(19) United States
(12) Patent Application Publication
(10) Pub. No.: US 2026/0067911 A1
(43) Pub. Date: Mar. 5, 2026

(54) Inter-User Equipment Coordination in Beam-Formed Sidelink Operation

(71) Applicant: Ofinno, LLC, Reston, VA (US)

(72) Inventors: Nazanin Rastegardoost, McLean, VA (US); Hyoungsuk Jeon, Centreville, VA (US); Esmael Hejazi Dinan, McLean, VA (US); Ali Cagatay Cirik, Chantilly, VA (US); Hua Zhou, Vienna, VA (US); Gautham Prasad, Herndon, VA (US); Hsin-Hsi Tsai, Reston, VA (US)

(73) Assignee: Ofinno, LLC, Reston, VA (US)

(21) Appl. No.: 19/385,996

(22) Filed: Nov. 11, 2025

Related U.S. Application Data
(63) Continuation of application No. PCT/US2024/028673, filed on May 9, 2024.
(60) Provisional application No. 63/465,796, filed on May 11, 2023.

(51) Int. Cl. H04W 72/40; H04L 5/00; H04W 28/26

(52) U.S. Cl. CPC H04W 72/40; H04L 5/0048; H04L 5/0073; H04W 28/26

(57) ABSTRACT

A first wireless device receives, from a second wireless device, first sidelink control information (SCI) indicating a first reserved resource for a sidelink reception based on a first sidelink (SL) reference signal (RS). The first wireless device receives, from a third wireless device and based on a second SL RS, second SCI indicating a second reserved resource overlapping in time and frequency with the first reserved resource. The first wireless device transmits, in response to the first SL RS and the second SL RS being quasi co-located (QCLed), conflict information to the second wireless device.

### CROSS-REFERENCE TO RELATED APPLICATIONS

This application is a continuation of International Application No. PCT/US2024/028673, filed May 9, 2024, which claims the benefit of U.S. Provisional Application No. 63/465,796, filed May 11, 2023, all of which are hereby incorporated by reference in their entireties.

### BRIEF DESCRIPTION OF THE DRAWINGS

Examples of several of the various embodiments of the present disclosure are described herein with reference to the drawings.

FIG. 1A and FIG. 1B illustrate example mobile communication networks in which embodiments of the present disclosure may be implemented.

FIG. 2A and FIG. 2B respectively illustrate a New Radio (NR) user plane and control plane protocol stack.

FIG. 3 illustrates an example of services provided between protocol layers of the NR user plane protocol stack of FIG. 2A.

FIG. 4A illustrates an example downlink data flow through the NR user plane protocol stack of FIG. 2A.

FIG. 4B illustrates an example format of a MAC subheader in a MAC PDU.

FIG. 5A and FIG. 5B respectively illustrate a mapping between logical channels, transport channels, and physical channels for the downlink and uplink.

FIG. 6 is an example diagram showing RRC state transitions of a UE.

FIG. 7 illustrates an example configuration of an NR frame into which OFDM symbols are grouped.

FIG. 8 illustrates an example configuration of a slot in the time and frequency domain for an NR carrier.

FIG. 9 illustrates an example of bandwidth adaptation using three configured BWPs for an NR carrier.

FIG. 10A illustrates three carrier aggregation configurations with two component carriers.

FIG. 10B illustrates an example of how aggregated cells may be configured into one or more PUCCH groups.

FIG. 11A illustrates an example of an SS/PBCH block structure and location.

FIG. 11B illustrates an example of CSI-RSs that are mapped in the time and frequency domains.

FIG. 12A and FIG. 12B respectively illustrate examples of three downlink and uplink beam management procedures.

FIG. 13A, FIG. 13B, and FIG. 13C respectively illustrate a four-step contention-based random access procedure, a two-step contention-free random access procedure, and another two-step random access procedure.

FIG. 14A illustrates an example of CORESET configurations for a bandwidth part.

FIG. 14B illustrates an example of a CCE-to-REG mapping for DCI transmission on a CORESET and PDCCH processing.

FIG. 15 illustrates an example of a wireless device in communication with a base station.

FIG. 16A, FIG. 16B, FIG. 16C, and FIG. 16D illustrate example structures for uplink and downlink transmission.

FIG. 17 illustrates examples of device-to-device (D2D) communication, in which there is a direct communication between wireless devices.

FIG. 18 illustrates an example of a resource pool for sidelink operations.

FIG. 19 illustrates an example of sidelink symbols in a slot.

FIG. 20 illustrates an example of resource indication for a first TB (e.g, a first data packet) and resource reservation for a second TB (e.g., a second data packet).

FIG. 21 and FIG. 22 illustrate examples of configuration information for sidelink communication.

FIG. 23 illustrates an example format of a MAC subheader for sidelink shared channel (SL-SCH).

FIG. 24 illustrates an example time of a resource selection procedure.

FIG. 25 illustrates an example timing of a resource selection procedure.

FIG. 26 illustrates an example flowchart of a resource selection procedure by a wireless device for transmitting a TB (e.g., a data packet) via sidelink.

FIG. 27 illustrates an example diagram of the resource selection procedure among layers of the wireless device.

FIG. 28 illustrates an example of a sidelink inter-UE coordination (e.g., an inter-UE coordination scheme 1).

FIG. 29 illustrates an example of a sidelink inter-UE coordination (e.g., an inter-UE coordination scheme 2).

FIG. 30 illustrates an example of sidelink CSI-RS transmission and a sidelink CSI reporting procedure as per an aspect of an example embodiment of the present disclosure.

FIG. 31 illustrates an example of resource allocation of SL CSI-RS.

FIG. 32 illustrates an example of SL CSI report as per an aspect of an example embodiment of the present disclosure.

FIG. 33A and FIG. 33B illustrate examples of SL RSs as per an aspect of an example embodiment of the present disclosure.

FIG. 34A illustrates an example for SL RS transmission as per an aspect of an embodiment of the present disclosure.

FIG. 34B illustrates an example for SL RS transmission as per an aspect of an embodiment of the present disclosure.

FIG. 35A and FIG. 35B show examples of directional/beam-formed sensing in sidelink.

FIG. 36 illustrates an example of sidelink resource conflict based on omni-directional transmission and sensing as per an aspect of an embodiment of the present disclosure.

FIG. 37A and FIG. 37B illustrate examples of sidelink resource conflict based on directional (beam-formed) transmission and sensing as per an aspect of an embodiment of the present disclosure.

FIG. 38 illustrates an example of sidelink resource conflict based on directional (beam-formed) transmission and sensing as per an aspect of an embodiment of the present disclosure.

FIG. 39 illustrates an example of resource conflict indication with beam-formed sidelink transmission and reception as per an aspect of an embodiment of the present disclosure.

FIG. 40 illustrates an example of preferred/non-preferred resource indication with beam-formed sidelink transmission and reception as per an aspect of an embodiment of the present disclosure.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. In fact, after reading the description, it will be apparent to one skilled in the relevant art how to implement alternative embodiments. The present embodiments should not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Embodiments may be configured to operate as needed. The disclosed mechanism may be performed when certain criteria are met, for example, in a wireless device, a base station, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

A base station may communicate with a mix of wireless devices. Wireless devices and/or base stations may support multiple technologies, and/or multiple releases of the same technology. Wireless devices may have some specific capability(ies) depending on wireless device category and/or capability(ies). When this disclosure refers to a base station communicating with a plurality of wireless devices, this disclosure may refer to a subset of the total wireless devices in a coverage area. This disclosure may refer to, for example, a plurality of wireless devices of a given LTE or 5G release with a given capability and in a given sector of the base station. The plurality of wireless devices in this disclosure may refer to a selected plurality of wireless devices, and/or a subset of total wireless devices in a coverage area which perform according to disclosed methods, and/or the like. There may be a plurality of base stations or a plurality of wireless devices in a coverage area that may not comply with the disclosed methods, for example, those wireless devices or base stations may perform based on older releases of LTE or 5G technology.

In this disclosure, “a” and “an” and similar phrases are to be interpreted as “at least one” and “one or more.” Similarly, any term that ends with the suffix “(s)” is to be interpreted as “at least one” and “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described. The term “based on”, as used herein, should be interpreted as “based at least in part on” rather than, for example, “based solely on”. The term “and/or” as used herein represents any possible combination of enumerated elements. For example, “A, B, and/or C” may represent A; B; C; A and B; A and C; B and C; or A, B, and C.

If A and B are sets and every element of A is an element of B, A is called a subset of B. In this specification, only non-empty sets and subsets are considered. For example, possible subsets of B={cell1, cell2} are: {cell1}, {cell2}, and {cell1, cell2}. The phrase “based on” (or equally “based at least on”) is indicative that the phrase following the term “based on” is an example of one of a multitude of suitable possibilities that may, or may not, be employed to one or more of the various embodiments. The phrase “in response to” (or equally “in response at least to”) is indicative that the phrase following the phrase “in response to” is an example of one of a multitude of suitable possibilities that may, or may not, be employed to one or more of the various embodiments. The phrase “depending on” (or equally “depending at least to”) is indicative that the phrase following the phrase “depending on” is an example of one of a multitude of suitable possibilities that may, or may not, be employed to one or more of the various embodiments. The phrase “employing/using” (or equally “employing/using at least”) is indicative that the phrase following the phrase “employing/using” is an example of one of a multitude of suitable possibilities that may, or may not, be employed to one or more of the various embodiments.

The term configured may relate to the capacity of a device whether the device is in an operational or non-operational state. Configured may refer to specific settings in a device that effect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, parameters (or equally called, fields, or Information elements: IEs) may comprise one or more information objects, and an information object may comprise one or more other objects. For example, if parameter (IE) N comprises parameter (IE) M, and parameter (IE) M comprises parameter (IE) K, and parameter (IE) K comprises parameter (information element) J. Then, for example, N comprises K, and N comprises J. In an example embodiment, when one or more messages comprise a plurality of parameters, it implies that a parameter in the plurality of parameters is in at least one of the one or more messages, but does not have to be in each of the one or more messages.

Many features presented are described as being optional through the use of “may” or the use of parentheses. For the sake of brevity and legibility, the present disclosure does not explicitly recite each and every permutation that may be obtained by choosing from the set of optional features. The present disclosure is to be interpreted as explicitly disclosing all such permutations. For example, a system described as having three optional features may be embodied in seven ways, namely with just one of the three possible features, with any two of the three possible features or with three of the three possible features.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g. hardware with a biological element) or a combination thereof, which may be behaviorally equivalent. For example, modules may be implemented as a software routine written in a computer language configured to be executed by a hardware machine (such as C, C++, Fortran, Java, Basic, MATLAB or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

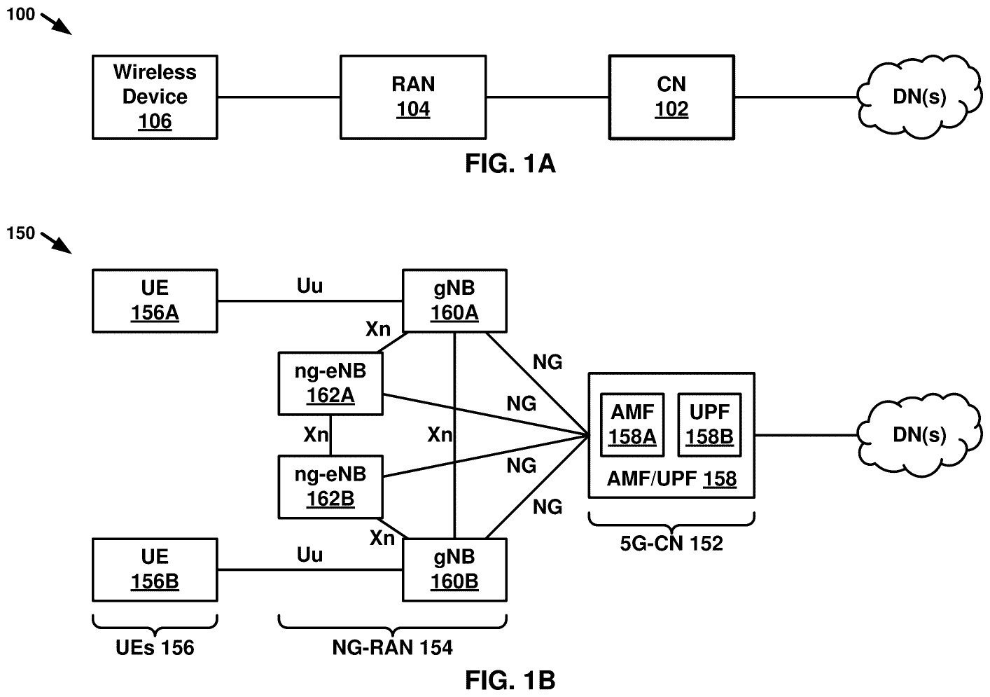

FIG. 1A illustrates an example of a mobile communication network 100 in which embodiments of the present disclosure may be implemented. The mobile communication network 100 may be, for example, a public land mobile network (PLMN) run by a network operator. As illustrated in FIG. 1A, the mobile communication network 100 includes a core network (CN) 102, a radio access network (RAN) 104, and a wireless device 106.

The CN 102 may provide the wireless device 106 with an interface to one or more data networks (DNs), such as public DNS (e.g., the Internet), private DNs, and/or intra-operator DNs. As part of the interface functionality, the CN 102 may set up end-to-end connections between the wireless device 106 and the one or more DNs, authenticate the wireless device 106, and provide charging functionality.

The RAN 104 may connect the CN 102 to the wireless device 106 through radio communications over an air interface. As part of the radio communications, the RAN 104 may provide scheduling, radio resource management, and retransmission protocols. The communication direction from the RAN 104 to the wireless device 106 over the air interface is known as the downlink and the communication direction from the wireless device 106 to the RAN 104 over the air interface is known as the uplink. Downlink transmissions may be separated from uplink transmissions using frequency division duplexing (FDD), time-division duplexing (TDD), and/or some combination of the two duplexing techniques.

The term wireless device may be used throughout this disclosure to refer to and encompass any mobile device or fixed (non-mobile) device for which wireless communication is needed or usable. For example, a wireless device may be a telephone, smart phone, tablet, computer, laptop, sensor, meter, wearable device, Internet of Things (IoT) device, vehicle road side unit (RSU), relay node, automobile, and/or any combination thereof. The term wireless device encompasses other terminology, including user equipment (UE), user terminal (UT), access terminal (AT), mobile station, handset, wireless transmit and receive unit (WTRU), and/or wireless communication device.

The RAN 104 may include one or more base stations (not shown). The term base station may be used throughout this disclosure to refer to and encompass a Node B (associated with UMTS and/or 3G standards), an Evolved Node B (eNB, associated with E-UTRA and/or 4G standards), a remote radio head (RRH), a baseband processing unit coupled to one or more RRHs, a repeater node or relay node used to extend the coverage area of a donor node, a Next Generation Evolved Node B (ng-eNB), a Generation Node B (gNB, associated with NR and/or 5G standards), an access point (AP, associated with, for example, WiFi or any other suitable wireless communication standard), and/or any combination thereof. A base station may comprise at least one gNB Central Unit (gNB-CU) and at least one a gNB Distributed Unit (gNB-DU).

A base station included in the RAN 104 may include one or more sets of antennas for communicating with the wireless device 106 over the air interface. For example, one or more of the base stations may include three sets of antennas to respectively control three cells (or sectors). The size of a cell may be determined by a range at which a receiver (e.g., a base station receiver) can successfully receive the transmissions from a transmitter (e.g., a wireless device transmitter) operating in the cell. Together, the cells of the base stations may provide radio coverage to the wireless device 106 over a wide geographic area to support wireless device mobility.

In addition to three-sector sites, other implementations of base stations are possible. For example, one or more of the base stations in the RAN 104 may be implemented as a sectored site with more or less than three sectors. One or more of the base stations in the RAN 104 may be implemented as an access point, as a baseband processing unit coupled to several remote radio heads (RRHs), and/or as a repeater or relay node used to extend the coverage area of a donor node. A baseband processing unit coupled to RRHs may be part of a centralized or cloud RAN architecture, where the baseband processing unit may be either centralized in a pool of baseband processing units or virtualized. A repeater node may amplify and rebroadcast a radio signal received from a donor node. A relay node may perform the same/similar functions as a repeater node but may decode the radio signal received from the donor node to remove noise before amplifying and rebroadcasting the radio signal.

The RAN 104 may be deployed as a homogenous network of macrocell base stations that have similar antenna patterns and similar high-level transmit powers. The RAN 104 may be deployed as a heterogeneous network. In heterogeneous networks, small cell base stations may be used to provide small coverage areas, for example, coverage areas that overlap with the comparatively larger coverage areas provided by macrocell base stations. The small coverage areas may be provided in areas with high data traffic (or so-called “hotspots”) or in areas with weak macrocell coverage. Examples of small cell base stations include, in order of decreasing coverage area, microcell base stations, picocell base stations, and femtocell base stations or home base stations.

The Third-Generation Partnership Project (3GPP) was formed in 1998 to provide global standardization of specifications for mobile communication networks similar to the mobile communication network 100 in FIG. 1A. To date, 3GPP has produced specifications for three generations of mobile networks: a third generation (3G) network known as Universal Mobile Telecommunications System (UMTS), a fourth generation (4G) network known as Long-Term Evolution (LTE), and a fifth generation (5G) network known as 5G System (5GS). Embodiments of the present disclosure are described with reference to the RAN of a 3GPP 5G network, referred to as next-generation RAN (NG-RAN). Embodiments may be applicable to RANs of other mobile communication networks, such as the RAN 104 in FIG. 1A, the RANs of earlier 3G and 4G networks, and those of future networks yet to be specified (e.g., a 3GPP 6G network). NG-RAN implements 5G radio access technology known as New Radio (NR) and may be provisioned to implement 4G radio access technology or other radio access technologies, including non-3GPP radio access technologies.

FIG. 1B illustrates another example mobile communication network 150 in which embodiments of the present disclosure may be implemented. Mobile communication network 150 may be, for example, a PLMN run by a network operator. As illustrated in FIG. 1B, mobile communication network 150 includes a 5G core network (5G-CN) 152, an NG-RAN 154, and UEs 156A and 156B (collectively UEs 156). These components may be implemented and operate in the same or similar manner as corresponding components described with respect to FIG. 1A.

The 5G-CN 152 provides the UEs 156 with an interface to one or more DNs, such as public DNS (e.g., the Internet), private DNs, and/or intra-operator DNs. As part of the interface functionality, the 5G-CN 152 may set up end-to-end connections between the UEs 156 and the one or more DNs, authenticate the UEs 156, and provide charging functionality. Compared to the CN of a 3GPP 4G network, the basis of the 5G-CN 152 may be a service-based architecture. This means that the architecture of the nodes making up the 5G-CN 152 may be defined as network functions that offer services via interfaces to other network functions. The network functions of the 5G-CN 152 may be implemented in several ways, including as network elements on dedicated or shared hardware, as software instances running on dedicated or shared hardware, or as virtualized functions instantiated on a platform (e.g., a cloud-based platform).

As illustrated in FIG. 1B, the 5G-CN 152 includes an Access and Mobility Management Function (AMF) 158A and a User Plane Function (UPF) 158B, which are shown as one component AMF/UPF 158 in FIG. 1B for ease of illustration. The UPF 158B may serve as a gateway between the NG-RAN 154 and the one or more DNs. The UPF 158B may perform functions such as packet routing and forwarding, packet inspection and user plane policy rule enforcement, traffic usage reporting, uplink classification to support routing of traffic flows to the one or more DNs, quality of service (QoS) handling for the user plane (e.g., packet filtering, gating, uplink/downlink rate enforcement, and uplink traffic verification), downlink packet buffering, and downlink data notification triggering. The UPF 158B may serve as an anchor point for intra-/inter-Radio Access Technology (RAT) mobility, an external protocol (or packet) data unit (PDU) session point of interconnect to the one or more DNs, and/or a branching point to support a multi-homed PDU session. The UEs 156 may be configured to receive services through a PDU session, which is a logical connection between a UE and a DN.

The AMF 158A may perform functions such as Non-Access Stratum (NAS) signaling termination, NAS signaling security, Access Stratum (AS) security control, inter-CN node signaling for mobility between 3GPP access networks, idle mode UE reachability (e.g., control and execution of paging retransmission), registration area management, intra-system and inter-system mobility support, access authentication, access authorization including checking of roaming rights, mobility management control (subscription and policies), network slicing support, and/or session management function (SMF) selection. NAS may refer to the functionality operating between a CN and a UE, and AS may refer to the functionality operating between the UE and a RAN.

The 5G-CN 152 may include one or more additional network functions that are not shown in FIG. 1B for the sake of clarity. For example, the 5G-CN 152 may include one or more of a Session Management Function (SMF), an NR Repository Function (NRF), a Policy Control Function (PCF), a Network Exposure Function (NEF), a Unified Data Management (UDM), an Application Function (AF), and/or an Authentication Server Function (AUSF).

The NG-RAN 154 may connect the 5G-CN 152 to the UEs 156 through radio communications over the air interface. The NG-RAN 154 may include one or more gNBs, illustrated as gNB 160A and gNB 160B (collectively gNBs 160) and/or one or more ng-eNBs, illustrated as ng-eNB 162A and ng-eNB 162B (collectively ng-eNBs 162). The gNBs 160 and ng-eNBs 162 may be more generically referred to as base stations. The gNBs 160 and ng-eNBs 162 may include one or more sets of antennas for communicating with the UEs 156 over an air interface. For example, one or more of the gNBs 160 and/or one or more of the ng-eNBs 162 may include three sets of antennas to respectively control three cells (or sectors). Together, the cells of the gNBs 160 and the ng-eNBs 162 may provide radio coverage to the UEs 156 over a wide geographic area to support UE mobility.

As shown in FIG. 1B, the gNBs 160 and/or the ng-eNBs 162 may be connected to the 5G-CN 152 by means of an NG interface and to other base stations by an Xn interface. The NG and Xn interfaces may be established using direct physical connections and/or indirect connections over an underlying transport network, such as an internet protocol (IP) transport network. The gNBs 160 and/or the ng-eNBs 162 may be connected to the UEs 156 by means of a Uu interface. For example, as illustrated in FIG. 1B, gNB 160A may be connected to the UE 156A by means of a Uu interface. The NG, Xn, and Uu interfaces are associated with a protocol stack. The protocol stacks associated with the interfaces may be used by the network elements in FIG. 1B to exchange data and signaling messages and may include two planes: a user plane and a control plane. The user plane may handle data of interest to a user. The control plane may handle signaling messages of interest to the network elements.

The gNBs 160 and/or the ng-eNBs 162 may be connected to one or more AMF/UPF functions of the 5G-CN 152, such as the AMF/UPF 158, by means of one or more NG interfaces. For example, the gNB 160A may be connected to the UPF 158B of the AMF/UPF 158 by means of an NG-User plane (NG-U) interface. The NG-U interface may provide delivery (e.g., non-guaranteed delivery) of user plane PDUs between the gNB 160A and the UPF 158B. The gNB 160A may be connected to the AMF 158A by means of an NG-Control plane (NG-C) interface. The NG-C interface may provide, for example, NG interface management, UE context management, UE mobility management, transport of NAS messages, paging, PDU session management, and configuration transfer and/or warning message transmission.

The gNBs 160 may provide NR user plane and control plane protocol terminations towards the UEs 156 over the Uu interface. For example, the gNB 160A may provide NR user plane and control plane protocol terminations toward the UE 156A over a Uu interface associated with a first protocol stack. The ng-eNBs 162 may provide Evolved UMTS Terrestrial Radio Access (E-UTRA) user plane and control plane protocol terminations towards the UEs 156 over a Uu interface, where E-UTRA refers to the 3GPP 4G radio-access technology. For example, the ng-eNB 162B may provide E-UTRA user plane and control plane protocol terminations towards the UE 156B over a Uu interface associated with a second protocol stack.

The 5G-CN 152 was described as being configured to handle NR and 4G radio accesses. It will be appreciated by one of ordinary skill in the art that it may be possible for NR to connect to a 4G core network in a mode known as “non-standalone operation.” In non-standalone operation, a 4G core network is used to provide (or at least support) control-plane functionality (e.g., initial access, mobility, and paging). Although only one AMF/UPF 158 is shown in FIG. 1B, one gNB or ng-eNB may be connected to multiple AMF/UPF nodes to provide redundancy and/or to load share across the multiple AMF/UPF nodes.

As discussed, an interface (e.g., Uu, Xn, and NG interfaces) between the network elements in FIG. 1B may be associated with a protocol stack that the network elements use to exchange data and signaling messages. A protocol stack may include two planes: a user plane and a control plane. The user plane may handle data of interest to a user, and the control plane may handle signaling messages of interest to the network elements.

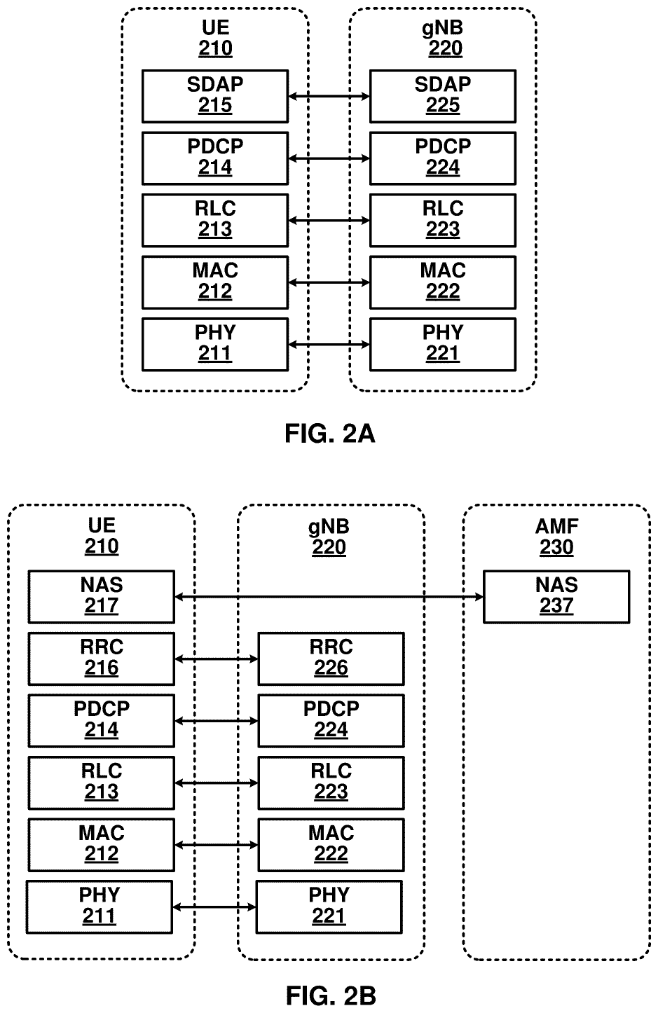

FIG. 2A and FIG. 2B respectively illustrate examples of NR user plane and NR control plane protocol stacks for the Uu interface that lies between a UE 210 and a gNB 220. The protocol stacks illustrated in FIG. 2A and FIG. 2B may be the same or similar to those used for the Uu interface between, for example, the UE 156A and the gNB 160A shown in FIG. 1B.

FIG. 2A illustrates a NR user plane protocol stack comprising five layers implemented in the UE 210 and the gNB 220. At the bottom of the protocol stack, physical layers (PHYs) 211 and 221 may provide transport services to the higher layers of the protocol stack and may correspond to layer 1 of the Open Systems Interconnection (OSI) model. The next four protocols above PHYs 211 and 221 comprise media access control layers (MACs) 212 and 222, radio link control layers (RLCs) 213 and 223, packet data convergence protocol layers (PDCPs) 214 and 224, and service data application protocol layers (SDAPs) 215 and 225. Together, these four protocols may make up layer 2, or the data link layer, of the OSI model.

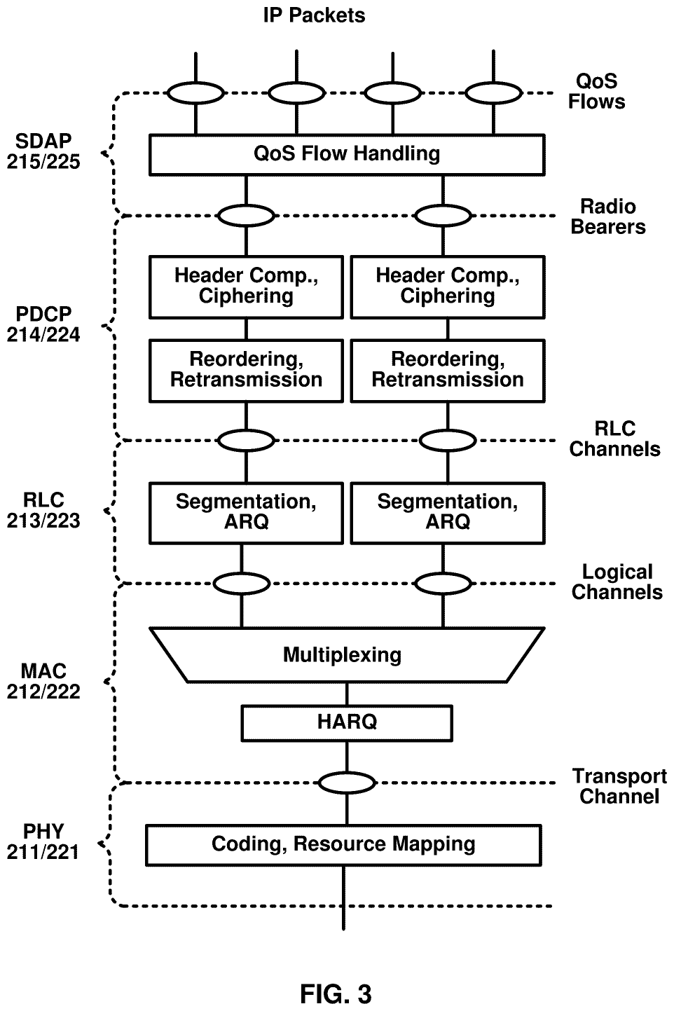

FIG. 3 illustrates an example of services provided between protocol layers of the NR user plane protocol stack. Starting from the top of FIG. 2A and FIG. 3, the SDAPs 215 and 225 may perform QoS flow handling. The UE 210 may receive services through a PDU session, which may be a logical connection between the UE 210 and a DN. The PDU session may have one or more QoS flows. A UPF of a CN (e.g., the UPF 158B) may map IP packets to the one or more QoS flows of the PDU session based on QoS requirements (e.g., in terms of delay, data rate, and/or error rate). The SDAPs 215 and 225 may perform mapping/de-mapping between the one or more QoS flows and one or more data radio bearers. The mapping/de-mapping between the QoS flows and the data radio bearers may be determined by the SDAP 225 at the gNB 220. The SDAP 215 at the UE 210 may be informed of the mapping between the QoS flows and the data radio bearers through reflective mapping or control signaling received from the gNB 220. For reflective mapping, the SDAP 225 at the gNB 220 may mark the downlink packets with a QoS flow indicator (QFI), which may be observed by the SDAP 215 at the UE 210 to determine the mapping/de-mapping between the QoS flows and the data radio bearers.

The PDCPs 214 and 224 may perform header compression/decompression to reduce the amount of data that needs to be transmitted over the air interface, ciphering/deciphering to prevent unauthorized decoding of data transmitted over the air interface, and integrity protection (to ensure control messages originate from intended sources. The PDCPs 214 and 224 may perform retransmissions of undelivered packets, in-sequence delivery and reordering of packets, and removal of packets received in duplicate due to, for example, an intra-gNB handover. The PDCPs 214 and 224 may perform packet duplication to improve the likelihood of the packet being received and, at the receiver, remove any duplicate packets. Packet duplication may be useful for services that require high reliability.

Although not shown in FIG. 3, PDCPs 214 and 224 may perform mapping/de-mapping between a split radio bearer and RLC channels in a dual connectivity scenario. Dual connectivity is a technique that allows a UE to connect to two cells or, more generally, two cell groups: a master cell group (MCG) and a secondary cell group (SCG). A split bearer is when a single radio bearer, such as one of the radio bearers provided by the PDCPs 214 and 224 as a service to the SDAPs 215 and 225, is handled by cell groups in dual connectivity. The PDCPs 214 and 224 may map/de-map the split radio bearer between RLC channels belonging to cell groups.

The RLCs 213 and 223 may perform segmentation, retransmission through Automatic Repeat Request (ARQ), and removal of duplicate data units received from MACs 212 and 222, respectively. The RLCs 213 and 223 may support three transmission modes: transparent mode (TM); unacknowledged mode (UM); and acknowledged mode (AM). Based on the transmission mode an RLC is operating, the RLC may perform one or more of the noted functions. The RLC configuration may be per logical channel with no dependency on numerologies and/or Transmission Time Interval (TTI) durations. As shown in FIG. 3, the RLCs 213 and 223 may provide RLC channels as a service to PDCPs 214 and 224, respectively.

The MACs 212 and 222 may perform multiplexing/demultiplexing of logical channels and/or mapping between logical channels and transport channels. The multiplexing/demultiplexing may include multiplexing/demultiplexing of data units, belonging to the one or more logical channels, into/from Transport Blocks (TBs) delivered to/from the PHYs 211 and 221. The MAC 222 may be configured to perform scheduling, scheduling information reporting, and priority handling between UEs by means of dynamic scheduling. Scheduling may be performed in the gNB 220 (at the MAC 222) for downlink and uplink. The MACs 212 and 222 may be configured to perform error correction through Hybrid Automatic Repeat Request (HARQ) (e.g., one HARQ entity per carrier in case of Carrier Aggregation (CA), priority handling between logical channels of the UE 210 by means of logical channel prioritization, and/or padding. The MACs 212 and 222 may support one or more numerologies and/or transmission timings. In an example, mapping restrictions in a logical channel prioritization may control which numerology and/or transmission timing a logical channel may use. As shown in FIG. 3, the MACs 212 and 222 may provide logical channels as a service to the RLCs 213 and 223.

The PHYs 211 and 221 may perform mapping of transport channels to physical channels and digital and analog signal processing functions for sending and receiving information over the air interface. These digital and analog signal processing functions may include, for example, coding/decoding and modulation/demodulation. The PHYs 211 and 221 may perform multi-antenna mapping. As shown in FIG. 3, the PHYs 211 and 221 may provide one or more transport channels as a service to the MACs 212 and 222.

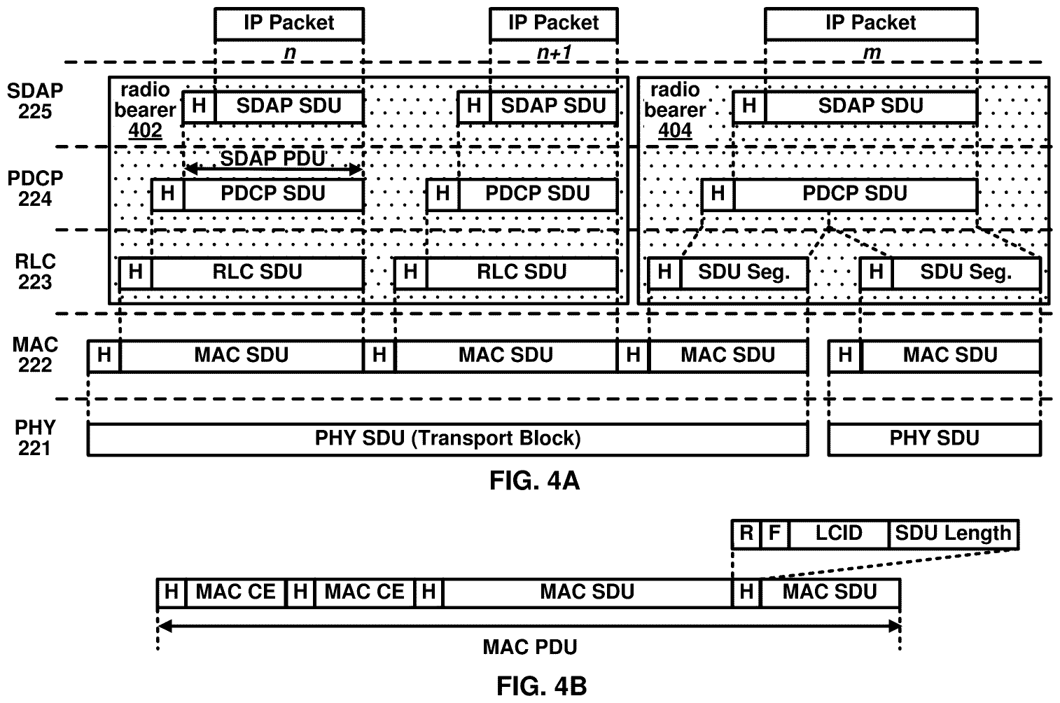

FIG. 4A illustrates an example downlink data flow through the NR user plane protocol stack. FIG. 4A illustrates a downlink data flow of three IP packets (n, n+1, and m) through the NR user plane protocol stack to generate two TBs at the gNB 220. An uplink data flow through the NR user plane protocol stack may be similar to the downlink data flow depicted in FIG. 4A.

The downlink data flow of FIG. 4A begins when SDAP 225 receives the three IP packets from one or more QoS flows and maps the three packets to radio bearers. In FIG. 4A, the SDAP 225 maps IP packets n and n+1 to a first radio bearer 402 and maps IP packet m to a second radio bearer 404. An SDAP header (labeled with an “H” in FIG. 4A) is added to an IP packet. The data unit from/to a higher protocol layer is referred to as a service data unit (SDU) of the lower protocol layer and the data unit to/from a lower protocol layer is referred to as a protocol data unit (PDU) of the higher protocol layer. As shown in FIG. 4A, the data unit from the SDAP 225 is an SDU of lower protocol layer PDCP 224 and is a PDU of the SDAP 225.

The remaining protocol layers in FIG. 4A may perform their associated functionality (e.g., with respect to FIG. 3), add corresponding headers, and forward their respective outputs to the next lower layer. For example, the PDCP 224 may perform IP-header compression and ciphering and forward its output to the RLC 223. The RLC 223 may optionally perform segmentation (e.g., as shown for IP packet m in FIG. 4A) and forward its output to the MAC 222. The MAC 222 may multiplex a number of RLC PDUs and may attach a MAC subheader to an RLC PDU to form a transport block. In NR, the MAC subheaders may be distributed across the MAC PDU, as illustrated in FIG. 4A. In LTE, the MAC subheaders may be entirely located at the beginning of the MAC PDU. The NR MAC PDU structure may reduce processing time and associated latency because the MAC PDU subheaders may be computed before the full MAC PDU is assembled.

FIG. 4B illustrates an example format of a MAC subheader in a MAC PDU. The MAC subheader includes: an SDU length field for indicating the length (e.g., in bytes) of the MAC SDU to which the MAC subheader corresponds; a logical channel identifier (LCID) field for identifying the logical channel from which the MAC SDU originated to aid in the demultiplexing process; a flag (F) for indicating the size of the SDU length field; and a reserved bit (R) field for future use.

FIG. 4B further illustrates MAC control elements (CEs) inserted into the MAC PDU by a MAC, such as MAC 223 or MAC 222. For example, FIG. 4B illustrates two MAC CEs inserted into the MAC PDU. MAC CEs may be inserted at the beginning of a MAC PDU for downlink transmissions (as shown in FIG. 4B) and at the end of a MAC PDU for uplink transmissions. MAC CEs may be used for in-band control signaling. Example MAC CEs include: scheduling-related MAC CEs, such as buffer status reports and power headroom reports; activation/deactivation MAC CEs, such as those for activation/deactivation of PDCP duplication detection, channel state information (CSI) reporting, sounding reference signal (SRS) transmission, and prior configured components; discontinuous reception (DRX) related MAC CEs; timing advance MAC CEs; and random access related MAC CEs. A MAC CE may be preceded by a MAC subheader with a similar format as described for MAC SDUs and may be identified with a reserved value in the LCID field that indicates the type of control information included in the MAC CE.

Before describing the NR control plane protocol stack, logical channels, transport channels, and physical channels are first described as well as a mapping between the channel types. One or more of the channels may be used to carry out functions associated with the NR control plane protocol stack described later below.

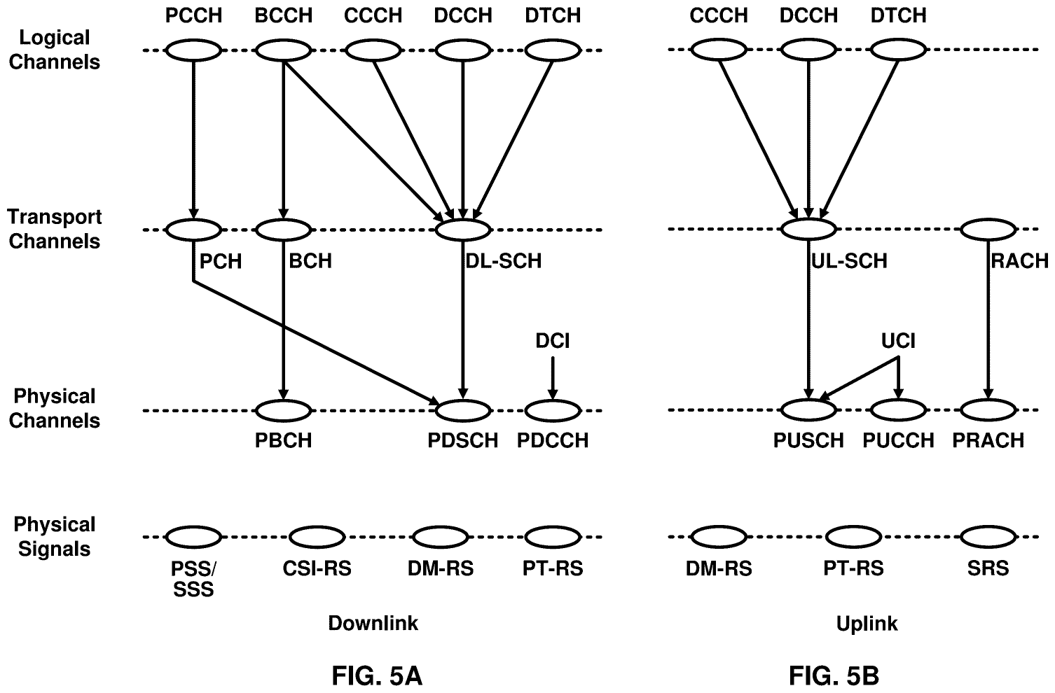

FIG. 5A and FIG. 5B illustrate, for downlink and uplink respectively, a mapping between logical channels, transport channels, and physical channels. Information is passed through channels between the RLC, the MAC, and the PHY of the NR protocol stack. A logical channel may be used between the RLC and the MAC and may be classified as a control channel that carries control and configuration information in the NR control plane or as a traffic channel that carries data in the NR user plane. A logical channel may be classified as a dedicated logical channel that is dedicated to a specific UE or as a common logical channel that may be used by more than one UE. A logical channel may also be defined by the type of information it carries. The set of logical channels defined by NR include, for example:
a paging control channel (PCCH) for carrying paging messages used to page a UE whose location is not known to the network on a cell level;
a broadcast control channel (BCCH) for carrying system information messages in the form of a master information block (MIB) and several system information blocks (SIBs), wherein the system information messages may be used by the UEs to obtain information about how a cell is configured and how to operate within the cell;
a common control channel (CCCH) for carrying control messages together with random access;
a dedicated control channel (DCCH) for carrying control messages to/from a specific the UE to configure the UE; and
a dedicated traffic channel (DTCH) for carrying user data to/from a specific the UE.

Transport channels are used between the MAC and PHY layers and may be defined by how the information they carry is transmitted over the air interface. The set of transport channels defined by NR include, for example:
a paging channel (PCH) for carrying paging messages that originated from the PCCH;
a broadcast channel (BCH) for carrying the MIB from the BCCH;
a downlink shared channel (DL-SCH) for carrying downlink data and signaling messages, including the SIBs from the BCCH;
an uplink shared channel (UL-SCH) for carrying uplink data and signaling messages; and
a random access channel (RACH) for allowing a UE to contact the network without any prior scheduling.

The PHY may use physical channels to pass information between processing levels of the PHY. A physical channel may have an associated set of time-frequency resources for carrying the information of one or more transport channels. The PHY may generate control information to support the low-level operation of the PHY and provide the control information to the lower levels of the PHY via physical control channels, known as L1/L2 control channels. The set of physical channels and physical control channels defined by NR include, for example:
a physical broadcast channel (PBCH) for carrying the MIB from the BCH;
a physical downlink shared channel (PDSCH) for carrying downlink data and signaling messages from the DL-SCH, as well as paging messages from the PCH;
a physical downlink control channel (PDCCH) for carrying downlink control information (DCI), which may include downlink scheduling commands, uplink scheduling grants, and uplink power control commands;
a physical uplink shared channel (PUSCH) for carrying uplink data and signaling messages from the UL-SCH and in some instances uplink control information (UCI) as described below;
a physical uplink control channel (PUCCH) for carrying UCI, which may include HARQ acknowledgments, channel quality indicators (CQI), pre-coding matrix indicators (PMI), rank indicators (RI), and scheduling requests (SR); and
a physical random access channel (PRACH) for random access.

Similar to the physical control channels, the physical layer generates physical signals to support the low-level operation of the physical layer. As shown in FIG. 5A and FIG. 5B, the physical layer signals defined by NR include: primary synchronization signals (PSS), secondary synchronization signals (SSS), channel state information reference signals (CSI-RS), demodulation reference signals (DMRS), sounding reference signals (SRS), and phase-tracking reference signals (PT-RS). These physical layer signals will be described in greater detail below.

FIG. 2B illustrates an example NR control plane protocol stack. As shown in FIG. 2B, the NR control plane protocol stack may use the same/similar first four protocol layers as the example NR user plane protocol stack. These four protocol layers include the PHYs 211 and 221, the MACs 212 and 222, the RLCs 213 and 223, and the PDCPs 214 and 224. Instead of having the SDAPs 215 and 225 at the top of the stack as in the NR user plane protocol stack, the NR control plane stack has radio resource controls (RRCs) 216 and 226 and NAS protocols 217 and 237 at the top of the NR control plane protocol stack.

The NAS protocols 217 and 237 may provide control plane functionality between the UE 210 and the AMF 230 (e.g., the AMF 158A) or, more generally, between the UE 210 and the CN. The NAS protocols 217 and 237 may provide control plane functionality between the UE 210 and the AMF 230 via signaling messages, referred to as NAS messages. There is no direct path between the UE 210 and the AMF 230 through which the NAS messages can be transported. The NAS messages may be transported using the AS of the Uu and NG interfaces. NAS protocols 217 and 237 may provide control plane functionality such as authentication, security, connection setup, mobility management, and session management.

The RRCs 216 and 226 may provide control plane functionality between the UE 210 and the gNB 220 or, more generally, between the UE 210 and the RAN. The RRCs 216 and 226 may provide control plane functionality between the UE 210 and the gNB 220 via signaling messages, referred to as RRC messages. RRC messages may be transmitted between the UE 210 and the RAN using signaling radio bearers and the same/similar PDCP, RLC, MAC, and PHY protocol layers. The MAC may multiplex control-plane and user-plane data into the same transport block (TB). The RRCs 216 and 226 may provide control plane functionality such as: broadcast of system information related to AS and NAS; paging initiated by the CN or the RAN; establishment, maintenance and release of an RRC connection between the UE 210 and the RAN; security functions including key management; establishment, configuration, maintenance and release of signaling radio bearers and data radio bearers; mobility functions; QoS management functions; the UE measurement reporting and control of the reporting; detection of and recovery from radio link failure (RLF); and/or NAS message transfer. As part of establishing an RRC connection, RRCs 216 and 226 may establish an RRC context, which may involve configuring parameters for communication between the UE 210 and the RAN.

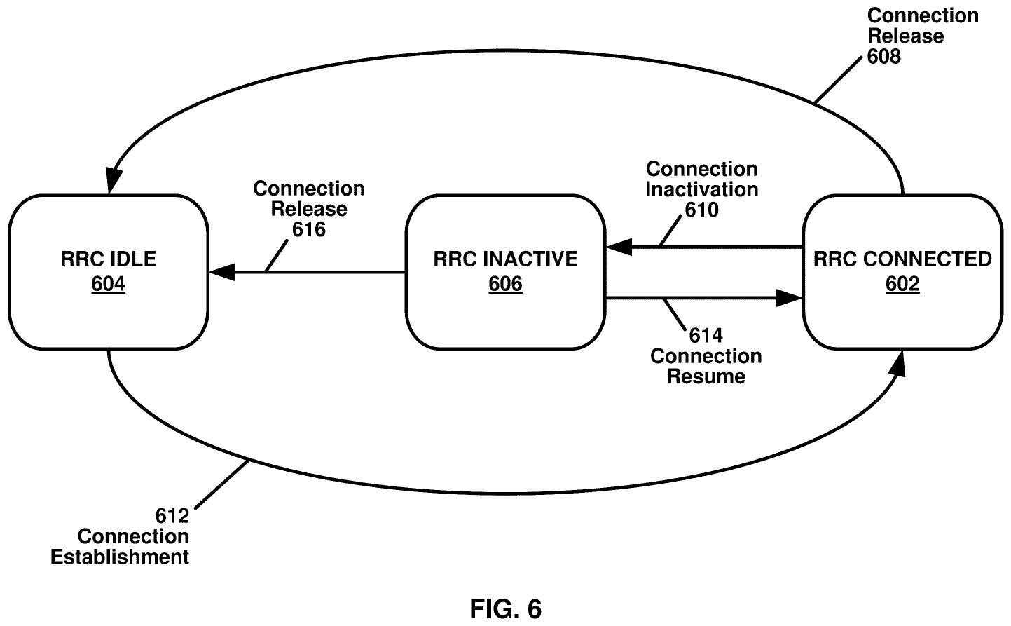

FIG. 6 is an example diagram showing RRC state transitions of a UE. The UE may be the same or similar to the wireless device 106 depicted in FIG. 1A, the UE 210 depicted in FIG. 2A and FIG. 2B, or any other wireless device described in the present disclosure. As illustrated in FIG. 6, a UE may be in at least one of three RRC states: RRC connected 602 (e.g., RRC_CONNECTED), RRC idle 604 (e.g., RRC_IDLE), and RRC inactive 606 (e.g., RRC_INACTIVE).

In RRC connected 602, the UE has an established RRC context and may have at least one RRC connection with a base station. The base station may be similar to one of the one or more base stations included in the RAN 104 depicted in FIG. 1A, one of the gNBs 160 or ng-eNBs 162 depicted in FIG. 1B, the gNB 220 depicted in FIG. 2A and FIG. 2B, or any other base station described in the present disclosure. The base station with which the UE is connected may have the RRC context for the UE. The RRC context, referred to as the UE context, may comprise parameters for communication between the UE and the base station. These parameters may include, for example: one or more AS contexts; one or more radio link configuration parameters; bearer configuration information (e.g., relating to a data radio bearer, signaling radio bearer, logical channel, QoS flow, and/or PDU session); security information; and/or PHY, MAC, RLC, PDCP, and/or SDAP layer configuration information. While in RRC connected 602, mobility of the UE may be managed by the RAN (e.g., the RAN 104 or the NG-RAN 154). The UE may measure the signal levels (e.g., reference signal levels) from a serving cell and neighboring cells and report these measurements to the base station currently serving the UE. The UE's serving base station may request a handover to a cell of one of the neighboring base stations based on the reported measurements. The RRC state may transition from RRC connected 602 to RRC idle 604 through a connection release procedure 608 or to RRC inactive 606 through a connection inactivation procedure 610.

In RRC idle 604, an RRC context may not be established for the UE. In RRC idle 604, the UE may not have an RRC connection with the base station. While in RRC idle 604, the UE may be in a sleep state for the majority of the time (e.g., to conserve battery power). The UE may wake up periodically (e.g., once in every discontinuous reception cycle) to monitor for paging messages from the RAN. Mobility of the UE may be managed by the UE through a procedure known as cell reselection. The RRC state may transition from RRC idle 604 to RRC connected 602 through a connection establishment procedure 612, which may involve a random access procedure as discussed in greater detail below.

In RRC inactive 606, the RRC context previously established is maintained in the UE and the base station. This allows for a fast transition to RRC connected 602 with reduced signaling overhead as compared to the transition from RRC idle 604 to RRC connected 602. While in RRC inactive 606, the UE may be in a sleep state and mobility of the UE may be managed by the UE through cell reselection. The RRC state may transition from RRC inactive 606 to RRC connected 602 through a connection resume procedure 614 or to RRC idle 604 though a connection release procedure 616 that may be the same as or similar to connection release procedure 608.

An RRC state may be associated with a mobility management mechanism. In RRC idle 604 and RRC inactive 606, mobility is managed by the UE through cell reselection. The purpose of mobility management in RRC idle 604 and RRC inactive 606 is to allow the network to be able to notify the UE of an event via a paging message without having to broadcast the paging message over the entire mobile communications network. The mobility management mechanism used in RRC idle 604 and RRC inactive 606 may allow the network to track the UE on a cell-group level so that the paging message may be broadcast over the cells of the cell group that the UE currently resides within instead of the entire mobile communication network. The mobility management mechanisms for RRC idle 604 and RRC inactive 606 track the UE on a cell-group level. They may do so using different granularities of grouping. For example, there may be three levels of cell-grouping granularity: individual cells; cells within a RAN area identified by a RAN area identifier (RAI); and cells within a group of RAN areas, referred to as a tracking area and identified by a tracking area identifier (TAI).

Tracking areas may be used to track the UE at the CN level. The CN (e.g., the CN 102 or the 5G-CN 152) may provide the UE with a list of TAIs associated with a UE registration area. If the UE moves, through cell reselection, to a cell associated with a TAI not included in the list of TAIs associated with the UE registration area, the UE may perform a registration update with the CN to allow the CN to update the UE's location and provide the UE with a new the UE registration area.

RAN areas may be used to track the UE at the RAN level. For a UE in RRC inactive 606 state, the UE may be assigned a RAN notification area. A RAN notification area may comprise one or more cell identities, a list of RAIs, or a list of TAIs. In an example, a base station may belong to one or more RAN notification areas. In an example, a cell may belong to one or more RAN notification areas. If the UE moves, through cell reselection, to a cell not included in the RAN notification area assigned to the UE, the UE may perform a notification area update with the RAN to update the UE's RAN notification area.

A base station storing an RRC context for a UE or a last serving base station of the UE may be referred to as an anchor base station. An anchor base station may maintain an RRC context for the UE at least during a period of time that the UE stays in a RAN notification area of the anchor base station and/or during a period of time that the UE stays in RRC inactive 606.

A gNB, such as gNBs 160 in FIG. 1B, may be split in two parts: a central unit (gNB-CU), and one or more distributed units (gNB-DU). A gNB-CU may be coupled to one or more gNB-DUs using an F1 interface. The gNB-CU may comprise the RRC, the PDCP, and the SDAP. A gNB-DU may comprise the RLC, the MAC, and the PHY.

In NR, the physical signals and physical channels (discussed with respect to FIG. 5A and FIG. 5B) may be mapped onto orthogonal frequency divisional multiplexing (OFDM) symbols. OFDM is a multicarrier communication scheme that transmits data over F orthogonal subcarriers (or tones). Before transmission, the data may be mapped to a series of complex symbols (e.g., M-quadrature amplitude modulation (M-QAM) or M-phase shift keying (M-PSK) symbols), referred to as source symbols, and divided into F parallel symbol streams. The F parallel symbol streams may be treated as though they are in the frequency domain and used as inputs to an Inverse Fast Fourier Transform (IFFT) block that transforms them into the time domain. The IFFT block may take in F source symbols at a time, one from each of the F parallel symbol streams, and use each source symbol to modulate the amplitude and phase of one of F sinusoidal basis functions that correspond to the F orthogonal subcarriers. The output of the IFFT block may be F time-domain samples that represent the summation of the F orthogonal subcarriers. The F time-domain samples may form a single OFDM symbol. After some processing (e.g., addition of a cyclic prefix) and up-conversion, an OFDM symbol provided by the IFFT block may be transmitted over the air interface on a carrier frequency. The F parallel symbol streams may be mixed using an FFT block before being processed by the IFFT block. This operation produces Discrete Fourier Transform (DFT)-precoded OFDM symbols and may be used by UEs in the uplink to reduce the peak to average power ratio (PAPR). Inverse processing may be performed on the OFDM symbol at a receiver using an FFT block to recover the data mapped to the source symbols.

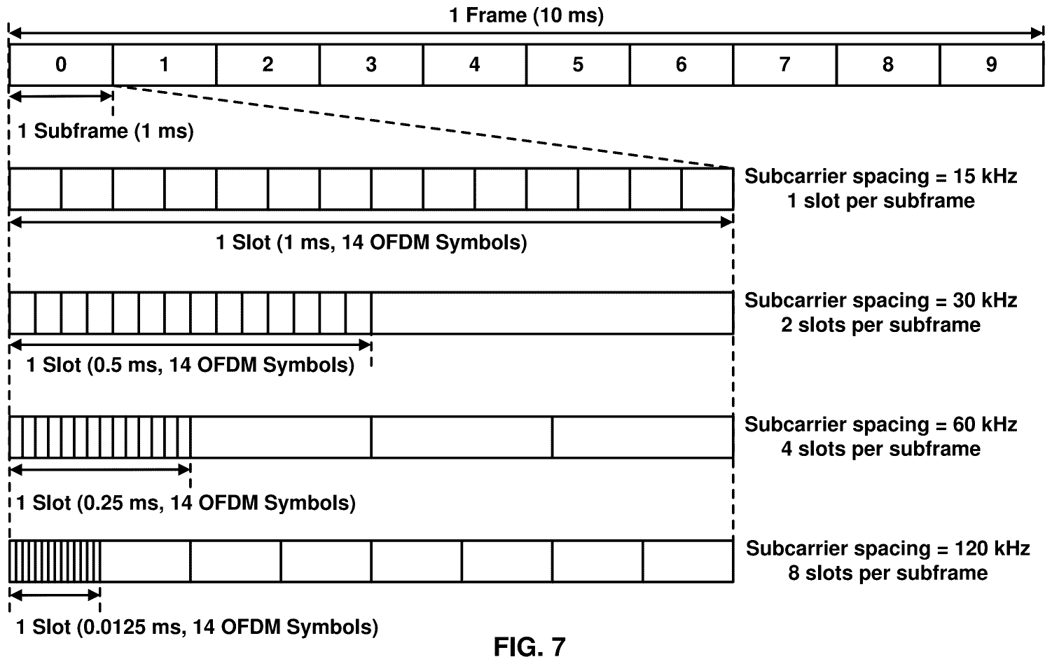

FIG. 7 illustrates an example configuration of an NR frame into which OFDM symbols are grouped. An NR frame may be identified by a system frame number (SFN). The SFN may repeat with a period of 1024 frames. As illustrated, one NR frame may be 10 milliseconds (ms) in duration and may include 10 subframes that are 1 ms in duration. A subframe may be divided into slots that include, for example, 14 OFDM symbols per slot.

The duration of a slot may depend on the numerology used for the OFDM symbols of the slot. In NR, a flexible numerology is supported to accommodate different cell deployments (e.g., cells with carrier frequencies below 1 GHz up to cells with carrier frequencies in the mm-wave range). A numerology may be defined in terms of subcarrier spacing and cyclic prefix duration. For a numerology in NR, subcarrier spacings may be scaled up by powers of two from a baseline subcarrier spacing of 15 kHz, and cyclic prefix durations may be scaled down by powers of two from a baseline cyclic prefix duration of 4.7 μs. For example, NR defines numerologies with the following subcarrier spacing/cyclic prefix duration combinations: 15 kHz/4.7 μs; 30 KHz/2.3 μs; 60 KHz/1.2 μs; 120 KHz/0.59 μs; and 240 KHz/0.29 μs.

A slot may have a fixed number of OFDM symbols (e.g., 14 OFDM symbols). A numerology with a higher subcarrier spacing has a shorter slot duration and, correspondingly, more slots per subframe. FIG. 7 illustrates this numerology-dependent slot duration and slots-per-subframe transmission structure (the numerology with a subcarrier spacing of 240 KHz is not shown in FIG. 7 for ease of illustration). A subframe in NR may be used as a numerology-independent time reference, while a slot may be used as the unit upon which uplink and downlink transmissions are scheduled. To support low latency, scheduling in NR may be decoupled from the slot duration and start at any OFDM symbol and last for as many symbols as needed for a transmission. These partial slot transmissions may be referred to as mini-slot or subslot transmissions.

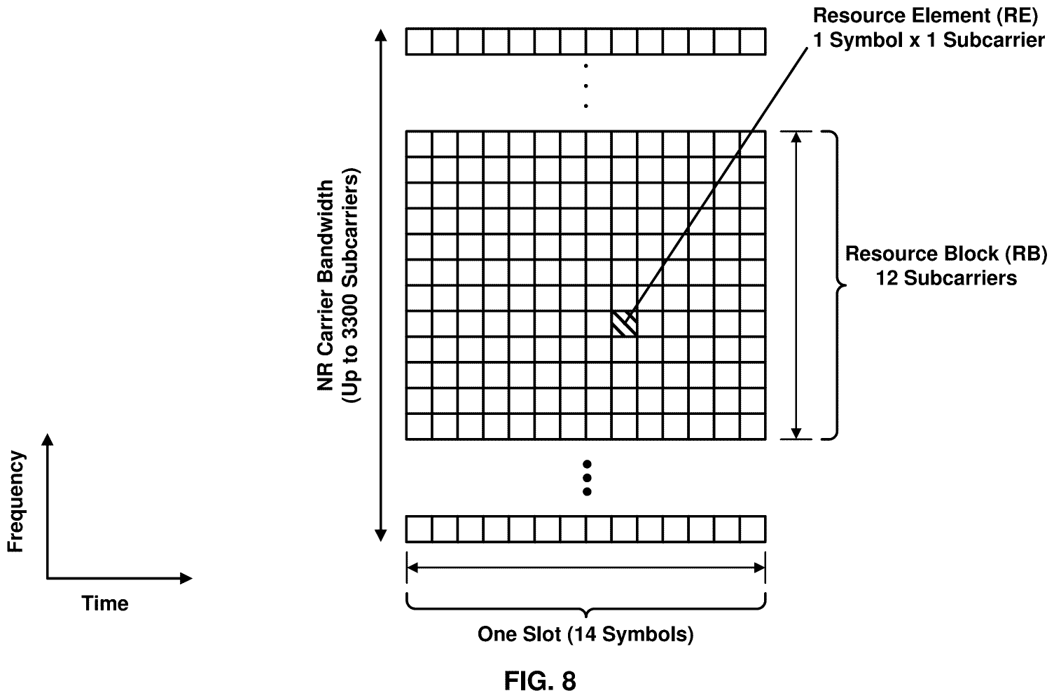

FIG. 8 illustrates an example configuration of a slot in the time and frequency domain for an NR carrier. The slot includes resource elements (REs) and resource blocks (RBs). An RE is the smallest physical resource in NR. An RE spans one OFDM symbol in the time domain by one subcarrier in the frequency domain as shown in FIG. 8. An RB spans twelve consecutive REs in the frequency domain as shown in FIG. 8. An NR carrier may be limited to a width of 275 RBs or 275×12=3300 subcarriers. Such a limitation, if used, may limit the NR carrier to 50, 100, 200, and 400 MHz for subcarrier spacings of 15, 30, 60, and 120 KHz, respectively, where the 400 MHz bandwidth may be set based on a 400 MHz per carrier bandwidth limit.

FIG. 8 illustrates a single numerology being used across the entire bandwidth of the NR carrier. In other example configurations, multiple numerologies may be supported on the same carrier.

NR may support wide carrier bandwidths (e.g., up to 400 MHz for a subcarrier spacing of 120 kHz). Not all UEs may be able to receive the full carrier bandwidth (e.g., due to hardware limitations). Also, receiving the full carrier bandwidth may be prohibitive in terms of UE power consumption. In an example, to reduce power consumption and/or for other purposes, a UE may adapt the size of the UE's receive bandwidth based on the amount of traffic the UE is scheduled to receive. This is referred to as bandwidth adaptation.

NR defines bandwidth parts (BWPs) to support UEs not capable of receiving the full carrier bandwidth and to support bandwidth adaptation. In an example, a BWP may be defined by a subset of contiguous RBs on a carrier. A UE may be configured (e.g., via RRC layer) with one or more downlink BWPs and one or more uplink BWPs per serving cell (e.g., up to four downlink BWPs and up to four uplink BWPs per serving cell). At a given time, one or more of the configured BWPs for a serving cell may be active. These one or more BWPs may be referred to as active BWPs of the serving cell. When a serving cell is configured with a secondary uplink carrier, the serving cell may have one or more first active BWPs in the uplink carrier and one or more second active BWPs in the secondary uplink carrier.

For unpaired spectra, a downlink BWP from a set of configured downlink BWPs may be linked with an uplink BWP from a set of configured uplink BWPs if a downlink BWP index of the downlink BWP and an uplink BWP index of the uplink BWP are the same. For unpaired spectra, a UE may expect that a center frequency for a downlink BWP is the same as a center frequency for an uplink BWP.

For a downlink BWP in a set of configured downlink BWPs on a primary cell (PCell), a base station may configure a UE with one or more control resource sets (CORESETs) for at least one search space. A search space is a set of locations in the time and frequency domains where the UE may find control information. The search space may be a UE-specific search space or a common search space (potentially usable by a plurality of UEs). For example, a base station may configure a UE with a common search space, on a PCell or on a primary secondary cell (PSCell), in an active downlink BWP.

For an uplink BWP in a set of configured uplink BWPs, a BS may configure a UE with one or more resource sets for one or more PUCCH transmissions. A UE may receive downlink receptions (e.g., PDCCH or PDSCH) in a downlink BWP according to a configured numerology (e.g., subcarrier spacing and cyclic prefix duration) for the downlink BWP. The UE may transmit uplink transmissions (e.g., PUCCH or PUSCH) in an uplink BWP according to a configured numerology (e.g., subcarrier spacing and cyclic prefix length for the uplink BWP).

One or more BWP indicator fields may be provided in Downlink Control Information (DCI). A value of a BWP indicator field may indicate which BWP in a set of configured BWPs is an active downlink BWP for one or more downlink receptions. The value of the one or more BWP indicator fields may indicate an active uplink BWP for one or more uplink transmissions.

A base station may semi-statically configure a UE with a default downlink BWP within a set of configured downlink BWPs associated with a PCell. If the base station does not provide the default downlink BWP to the UE, the default downlink BWP may be an initial active downlink BWP. The UE may determine which BWP is the initial active downlink BWP based on a CORESET configuration obtained using the PBCH.

A base station may configure a UE with a BWP inactivity timer value for a PCell. The UE may start or restart a BWP inactivity timer at any appropriate time. For example, the UE may start or restart the BWP inactivity timer (a) when the UE detects a DCI indicating an active downlink BWP other than a default downlink BWP for a paired spectra operation; or (b) when a UE detects a DCI indicating an active downlink BWP or active uplink BWP other than a default downlink BWP or uplink BWP for an unpaired spectra operation. If the UE does not detect DCI during an interval of time (e.g., 1 ms or 0.5 ms), the UE may run the BWP inactivity timer toward expiration (for example, increment from zero to the BWP inactivity timer value, or decrement from the BWP inactivity timer value to zero). When the BWP inactivity timer expires, the UE may switch from the active downlink BWP to the default downlink BWP.

In an example, a base station may semi-statically configure a UE with one or more BWPs. A UE may switch an active BWP from a first BWP to a second BWP in response to receiving a DCI indicating the second BWP as an active BWP and/or in response to an expiry of the BWP inactivity timer (e.g., if the second BWP is the default BWP).

Downlink and uplink BWP switching (where BWP switching refers to switching from a currently active BWP to a not currently active BWP) may be performed independently in paired spectra. In unpaired spectra, downlink and uplink BWP switching may be performed simultaneously. Switching between configured BWPs may occur based on RRC signaling, DCI, expiration of a BWP inactivity timer, and/or an initiation of random access.

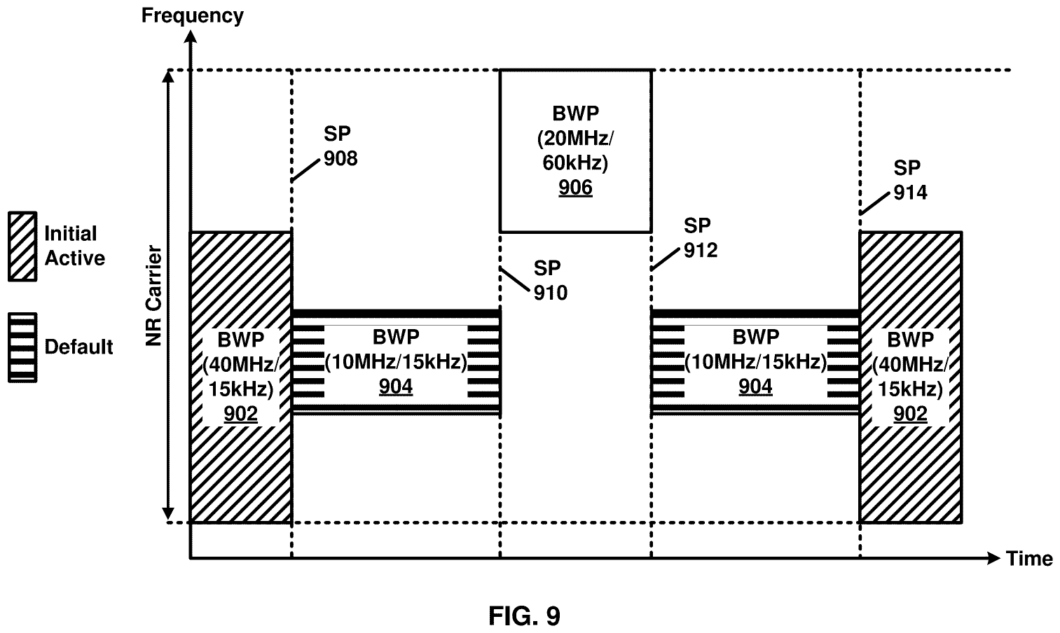

FIG. 9 illustrates an example of bandwidth adaptation using three configured BWPs for an NR carrier. A UE configured with the three BWPs may switch from one BWP to another BWP at a switching point. In the example illustrated in FIG. 9, the BWPs include: a BWP 902 with a bandwidth of 40 MHz and a subcarrier spacing of 15 kHz; a BWP 904 with a bandwidth of 10 MHz and a subcarrier spacing of 15 kHz; and a BWP 906 with a bandwidth of 20 MHz and a subcarrier spacing of 60 KHz. The BWP 902 may be an initial active BWP, and the BWP 904 may be a default BWP. The UE may switch between BWPs at switching points. In the example of FIG. 9, the UE may switch from the BWP 902 to the BWP 904 at a switching point 908. The switching at the switching point 908 may occur for any suitable reason, for example, in response to an expiry of a BWP inactivity timer (indicating switching to the default BWP) and/or in response to receiving a DCI indicating BWP 904 as the active BWP. The UE may switch at a switching point 910 from active BWP 904 to BWP 906 in response receiving a DCI indicating BWP 906 as the active BWP. The UE may switch at a switching point 912 from active BWP 906 to BWP 904 in response to an expiry of a BWP inactivity timer and/or in response receiving a DCI indicating BWP 904 as the active BWP. The UE may switch at a switching point 914 from active BWP 904 to BWP 902 in response receiving a DCI indicating BWP 902 as the active BWP.

If a UE is configured for a secondary cell with a default downlink BWP in a set of configured downlink BWPs and a timer value, UE procedures for switching BWPs on a secondary cell may be the same/similar as those on a primary cell. For example, the UE may use the timer value and the default downlink BWP for the secondary cell in the same/similar manner as the UE would use these values for a primary cell.

To provide for greater data rates, two or more carriers can be aggregated and simultaneously transmitted to/from the same UE using carrier aggregation (CA). The aggregated carriers in CA may be referred to as component carriers (CCs). When CA is used, there are a number of serving cells for the UE, one for a CC. The CCs may have three configurations in the frequency domain.

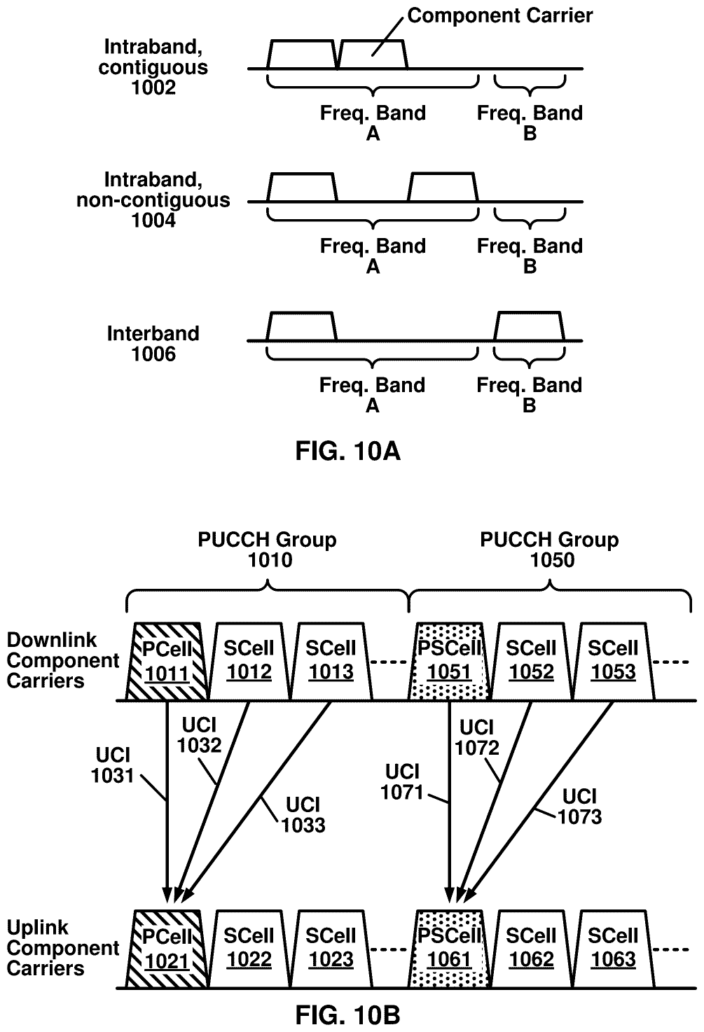

FIG. 10A illustrates the three CA configurations with two CCs. In the intraband, contiguous configuration 1002, the two CCs are aggregated in the same frequency band (frequency band A) and are located directly adjacent to each other within the frequency band. In the intraband, non-contiguous configuration 1004, the two CCs are aggregated in the same frequency band (frequency band A) and are separated in the frequency band by a gap. In the interband configuration 1006, the two CCs are located in frequency bands (frequency band A and frequency band B).

In an example, up to 32 CCs may be aggregated. The aggregated CCs may have the same or different bandwidths, subcarrier spacing, and/or duplexing schemes (TDD or FDD). A serving cell for a UE using CA may have a downlink CC. For FDD, one or more uplink CCs may be optionally configured for a serving cell. The ability to aggregate more downlink carriers than uplink carriers may be useful, for example, when the UE has more data traffic in the downlink than in the uplink.

When CA is used, one of the aggregated cells for a UE may be referred to as a primary cell (PCell). The PCell may be the serving cell that the UE initially connects to at RRC connection establishment, reestablishment, and/or handover. The PCell may provide the UE with NAS mobility information and the security input. UEs may have different PCells. In the downlink, the carrier corresponding to the PCell may be referred to as the downlink primary CC (DL PCC). In the uplink, the carrier corresponding to the PCell may be referred to as the uplink primary CC (UL PCC). The other aggregated cells for the UE may be referred to as secondary cells (SCells). In an example, the SCells may be configured after the PCell is configured for the UE. For example, an SCell may be configured through an RRC Connection Reconfiguration procedure. In the downlink, the carrier corresponding to an SCell may be referred to as a downlink secondary CC (DL SCC). In the uplink, the carrier corresponding to the SCell may be referred to as the uplink secondary CC (UL SCC).

Configured SCells for a UE may be activated and deactivated based on, for example, traffic and channel conditions. Deactivation of an SCell may mean that PDCCH and PDSCH reception on the SCell is stopped and PUSCH, SRS, and CQI transmissions on the SCell are stopped. Configured SCells may be activated and deactivated using a MAC CE with respect to FIG. 4B. For example, a MAC CE may use a bitmap (e.g., one bit per SCell) to indicate which SCells (e.g., in a subset of configured SCells) for the UE are activated or deactivated. Configured SCells may be deactivated in response to an expiration of an SCell deactivation timer (e.g., one SCell deactivation timer per SCell).

Downlink control information, such as scheduling assignments and scheduling grants, for a cell may be transmitted on the cell corresponding to the assignments and grants, which is known as self-scheduling. The DCI for the cell may be transmitted on another cell, which is known as cross-carrier scheduling. Uplink control information (e.g., HARQ acknowledgments and channel state feedback, such as CQI, PMI, and/or RI) for aggregated cells may be transmitted on the PUCCH of the PCell. For a larger number of aggregated downlink CCs, the PUCCH of the PCell may become overloaded. Cells may be divided into multiple PUCCH groups.

FIG. 10B illustrates an example of how aggregated cells may be configured into one or more PUCCH groups. A PUCCH group 1010 and a PUCCH group 1050 may include one or more downlink CCs, respectively. In the example of FIG. 10B, the PUCCH group 1010 includes three downlink CCs: a PCell 1011, an SCell 1012, and an SCell 1013. The PUCCH group 1050 includes three downlink CCs in the present example: a PCell 1051, an SCell 1052, and an SCell 1053. One or more uplink CCs may be configured as a PCell 1021, an SCell 1022, and an SCell 1023. One or more other uplink CCs may be configured as a primary SCell (PSCell) 1061, an SCell 1062, and an SCell 1063. Uplink control information (UCI) related to the downlink CCs of the PUCCH group 1010, shown as UCI 1031, UCI 1032, and UCI 1033, may be transmitted in the uplink of the PCell 1021. Uplink control information (UCI) related to the downlink CCs of the PUCCH group 1050, shown as UCI 1071, UCI 1072, and UCI 1073, may be transmitted in the uplink of the PSCell 1061. In an example, if the aggregated cells depicted in FIG. 10B were not divided into the PUCCH group 1010 and the PUCCH group 1050, a single uplink PCell to transmit UCI relating to the downlink CCs, and the PCell may become overloaded. By dividing transmissions of UCI between the PCell 1021 and the PSCell 1061, overloading may be prevented.

A cell, comprising a downlink carrier and optionally an uplink carrier, may be assigned with a physical cell ID and a cell index. The physical cell ID or the cell index may identify a downlink carrier and/or an uplink carrier of the cell, for example, depending on the context in which the physical cell ID is used. A physical cell ID may be determined using a synchronization signal transmitted on a downlink component carrier. A cell index may be determined using RRC messages. In the disclosure, a physical cell ID may be referred to as a carrier ID, and a cell index may be referred to as a carrier index. For example, when the disclosure refers to a first physical cell ID for a first downlink carrier, the disclosure may mean the first physical cell ID is for a cell comprising the first downlink carrier. The same/similar concept may apply to, for example, a carrier activation. When the disclosure indicates that a first carrier is activated, the specification may mean that a cell comprising the first carrier is activated.

In CA, a multi-carrier nature of a PHY may be exposed to a MAC. In an example, a HARQ entity may operate on a serving cell. A transport block may be generated per assignment/grant per serving cell. A transport block and potential HARQ retransmissions of the transport block may be mapped to a serving cell.

In the downlink, a base station may transmit (e.g., unicast, multicast, and/or broadcast) one or more Reference Signals (RSs) to a UE (e.g., PSS, SSS, CSI-RS, DMRS, and/or PT-RS, as shown in FIG. 5A). In the uplink, the UE may transmit one or more RSs to the base station (e.g., DMRS, PT-RS, and/or SRS, as shown in FIG. 5B). The PSS and the SSS may be transmitted by the base station and used by the UE to synchronize the UE to the base station. The PSS and the SSS may be provided in a synchronization signal (SS)/physical broadcast channel (PBCH) block that includes the PSS, the SSS, and the PBCH. The base station may periodically transmit a burst of SS/PBCH blocks.

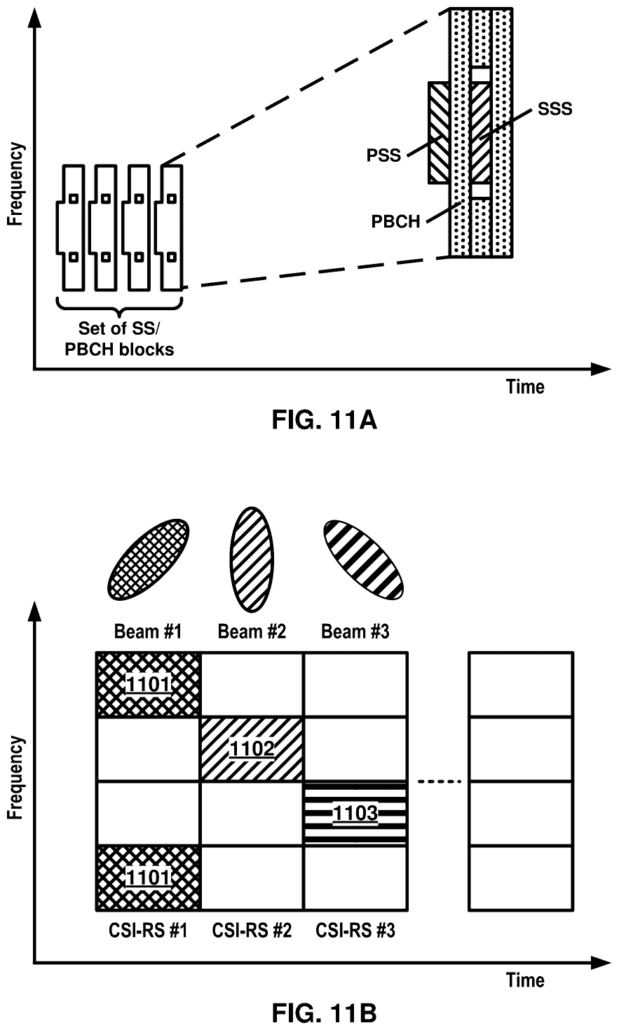

FIG. 11A illustrates an example of an SS/PBCH block's structure and location. A burst of SS/PBCH blocks may include one or more SS/PBCH blocks (e.g., 4 SS/PBCH blocks, as shown in FIG. 11A). Bursts may be transmitted periodically (e.g., every 2 frames or 20 ms). A burst may be restricted to a half-frame (e.g., a first half-frame having a duration of 5 ms). It will be understood that FIG. 11A is an example, and that these parameters (number of SS/PBCH blocks per burst, periodicity of bursts, position of burst within the frame) may be configured based on, for example: a carrier frequency of a cell in which the SS/PBCH block is transmitted; a numerology or subcarrier spacing of the cell; a configuration by the network (e.g., using RRC signaling); or any other suitable factor. In an example, the UE may assume a subcarrier spacing for the SS/PBCH block based on the carrier frequency being monitored, unless the radio network configured the UE to assume a different subcarrier spacing.

The SS/PBCH block may span one or more OFDM symbols in the time domain (e.g., 4 OFDM symbols, as shown in the example of FIG. 11A) and may span one or more subcarriers in the frequency domain (e.g., 240 contiguous subcarriers). The PSS, the SSS, and the PBCH may have a common center frequency. The PSS may be transmitted first and may span, for example, 1 OFDM symbol and 127 subcarriers. The SSS may be transmitted after the PSS (e.g., two symbols later) and may span 1 OFDM symbol and 127 subcarriers. The PBCH may be transmitted after the PSS (e.g., across the next 3 OFDM symbols) and may span 240 subcarriers.

The location of the SS/PBCH block in the time and frequency domains may not be known to the UE (e.g., if the UE is searching for the cell). To find and select the cell, the UE may monitor a carrier for the PSS. For example, the UE may monitor a frequency location within the carrier. If the PSS is not found after a certain duration (e.g., 20 ms), the UE may search for the PSS at a different frequency location within the carrier, as indicated by a synchronization raster. If the PSS is found at a location in the time and frequency domains, the UE may determine, based on a known structure of the SS/PBCH block, the locations of the SSS and the PBCH, respectively. The SS/PBCH block may be a cell-defining SS block (CD-SSB). In an example, a primary cell may be associated with a CD-SSB. The CD-SSB may be located on a synchronization raster. In an example, a cell selection/search and/or reselection may be based on the CD-SSB.

The SS/PBCH block may be used by the UE to determine one or more parameters of the cell. For example, the UE may determine a physical cell identifier (PCI) of the cell based on the sequences of the PSS and the SSS, respectively. The UE may determine a location of a frame boundary of the cell based on the location of the SS/PBCH block. For example, the SS/PBCH block may indicate that it has been transmitted in accordance with a transmission pattern, wherein a SS/PBCH block in the transmission pattern is a known distance from the frame boundary.

The PBCH may use a QPSK modulation and may use forward error correction (FEC). The FEC may use polar coding. One or more symbols spanned by the PBCH may carry one or more DMRSs for demodulation of the PBCH. The PBCH may include an indication of a current system frame number (SFN) of the cell and/or a SS/PBCH block timing index. These parameters may facilitate time synchronization of the UE to the base station. The PBCH may include a master information block (MIB) used to provide the UE with one or more parameters. The MIB may be used by the UE to locate remaining minimum system information (RMSI) associated with the cell. The RMSI may include a System Information Block Type 1 (SIB1). The SIB1 may contain information needed by the UE to access the cell. The UE may use one or more parameters of the MIB to monitor PDCCH, which may be used to schedule PDSCH. The PDSCH may include the SIB1. The SIB1 may be decoded using parameters provided in the MIB. The PBCH may indicate an absence of SIB1. Based on the PBCH indicating the absence of SIB1, the UE may be pointed to a frequency. The UE may search for an SS/PBCH block at the frequency to which the UE is pointed.

The UE may assume that one or more SS/PBCH blocks transmitted with a same SS/PBCH block index are quasi co-located (QCLed) (e.g., having the same/similar Doppler spread, Doppler shift, average gain, average delay, and/or spatial Rx parameters). The UE may not assume QCL for SS/PBCH block transmissions having different SS/PBCH block indices.

SS/PBCH blocks (e.g., those within a half-frame) may be transmitted in spatial directions (e.g., using different beams that span a coverage area of the cell). In an example, a first SS/PBCH block may be transmitted in a first spatial direction using a first beam, and a second SS/PBCH block may be transmitted in a second spatial direction using a second beam.

In an example, within a frequency span of a carrier, a base station may transmit a plurality of SS/PBCH blocks. In an example, a first PCI of a first SS/PBCH block of the plurality of SS/PBCH blocks may be different from a second PCI of a second SS/PBCH block of the plurality of SS/PBCH blocks. The PCIs of SS/PBCH blocks transmitted in different frequency locations may be different or the same.

The CSI-RS may be transmitted by the base station and used by the UE to acquire channel state information (CSI). The base station may configure the UE with one or more CSI-RSs for channel estimation or any other suitable purpose. The base station may configure a UE with one or more of the same/similar CSI-RSs. The UE may measure the one or more CSI-RSs. The UE may estimate a downlink channel state and/or generate a CSI report based on the measuring of the one or more downlink CSI-RSs. The UE may provide the CSI report to the base station. The base station may use feedback provided by the UE (e.g., the estimated downlink channel state) to perform link adaptation.

The base station may semi-statically configure the UE with one or more CSI-RS resource sets. A CSI-RS resource may be associated with a location in the time and frequency domains and a periodicity. The base station may selectively activate and/or deactivate a CSI-RS resource. The base station may indicate to the UE that a CSI-RS resource in the CSI-RS resource set is activated and/or deactivated.

The base station may configure the UE to report CSI measurements. The base station may configure the UE to provide CSI reports periodically, aperiodically, or semi-persistently. For periodic CSI reporting, the UE may be configured with a timing and/or periodicity of a plurality of CSI reports. For aperiodic CSI reporting, the base station may request a CSI report. For example, the base station may command the UE to measure a configured CSI-RS resource and provide a CSI report relating to the measurements. For semi-persistent CSI reporting, the base station may configure the UE to transmit periodically, and selectively activate or deactivate the periodic reporting. The base station may configure the UE with a CSI-RS resource set and CSI reports using RRC signaling.

The CSI-RS configuration may comprise one or more parameters indicating, for example, up to 32 antenna ports. The UE may be configured to employ the same OFDM symbols for a downlink CSI-RS and a control resource set (CORESET) when the downlink CSI-RS and CORESET are spatially QCLed and resource elements associated with the downlink CSI-RS are outside of the physical resource blocks (PRBs) configured for the CORESET. The UE may be configured to employ the same OFDM symbols for downlink CSI-RS and SS/PBCH blocks when the downlink CSI-RS and SS/PBCH blocks are spatially QCLed and resource elements associated with the downlink CSI-RS are outside of PRBs configured for the SS/PBCH blocks.

Downlink DMRSs may be transmitted by a base station and used by a UE for channel estimation. For example, the downlink DMRS may be used for coherent demodulation of one or more downlink physical channels (e.g., PDSCH). An NR network may support one or more variable and/or configurable DMRS patterns for data demodulation. At least one downlink DMRS configuration may support a front-loaded DMRS pattern. A front-loaded DMRS may be mapped over one or more OFDM symbols (e.g., one or two adjacent OFDM symbols). A base station may semi-statically configure the UE with a number (e.g. a maximum number) of front-loaded DMRS symbols for PDSCH. A DMRS configuration may support one or more DMRS ports. For example, for single user-MIMO, a DMRS configuration may support up to eight orthogonal downlink DMRS ports per UE. For multiuser-MIMO, a DMRS configuration may support up to 4 orthogonal downlink DMRS ports per UE. A radio network may support (e.g., at least for CP-OFDM) a common DMRS structure for downlink and uplink, wherein a DMRS location, a DMRS pattern, and/or a scrambling sequence may be the same or different. The base station may transmit a downlink DMRS and a corresponding PDSCH using the same precoding matrix. The UE may use the one or more downlink DMRSs for coherent demodulation/channel estimation of the PDSCH.

In an example, a transmitter (e.g., a base station) may use a precoder matrices for a part of a transmission bandwidth. For example, the transmitter may use a first precoder matrix for a first bandwidth and a second precoder matrix for a second bandwidth. The first precoder matrix and the second precoder matrix may be different based on the first bandwidth being different from the second bandwidth. The UE may assume that a same precoding matrix is used across a set of PRBs. The set of PRBs may be denoted as a precoding resource block group (PRG).

A PDSCH may comprise one or more layers. The UE may assume that at least one symbol with DMRS is present on a layer of the one or more layers of the PDSCH. A higher layer may configure up to 3 DMRSs for the PDSCH.

Downlink PT-RS may be transmitted by a base station and used by a UE for phase-noise compensation. Whether a downlink PT-RS is present or not may depend on an RRC configuration. The presence and/or pattern of the downlink PT-RS may be configured on a UE-specific basis using a combination of RRC signaling and/or an association with one or more parameters employed for other purposes (e.g., modulation and coding scheme (MCS)), which may be indicated by DCI. When configured, a dynamic presence of a downlink PT-RS may be associated with one or more DCI parameters comprising at least MCS. An NR network may support a plurality of PT-RS densities defined in the time and/or frequency domains. When present, a frequency domain density may be associated with at least one configuration of a scheduled bandwidth. The UE may assume a same precoding for a DMRS port and a PT-RS port. A number of PT-RS ports may be fewer than a number of DMRS ports in a scheduled resource. Downlink PT-RS may be confined in the scheduled time/frequency duration for the UE. Downlink PT-RS may be transmitted on symbols to facilitate phase tracking at the receiver.

The UE may transmit an uplink DMRS to a base station for channel estimation. For example, the base station may use the uplink DMRS for coherent demodulation of one or more uplink physical channels. For example, the UE may transmit an uplink DMRS with a PUSCH and/or a PUCCH. The uplink DM-RS may span a range of frequencies that is similar to a range of frequencies associated with the corresponding physical channel. The base station may configure the UE with one or more uplink DMRS configurations. At least one DMRS configuration may support a front-loaded DMRS pattern. The front-loaded DMRS may be mapped over one or more OFDM symbols (e.g., one or two adjacent OFDM symbols). One or more uplink DMRSs may be configured to transmit at one or more symbols of a PUSCH and/or a PUCCH. The base station may semi-statically configure the UE with a number (e.g. maximum number) of front-loaded DMRS symbols for the PUSCH and/or the PUCCH, which the UE may use to schedule a single-symbol DMRS and/or a double-symbol DMRS. An NR network may support (e.g., for cyclic prefix orthogonal frequency division multiplexing (CP-OFDM) a common DMRS structure for downlink and uplink, wherein a DMRS location, a DMRS pattern, and/or a scrambling sequence for the DMRS may be the same or different.

A PUSCH may comprise one or more layers, and the UE may transmit at least one symbol with DMRS present on a layer of the one or more layers of the PUSCH. In an example, a higher layer may configure up to three DMRSs for the PUSCH.

Uplink PT-RS (which may be used by a base station for phase tracking and/or phase-noise compensation) may or may not be present depending on an RRC configuration of the UE. The presence and/or pattern of uplink PT-RS may be configured on a UE-specific basis by a combination of RRC signaling and/or one or more parameters employed for other purposes (e.g., Modulation and Coding Scheme (MCS)), which may be indicated by DCI. When configured, a dynamic presence of uplink PT-RS may be associated with one or more DCI parameters comprising at least MCS. A radio network may support a plurality of uplink PT-RS densities defined in time/frequency domain. When present, a frequency domain density may be associated with at least one configuration of a scheduled bandwidth. The UE may assume a same precoding for a DMRS port and a PT-RS port. A number of PT-RS ports may be fewer than a number of DMRS ports in a scheduled resource. For example, uplink PT-RS may be confined in the scheduled time/frequency duration for the UE.

SRS may be transmitted by a UE to a base station for channel state estimation to support uplink channel dependent scheduling and/or link adaptation. SRS transmitted by the UE may allow a base station to estimate an uplink channel state at one or more frequencies. A scheduler at the base station may employ the estimated uplink channel state to assign one or more resource blocks for an uplink PUSCH transmission from the UE. The base station may semi-statically configure the UE with one or more SRS resource sets. For an SRS resource set, the base station may configure the UE with one or more SRS resources. An SRS resource set applicability may be configured by a higher layer (e.g., RRC) parameter. For example, when a higher layer parameter indicates beam management, an SRS resource in a SRS resource set of the one or more SRS resource sets (e.g., with the same/similar time domain behavior, periodic, aperiodic, and/or the like) may be transmitted at a time instant (e.g., simultaneously). The UE may transmit one or more SRS resources in SRS resource sets. An NR network may support aperiodic, periodic and/or semi-persistent SRS transmissions. The UE may transmit SRS resources based on one or more trigger types, wherein the one or more trigger types may comprise higher layer signaling (e.g., RRC) and/or one or more DCI formats. In an example, at least one DCI format may be employed for the UE to select at least one of one or more configured SRS resource sets. An SRS trigger type 0 may refer to an SRS triggered based on a higher layer signaling. An SRS trigger type 1 may refer to an SRS triggered based on one or more DCI formats. In an example, when PUSCH and SRS are transmitted in a same slot, the UE may be configured to transmit SRS after a transmission of a PUSCH and a corresponding uplink DMRS.

The base station may semi-statically configure the UE with one or more SRS configuration parameters indicating at least one of following: a SRS resource configuration identifier; a number of SRS ports; time domain behavior of an SRS resource configuration (e.g., an indication of periodic, semi-persistent, or aperiodic SRS); slot, mini-slot, and/or subframe level periodicity; offset for a periodic and/or an aperiodic SRS resource; a number of OFDM symbols in an SRS resource; a starting OFDM symbol of an SRS resource; an SRS bandwidth; a frequency hopping bandwidth; a cyclic shift; and/or an SRS sequence ID.

An antenna port is defined such that the channel over which a symbol on the antenna port is conveyed can be inferred from the channel over which another symbol on the same antenna port is conveyed. If a first symbol and a second symbol are transmitted on the same antenna port, the receiver may infer the channel (e.g., fading gain, multipath delay, and/or the like) for conveying the second symbol on the antenna port, from the channel for conveying the first symbol on the antenna port. A first antenna port and a second antenna port may be referred to as quasi co-located (QCLed) if one or more large-scale properties of the channel over which a first symbol on the first antenna port is conveyed may be inferred from the channel over which a second symbol on a second antenna port is conveyed. The one or more large-scale properties may comprise at least one of: a delay spread; a Doppler spread; a Doppler shift; an average gain; an average delay; and/or spatial Receiving (Rx) parameters.

Channels that use beamforming require beam management. Beam management may comprise beam measurement, beam selection, and beam indication. A beam may be associated with one or more reference signals. For example, a beam may be identified by one or more beamformed reference signals. The UE may perform downlink beam measurement based on downlink reference signals (e.g., a channel state information reference signal (CSI-RS)) and generate a beam measurement report. The UE may perform the downlink beam measurement procedure after an RRC connection is set up with a base station.

FIG. 11B illustrates an example of channel state information reference signals (CSI-RSs) that are mapped in the time and frequency domains. A square shown in FIG. 11B may span a resource block (RB) within a bandwidth of a cell. A base station may transmit one or more RRC messages comprising CSI-RS resource configuration parameters indicating one or more CSI-RSs. One or more of the following parameters may be configured by higher layer signaling (e.g., RRC and/or MAC signaling) for a CSI-RS resource configuration: a CSI-RS resource configuration identity, a number of CSI-RS ports, a CSI-RS configuration (e.g., symbol and resource element (RE) locations in a subframe), a CSI-RS subframe configuration (e.g., subframe location, offset, and periodicity in a radio frame), a CSI-RS power parameter, a CSI-RS sequence parameter, a code division multiplexing (CDM) type parameter, a frequency density, a transmission comb, quasi co-location (QCL) parameters (e.g., QCL-scramblingidentity, crs-portscount, mbsfn-subframeconfiglist, csi-rs-configZPid, qcl-csi-rs-configNZPid), and/or other radio resource parameters.

The three beams illustrated in FIG. 11B may be configured for a UE in a UE-specific configuration. Three beams are illustrated in FIG. 11B (beam #1, beam #2, and beam #3), more or fewer beams may be configured. Beam #1 may be allocated with CSI-RS 1101 that may be transmitted in one or more subcarriers in an RB of a first symbol. Beam #2 may be allocated with CSI-RS 1102 that may be transmitted in one or more subcarriers in an RB of a second symbol. Beam #3 may be allocated with CSI-RS 1103 that may be transmitted in one or more subcarriers in an RB of a third symbol. By using frequency division multiplexing (FDM), a base station may use other subcarriers in a same RB (for example, those that are not used to transmit CSI-RS 1101) to transmit another CSI-RS associated with a beam for another UE. By using time domain multiplexing (TDM), beams used for the UE may be configured such that beams for the UE use symbols from beams of other UEs.

CSI-RSs such as those illustrated in FIG. 11B (e.g., CSI-RS 1101, 1102, 1103) may be transmitted by the base station and used by the UE for one or more measurements. For example, the UE may measure a reference signal received power (RSRP) of configured CSI-RS resources. The base station may configure the UE with a reporting configuration and the UE may report the RSRP measurements to a network (for example, via one or more base stations) based on the reporting configuration. In an example, the base station may determine, based on the reported measurement results, one or more transmission configuration indication (TCI) states comprising a number of reference signals. In an example, the base station may indicate one or more TCI states to the UE (e.g., via RRC signaling, a MAC CE, and/or a DCI). The UE may receive a downlink transmission with a receive (Rx) beam determined based on the one or more TCI states. In an example, the UE may or may not have a capability of beam correspondence. If the UE has the capability of beam correspondence, the UE may determine a spatial domain filter of a transmit (Tx) beam based on a spatial domain filter of the corresponding Rx beam. If the UE does not have the capability of beam correspondence, the UE may perform an uplink beam selection procedure to determine the spatial domain filter of the Tx beam. The UE may perform the uplink beam selection procedure based on one or more sounding reference signal (SRS) resources configured to the UE by the base station. The base station may select and indicate uplink beams for the UE based on measurements of the one or more SRS resources transmitted by the UE.

In a beam management procedure, a UE may assess (e.g., measure) a channel quality of one or more beam pair links, a beam pair link comprising a transmitting beam transmitted by a base station and a receiving beam received by the UE. Based on the assessment, the UE may transmit a beam measurement report indicating one or more beam pair quality parameters comprising, e.g., one or more beam identifications (e.g., a beam index, a reference signal index, or the like), RSRP, a precoding matrix indicator (PMI), a channel quality indicator (CQI), and/or a rank indicator (RI).

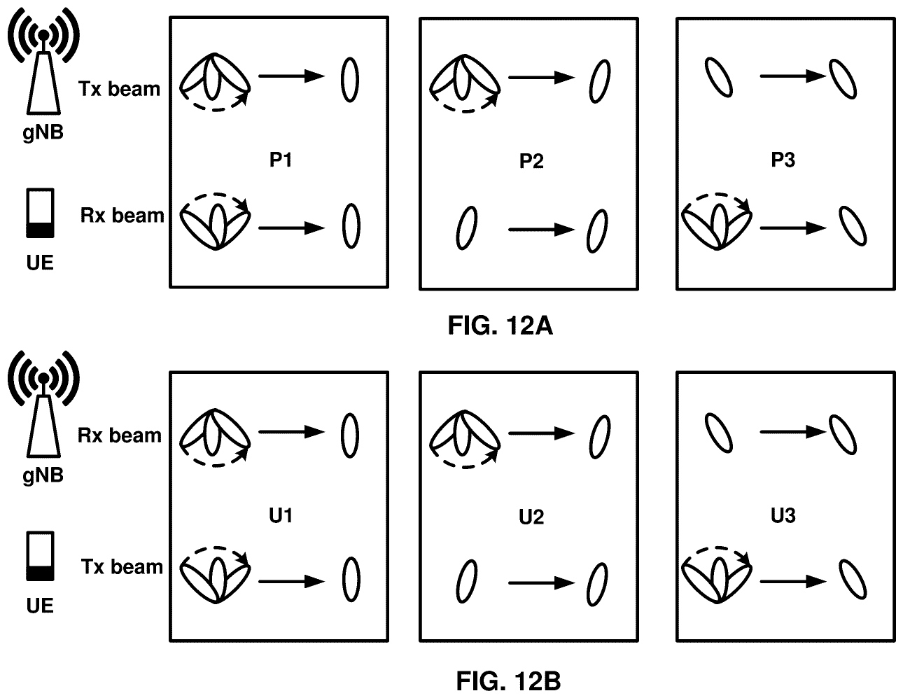

FIG. 12A illustrates examples of three downlink beam management procedures: P1, P2, and P3. Procedure P1 may enable a UE measurement on transmit (Tx) beams of a transmission reception point (TRP) (or multiple TRPs), e.g., to support a selection of one or more base station Tx beams and/or UE Rx beams (shown as ovals in the top row and bottom row, respectively, of P1). Beamforming at a TRP may comprise a Tx beam sweep for a set of beams (shown, in the top rows of P1 and P2, as ovals rotated in a counter-clockwise direction indicated by the dashed arrow). Beamforming at a UE may comprise an Rx beam sweep for a set of beams (shown, in the bottom rows of P1 and P3, as ovals rotated in a clockwise direction indicated by the dashed arrow). Procedure P2 may be used to enable a UE measurement on Tx beams of a TRP (shown, in the top row of P2, as ovals rotated in a counter-clockwise direction indicated by the dashed arrow). The UE and/or the base station may perform procedure P2 using a smaller set of beams than is used in procedure P1, or using narrower beams than the beams used in procedure P1. This may be referred to as beam refinement. The UE may perform procedure P3 for Rx beam determination by using the same Tx beam at the base station and sweeping an Rx beam at the UE.

FIG. 12B illustrates examples of three uplink beam management procedures: U1, U2, and U3. Procedure U1 may be used to enable a base station to perform a measurement on Tx beams of a UE, e.g., to support a selection of one or more UE Tx beams and/or base station Rx beams (shown as ovals in the top row and bottom row, respectively, of U1). Beamforming at the UE may include, e.g., a Tx beam sweep from a set of beams (shown in the bottom rows of U1 and U3 as ovals rotated in a clockwise direction indicated by the dashed arrow). Beamforming at the base station may include, e.g., an Rx beam sweep from a set of beams (shown, in the top rows of U1 and U2, as ovals rotated in a counter-clockwise direction indicated by the dashed arrow). Procedure U2 may be used to enable the base station to adjust its Rx beam when the UE uses a fixed Tx beam. The UE and/or the base station may perform procedure U2 using a smaller set of beams than is used in procedure P1, or using narrower beams than the beams used in procedure P1. This may be referred to as beam refinement The UE may perform procedure U3 to adjust its Tx beam when the base station uses a fixed Rx beam.

A UE may initiate a beam failure recovery (BFR) procedure based on detecting a beam failure. The UE may transmit a BFR request (e.g., a preamble, a UCI, an SR, a MAC CE, and/or the like) based on the initiating of the BFR procedure. The UE may detect the beam failure based on a determination that a quality of beam pair link(s) of an associated control channel is unsatisfactory (e.g., having an error rate higher than an error rate threshold, a received signal power lower than a received signal power threshold, an expiration of a timer, and/or the like).

The UE may measure a quality of a beam pair link using one or more reference signals (RSs) comprising one or more SS/PBCH blocks, one or more CSI-RS resources, and/or one or more demodulation reference signals (DMRSs). A quality of the beam pair link may be based on one or more of a block error rate (BLER), an RSRP value, a signal to interference plus noise ratio (SINR) value, a reference signal received quality (RSRQ) value, and/or a CSI value measured on RS resources. The base station may indicate that an RS resource is quasi co-located (QCLed) with one or more DM-RSs of a channel (e.g., a control channel, a shared data channel, and/or the like). The RS resource and the one or more DMRSs of the channel may be QCLed when the channel characteristics (e.g., Doppler shift, Doppler spread, average delay, delay spread, spatial Rx parameter, fading, and/or the like) from a transmission via the RS resource to the UE are similar or the same as the channel characteristics from a transmission via the channel to the UE.

A network (e.g., a gNB and/or an ng-eNB of a network) and/or the UE may initiate a random access procedure. A UE in an RRC_IDLE state and/or an RRC_INACTIVE state may initiate the random access procedure to request a connection setup to a network. The UE may initiate the random access procedure from an RRC_CONNECTED state. The UE may initiate the random access procedure to request uplink resources (e.g., for uplink transmission of an SR when there is no PUCCH resource available) and/or acquire uplink timing (e.g., when uplink synchronization status is non-synchronized). The UE may initiate the random access procedure to request one or more system information blocks (SIBs) (e.g., other system information such as SIB2, SIB3, and/or the like). The UE may initiate the random access procedure for a beam failure recovery request. A network may initiate a random access procedure for a handover and/or for establishing time alignment for an SCell addition.

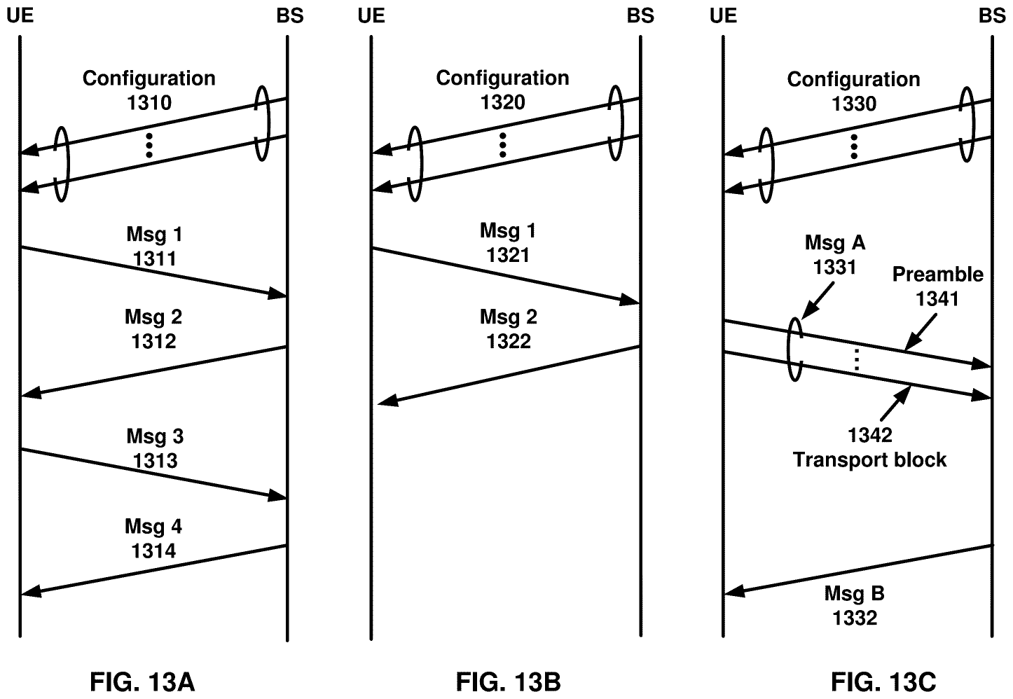

FIG. 13A illustrates a four-step contention-based random access procedure. Prior to initiation of the procedure, a base station may transmit a configuration message 1310 to the UE. The procedure illustrated in FIG. 13A comprises transmission of four messages: a Msg 1 1311, a Msg 2 1312, a Msg 3 1313, and a Msg 4 1314. The Msg 1 1311 may include and/or be referred to as a preamble (or a random access preamble). The Msg 2 1312 may include and/or be referred to as a random access response (RAR).

The configuration message 1310 may be transmitted, for example, using one or more RRC messages. The one or more RRC messages may indicate one or more random access channel (RACH) parameters to the UE. The one or more RACH parameters may comprise at least one of following: general parameters for one or more random access procedures (e.g., RACH-configGeneral); cell-specific parameters (e.g., RACH-ConfigCommon); and/or dedicated parameters (e.g., RACH-configDedicated). The base station may broadcast or multicast the one or more RRC messages to one or more UEs. The one or more RRC messages may be UE-specific (e.g., dedicated RRC messages transmitted to a UE in an RRC_CONNECTED state and/or in an RRC_INACTIVE state). The UE may determine, based on the one or more RACH parameters, a time-frequency resource and/or an uplink transmit power for transmission of the Msg 1 1311 and/or the Msg 3 1313. Based on the one or more RACH parameters, the UE may determine a reception timing and a downlink channel for receiving the Msg 2 1312 and the Msg 4 1314.

The one or more RACH parameters provided in the configuration message 1310 may indicate one or more Physical RACH (PRACH) occasions available for transmission of the Msg 1 1311. The one or more PRACH occasions may be predefined. The one or more RACH parameters may indicate one or more available sets of one or more PRACH occasions (e.g., prach-Configindex). The one or more RACH parameters may indicate an association between (a) one or more PRACH occasions and (b) one or more reference signals. The one or more RACH parameters may indicate an association between (a) one or more preambles and (b) one or more reference signals. The one or more reference signals may be SS/PBCH blocks and/or CSI-RSs. For example, the one or more RACH parameters may indicate a number of SS/PBCH blocks mapped to a PRACH occasion and/or a number of preambles mapped to a SS/PBCH blocks.

The one or more RACH parameters provided in the configuration message 1310 may be used to determine an uplink transmit power of Msg 1 1311 and/or Msg 3 1313. For example, the one or more RACH parameters may indicate a reference power for a preamble transmission (e.g., a received target power and/or an initial power of the preamble transmission). There may be one or more power offsets indicated by the one or more RACH parameters. For example, the one or more RACH parameters may indicate: a power ramping step; a power offset between SSB and CSI-RS; a power offset between transmissions of the Msg 1 1311 and the Msg 3 1313; and/or a power offset value between preamble groups. The one or more RACH parameters may indicate one or more thresholds based on which the UE may determine at least one reference signal (e.g., an SSB and/or CSI-RS) and/or an uplink carrier (e.g., a normal uplink (NUL) carrier and/or a supplemental uplink (SUL) carrier).

The Msg 1 1311 may include one or more preamble transmissions (e.g., a preamble transmission and one or more preamble retransmissions). An RRC message may be used to configure one or more preamble groups (e.g., group A and/or group B). A preamble group may comprise one or more preambles. The UE may determine the preamble group based on a pathloss measurement and/or a size of the Msg 3 1313. The UE may measure an RSRP of one or more reference signals (e.g., SSBs and/or CSI-RSs) and determine at least one reference signal having an RSRP above an RSRP threshold (e.g., rsrp-ThresholdSSB and/or rsrp-ThresholdCSI-RS). The UE may select at least one preamble associated with the one or more reference signals and/or a selected preamble group, for example, if the association between the one or more preambles and the at least one reference signal is configured by an RRC message.

The UE may determine the preamble based on the one or more RACH parameters provided in the configuration message 1310. For example, the UE may determine the preamble based on a pathloss measurement, an RSRP measurement, and/or a size of the Msg 3 1313. As another example, the one or more RACH parameters may indicate: a preamble format; a maximum number of preamble transmissions; and/or one or more thresholds for determining one or more preamble groups (e.g., group A and group B). A base station may use the one or more RACH parameters to configure the UE with an association between one or more preambles and one or more reference signals (e.g., SSBs and/or CSI-RSs). If the association is configured, the UE may determine the preamble to include in Msg 1 1311 based on the association. The Msg 1 1311 may be transmitted to the base station via one or more PRACH occasions. The UE may use one or more reference signals (e.g., SSBs and/or CSI-RSs) for selection of the preamble and for determining of the PRACH occasion. One or more RACH parameters (e.g., ra-ssb-OccasionMskIndex and/or ra-OccasionList) may indicate an association between the PRACH occasions and the one or more reference signals.

The UE may perform a preamble retransmission if no response is received following a preamble transmission. The UE may increase an uplink transmit power for the preamble retransmission. The UE may select an initial preamble transmit power based on a pathloss measurement and/or a target received preamble power configured by the network. The UE may determine to retransmit a preamble and may ramp up the uplink transmit power. The UE may receive one or more RACH parameters (e.g., PREAMBLE_POWER_RAMPING_STEP) indicating a ramping step for the preamble retransmission. The ramping step may be an amount of incremental increase in uplink transmit power for a retransmission. The UE may ramp up the uplink transmit power if the UE determines a reference signal (e.g., SSB and/or CSI-RS) that is the same as a previous preamble transmission. The UE may count a number of preamble transmissions and/or retransmissions (e.g., PREAMBLE_TRANSMISSION_COUNTER). The UE may determine that a random access procedure completed unsuccessfully, for example, if the number of preamble transmissions exceeds a threshold configured by the one or more RACH parameters (e.g., preamble TransMax).

The Msg 2 1312 received by the UE may include an RAR. In some scenarios, the Msg 2 1312 may include multiple RARs corresponding to multiple UEs. The Msg 2 1312 may be received after or in response to the transmitting of the Msg 1 1311. The Msg 2 1312 may be scheduled on the DL-SCH and indicated on a PDCCH using a random access RNTI (RA-RNTI). The Msg 2 1312 may indicate that the Msg 1 1311 was received by the base station. The Msg 2 1312 may include a time-alignment command that may be used by the UE to adjust the UE's transmission timing, a scheduling grant for transmission of the Msg 3 1313, and/or a Temporary Cell RNTI (TC-RNTI). After transmitting a preamble, the UE may start a time window (e.g., ra-ResponseWindow) to monitor a PDCCH for the Msg 2 1312. The UE may determine when to start the time window based on a PRACH occasion that the UE uses to transmit the preamble. For example, the UE may start the time window one or more symbols after a last symbol of the preamble (e.g., at a first PDCCH occasion from an end of a preamble transmission). The one or more symbols may be determined based on a numerology. The PDCCH may be in a common search space (e.g., a Type1-PDCCH common search space) configured by an RRC message. The UE may identify the RAR based on a Radio Network Temporary Identifier (RNTI). RNTIs may be used depending on one or more events initiating the random access procedure. The UE may use random access RNTI (RA-RNTI). The RA-RNTI may be associated with PRACH occasions in which the UE transmits a preamble. For example, the UE may determine the RA-RNTI based on: an OFDM symbol index; a slot index; a frequency domain index; and/or a UL carrier indicator of the PRACH occasions. An example of RA-RNTI may be as follows:
RA-RNTI=1+s_id+14 xt_id+14×80×f_id+14× 80×8×ul_carrier_id, where s_id may be an index of a first OFDM symbol of the PRACH occasion (e.g., 0≤s_id<14), t_id may be an index of a first slot of the PRACH occasion in a system frame (e.g., 0≤t_id<80), f_id may be an index of the PRACH occasion in the frequency domain (e.g., 0≤f_id<8), and ul_carrier_id may be a UL carrier used for a preamble transmission (e.g., 0 for an NUL carrier, and 1 for an SUL carrier).

The UE may transmit the Msg 3 1313 in response to a successful reception of the Msg 2 1312 (e.g., using resources identified in the Msg 2 1312). The Msg 3 1313 may be used for contention resolution in, for example, the contention-based random access procedure illustrated in FIG. 13A. In some scenarios, a plurality of UEs may transmit a same preamble to a base station and the base station may provide an RAR that corresponds to a UE. Collisions may occur if the plurality of UEs interpret the RAR as corresponding to themselves. Contention resolution (e.g., using the Msg 3 1313 and the Msg 4 1314) may be used to increase the likelihood that the UE does not incorrectly use an identity of another the UE. To perform contention resolution, the UE may include a device identifier in the Msg 3 1313 (e.g., a C-RNTI if assigned, a TC-RNTI included in the Msg 2 1312, and/or any other suitable identifier).

The Msg 4 1314 may be received after or in response to the transmitting of the Msg 3 1313. If a C-RNTI was included in the Msg 3 1313, the base station will address the UE on the PDCCH using the C-RNTI. If the UE's unique C-RNTI is detected on the PDCCH, the random access procedure is determined to be successfully completed. If a TC-RNTI is included in the Msg 3 1313 (e.g., if the UE is in an RRC_IDLE state or not otherwise connected to the base station), Msg 4 1314 will be received using a DL-SCH associated with the TC-RNTI. If a MAC PDU is successfully decoded and a MAC PDU comprises the UE contention resolution identity MAC CE that matches or otherwise corresponds with the CCCH SDU sent (e.g., transmitted) in Msg 3 1313, the UE may determine that the contention resolution is successful and/or the UE may determine that the random access procedure is successfully completed.

The UE may be configured with a supplementary uplink (SUL) carrier and a normal uplink (NUL) carrier. An initial access (e.g., random access procedure) may be supported in an uplink carrier. For example, a base station may configure the UE with two separate RACH configurations: one for an SUL carrier and the other for an NUL carrier. For random access in a cell configured with an SUL carrier, the network may indicate which carrier to use (NUL or SUL). The UE may determine the SUL carrier, for example, if a measured quality of one or more reference signals is lower than a broadcast threshold. Uplink transmissions of the random access procedure (e.g., the Msg 1 1311 and/or the Msg 3 1313) may remain on the selected carrier. The UE may switch an uplink carrier during the random access procedure (e.g., between the Msg 1 1311 and the Msg 3 1313) in one or more cases. For example, the UE may determine and/or switch an uplink carrier for the Msg 1 1311 and/or the Msg 3 1313 based on a channel clear assessment (e.g., a listen-before-talk).

FIG. 13B illustrates a two-step contention-free random access procedure. Similar to the four-step contention-based random access procedure illustrated in FIG. 13A, a base station may, prior to initiation of the procedure, transmit a configuration message 1320 to the UE. The configuration message 1320 may be analogous in some respects to the configuration message 1310. The procedure illustrated in FIG. 13B comprises transmission of two messages: a Msg 1 1321 and a Msg 2 1322. The Msg 1 1321 and the Msg 2 1322 may be analogous in some respects to the Msg 1 1311 and a Msg 2 1312 illustrated in FIG. 13A, respectively. As will be understood from FIGS. 13A and 13B, the contention-free random access procedure may not include messages analogous to the Msg 3 1313 and/or the Msg 4 1314.

The contention-free random access procedure illustrated in FIG. 13B may be initiated for a beam failure recovery, other SI request, SCell addition, and/or handover. For example, a base station may indicate or assign to the UE the preamble to be used for the Msg 1 1321. The UE may receive, from the base station via PDCCH and/or RRC, an indication of a preamble (e.g., ra-PreambleIndex).

After transmitting a preamble, the UE may start a time window (e.g., ra-ResponseWindow) to monitor a PDCCH for the RAR. In the event of a beam failure recovery request, the base station may configure the UE with a separate time window and/or a separate PDCCH in a search space indicated by an RRC message (e.g., recoverySearchSpaceId). The UE may monitor for a PDCCH transmission addressed to a Cell RNTI (C-RNTI) on the search space. In the contention-free random access procedure illustrated in FIG. 13B, the UE may determine that a random access procedure successfully completes after or in response to transmission of Msg 1 1321 and reception of a corresponding Msg 2 1322. The UE may determine that a random access procedure successfully completes, for example, if a PDCCH transmission is addressed to a C-RNTI. The UE may determine that a random access procedure successfully completes, for example, if the UE receives an RAR comprising a preamble identifier corresponding to a preamble transmitted by the UE and/or the RAR comprises a MAC sub-PDU with the preamble identifier. The UE may determine the response as an indication of an acknowledgement for an SI request.

FIG. 13C illustrates another two-step random access procedure. Similar to the random access procedures illustrated in FIGS. 13A and 13B, a base station may, prior to initiation of the procedure, transmit a configuration message 1330 to the UE. The configuration message 1330 may be analogous in some respects to the configuration message 1310 and/or the configuration message 1320. The procedure illustrated in FIG. 13C comprises transmission of two messages: a Msg A 1331 and a Msg B 1332.

Msg A 1331 may be transmitted in an uplink transmission by the UE. Msg A 1331 may comprise one or more transmissions of a preamble 1341 and/or one or more transmissions of a transport block 1342. The transport block 1342 may comprise contents that are similar and/or equivalent to the contents of the Msg 3 1313 illustrated in FIG. 13A. The transport block 1342 may comprise UCI (e.g., an SR, a HARQ ACK/NACK, and/or the like). The UE may receive the Msg B 1332 after or in response to transmitting the Msg A 1331. The Msg B 1332 may comprise contents that are similar and/or equivalent to the contents of the Msg 2 1312 (e.g., an RAR) illustrated in FIGS. 13A and 13B and/or the Msg 4 1314 illustrated in FIG. 13A.

The UE may initiate the two-step random access procedure in FIG. 13C for licensed spectrum and/or unlicensed spectrum. The UE may determine, based on one or more factors, whether to initiate the two-step random access procedure. The one or more factors may be: a radio access technology in use (e.g., LTE, NR, and/or the like); whether the UE has valid TA or not; a cell size; the UE's RRC state; a type of spectrum (e.g., licensed vs. unlicensed); and/or any other suitable factors.

The UE may determine, based on two-step RACH parameters included in the configuration message 1330, a radio resource and/or an uplink transmit power for the preamble 1341 and/or the transport block 1342 included in the Msg A 1331. The RACH parameters may indicate a modulation and coding schemes (MCS), a time-frequency resource, and/or a power control for the preamble 1341 and/or the transport block 1342. A time-frequency resource for transmission of the preamble 1341 (e.g., a PRACH) and a time-frequency resource for transmission of the transport block 1342 (e.g., a PUSCH) may be multiplexed using FDM, TDM, and/or CDM. The RACH parameters may enable the UE to determine a reception timing and a downlink channel for monitoring for and/or receiving Msg B 1332.

The transport block 1342 may comprise data (e.g., delay-sensitive data), an identifier of the UE, security information, and/or device information (e.g., an International Mobile Subscriber Identity (IMSI)). The base station may transmit the Msg B 1332 as a response to the Msg A 1331. The Msg B 1332 may comprise at least one of following: a preamble identifier; a timing advance command; a power control command; an uplink grant (e.g., a radio resource assignment and/or an MCS); a UE identifier for contention resolution; and/or an RNTI (e.g., a C-RNTI or a TC-RNTI). The UE may determine that the two-step random access procedure is successfully completed if: a preamble identifier in the Msg B 1332 is matched to a preamble transmitted by the UE; and/or the identifier of the UE in Msg B 1332 is matched to the identifier of the UE in the Msg A 1331 (e.g., the transport block 1342).

A UE and a base station may exchange control signaling. The control signaling may be referred to as L1/L2 control signaling and may originate from the PHY layer (e.g., layer 1) and/or the MAC layer (e.g., layer 2). The control signaling may comprise downlink control signaling transmitted from the base station to the UE and/or uplink control signaling transmitted from the UE to the base station.

The downlink control signaling may comprise: a downlink scheduling assignment; an uplink scheduling grant indicating uplink radio resources and/or a transport format; a slot format information; a preemption indication; a power control command; and/or any other suitable signaling. The UE may receive the downlink control signaling in a payload transmitted by the base station on a physical downlink control channel (PDCCH). The payload transmitted on the PDCCH may be referred to as downlink control information (DCI). In some scenarios, the PDCCH may be a group common PDCCH (GC-PDCCH) that is common to a group of UEs.

A base station may attach one or more cyclic redundancy check (CRC) parity bits to a DCI in order to facilitate detection of transmission errors. When the DCI is intended for a UE (or a group of the UEs), the base station may scramble the CRC parity bits with an identifier of the UE (or an identifier of the group of the UEs). Scrambling the CRC parity bits with the identifier may comprise Modulo-2 addition (or an exclusive OR operation) of the identifier value and the CRC parity bits. The identifier may comprise a 16-bit value of a radio network temporary identifier (RNTI).

DCIs may be used for different purposes. A purpose may be indicated by the type of RNTI used to scramble the CRC parity bits. For example, a DCI having CRC parity bits scrambled with a paging RNTI (P-RNTI) may indicate paging information and/or a system information change notification. The P-RNTI may be predefined as “FFFE” in hexadecimal. A DCI having CRC parity bits scrambled with a system information RNTI (SI-RNTI) may indicate a broadcast transmission of the system information. The SI-RNTI may be predefined as “FFFF” in hexadecimal. A DCI having CRC parity bits scrambled with a random access RNTI (RA-RNTI) may indicate a random access response (RAR). A DCI having CRC parity bits scrambled with a cell RNTI (C-RNTI) may indicate a dynamically scheduled unicast transmission and/or a triggering of PDCCH-ordered random access. A DCI having CRC parity bits scrambled with a temporary cell RNTI (TC-RNTI) may indicate a contention resolution (e.g., a Msg 3 analogous to the Msg 3 1313 illustrated in FIG. 13A). Other RNTIs configured to the UE by a base station may comprise a Configured Scheduling RNTI (CS-RNTI), a Transmit Power Control-PUCCH RNTI (TPC-PUCCH-RNTI), a Transmit Power Control-PUSCH RNTI (TPC-PUSCH-RNTI), a Transmit Power Control-SRS RNTI (TPC-SRS-RNTI), an Interruption RNTI (INT-RNTI), a Slot Format Indication RNTI (SFI-RNTI), a Semi-Persistent CSI RNTI (SP-CSI-RNTI), a Modulation and Coding Scheme Cell RNTI (MCS-C-RNTI), and/or the like.

Depending on the purpose and/or content of a DCI, the base station may transmit the DCIs with one or more DCI formats. For example, DCI format 0_0 may be used for scheduling of PUSCH in a cell. DCI format 0_0 may be a fallback DCI format (e.g., with compact DCI payloads). DCI format 0_1 may be used for scheduling of PUSCH in a cell (e.g., with more DCI payloads than DCI format 0_0). DCI format 1_0 may be used for scheduling of PDSCH in a cell. DCI format 1_0 may be a fallback DCI format (e.g., with compact DCI payloads). DCI format 1_1 may be used for scheduling of PDSCH in a cell (e.g., with more DCI payloads than DCI format 1_0). DCI format 2_0 may be used for providing a slot format indication to a group of UEs. DCI format 2_1 may be used for notifying a group of UEs of a physical resource block and/or OFDM symbol where the UE may assume no transmission is intended to the UE. DCI format 2_2 may be used for transmission of a transmit power control (TPC) command for PUCCH or PUSCH. DCI format 2_3 may be used for transmission of a group of TPC commands for SRS transmissions by one or more UEs. DCI format(s) for new functions may be defined in future releases. DCI formats may have different DCI sizes, or may share the same DCI size.

After scrambling a DCI with a RNTI, the base station may process the DCI with channel coding (e.g., polar coding), rate matching, scrambling and/or QPSK modulation. A base station may map the coded and modulated DCI on resource elements used and/or configured for a PDCCH. Based on a payload size of the DCI and/or a coverage of the base station, the base station may transmit the DCI via a PDCCH occupying a number of contiguous control channel elements (CCEs). The number of the contiguous CCEs (referred to as aggregation level) may be 1, 2, 4, 8, 16, and/or any other suitable number. A CCE may comprise a number (e.g., 6) of resource-element groups (REGs). A REG may comprise a resource block in an OFDM symbol. The mapping of the coded and modulated DCI on the resource elements may be based on mapping of CCEs and REGs (e.g., CCE-to-REG mapping).

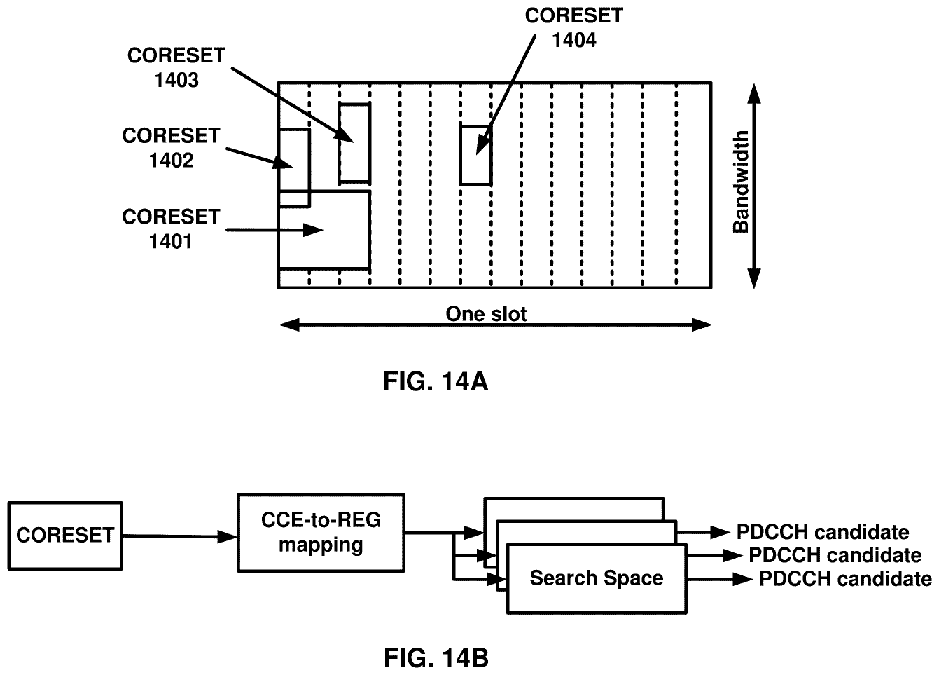

FIG. 14A illustrates an example of CORESET configurations for a bandwidth part. The base station may transmit a DCI via a PDCCH on one or more control resource sets (CORESETs). A CORESET may comprise a time-frequency resource in which the UE tries to decode a DCI using one or more search spaces. The base station may configure a CORESET in the time-frequency domain. In the example of FIG. 14A, a first CORESET 1401 and a second CORESET 1402 occur at the first symbol in a slot. The first CORESET 1401 overlaps with the second CORESET 1402 in the frequency domain. A third CORESET 1403 occurs at a third symbol in the slot. A fourth CORESET 1404 occurs at the seventh symbol in the slot. CORESETs may have a different number of resource blocks in frequency domain.

FIG. 14B illustrates an example of a CCE-to-REG mapping for DCI transmission on a CORESET and PDCCH processing. The CCE-to-REG mapping may be an interleaved mapping (e.g., for the purpose of providing frequency diversity) or a non-interleaved mapping (e.g., for the purposes of facilitating interference coordination and/or frequency-selective transmission of control channels). The base station may perform different or same CCE-to-REG mapping on different CORESETs. A CORESET may be associated with a CCE-to-REG mapping by RRC configuration. A CORESET may be configured with an antenna port quasi co-location (QCL) parameter. The antenna port QCL parameter may indicate QCL information of a demodulation reference signal (DMRS) for PDCCH reception in the CORESET.

The base station may transmit, to the UE, RRC messages comprising configuration parameters of one or more CORESETs and one or more search space sets. The configuration parameters may indicate an association between a search space set and a CORESET. A search space set may comprise a set of PDCCH candidates formed by CCEs at a given aggregation level. The configuration parameters may indicate: a number of PDCCH candidates to be monitored per aggregation level; a PDCCH monitoring periodicity and a PDCCH monitoring pattern; one or more DCI formats to be monitored by the UE; and/or whether a search space set is a common search space set or a UE-specific search space set. A set of CCEs in the common search space set may be predefined and known to the UE. A set of CCEs in the UE-specific search space set may be configured based on the UE's identity (e.g., C-RNTI).

As shown in FIG. 14B, the UE may determine a time-frequency resource for a CORESET based on RRC messages. The UE may determine a CCE-to-REG mapping (e.g., interleaved or non-interleaved, and/or mapping parameters) for the CORESET based on configuration parameters of the CORESET. The UE may determine a number (e.g., at most 10) of search space sets configured on the CORESET based on the RRC messages. The UE may monitor a set of PDCCH candidates according to configuration parameters of a search space set. The UE may monitor a set of PDCCH candidates in one or more CORESETs for detecting one or more DCIs. Monitoring may comprise decoding one or more PDCCH candidates of the set of the PDCCH candidates according to the monitored DCI formats. Monitoring may comprise decoding a DCI content of one or more PDCCH candidates with possible (or configured) PDCCH locations, possible (or configured) PDCCH formats (e.g., number of CCEs, number of PDCCH candidates in common search spaces, and/or number of PDCCH candidates in the UE-specific search spaces) and possible (or configured) DCI formats. The decoding may be referred to as blind decoding. The UE may determine a DCI as valid for the UE, in response to CRC checking (e.g., scrambled bits for CRC parity bits of the DCI matching a RNTI value). The UE may process information contained in the DCI (e.g., a scheduling assignment, an uplink grant, power control, a slot format indication, a downlink preemption, and/or the like).

The UE may transmit uplink control signaling (e.g., uplink control information (UCI)) to a base station. The uplink control signaling may comprise hybrid automatic repeat request (HARQ) acknowledgements for received DL-SCH transport blocks. The UE may transmit the HARQ acknowledgements after receiving a DL-SCH transport block. Uplink control signaling may comprise channel state information (CSI) indicating channel quality of a physical downlink channel. The UE may transmit the CSI to the base station. The base station, based on the received CSI, may determine transmission format parameters (e.g., comprising multi-antenna and beamforming schemes) for a downlink transmission. Uplink control signaling may comprise scheduling requests (SR). The UE may transmit an SR indicating that uplink data is available for transmission to the base station. The UE may transmit a UCI (e.g., HARQ acknowledgements (HARQ-ACK), CSI report, SR, and the like) via a physical uplink control channel (PUCCH) or a physical uplink shared channel (PUSCH). The UE may transmit the uplink control signaling via a PUCCH using one of several PUCCH formats.

There may be five PUCCH formats and the UE may determine a PUCCH format based on a size of the UCI (e.g., a number of uplink symbols of UCI transmission and a number of UCI bits). PUCCH format 0 may have a length of one or two OFDM symbols and may include two or fewer bits. The UE may transmit UCI in a PUCCH resource using PUCCH format 0 if the transmission is over one or two symbols and the number of HARQ-ACK information bits with positive or negative SR (HARQ-ACK/SR bits) is one or two. PUCCH format 1 may occupy a number between four and fourteen OFDM symbols and may include two or fewer bits. The UE may use PUCCH format 1 if the transmission is four or more symbols and the number of HARQ-ACK/SR bits is one or two. PUCCH format 2 may occupy one or two OFDM symbols and may include more than two bits. The UE may use PUCCH format 2 if the transmission is over one or two symbols and the number of UCI bits is two or more. PUCCH format 3 may occupy a number between four and fourteen OFDM symbols and may include more than two bits. The UE may use PUCCH format 3 if the transmission is four or more symbols, the number of UCI bits is two or more and PUCCH resource does not include an orthogonal cover code. PUCCH format 4 may occupy a number between four and fourteen OFDM symbols and may include more than two bits. The UE may use PUCCH format 4 if the transmission is four or more symbols, the number of UCI bits is two or more and the PUCCH resource includes an orthogonal cover code.

The base station may transmit configuration parameters to the UE for a plurality of PUCCH resource sets using, for example, an RRC message. The plurality of PUCCH resource sets (e.g., up to four sets) may be configured on an uplink BWP of a cell. A PUCCH resource set may be configured with a PUCCH resource set index, a plurality of PUCCH resources with a PUCCH resource being identified by a PUCCH resource identifier (e.g., pucch-Resourceid), and/or a number (e.g. a maximum number) of UCI information bits the UE may transmit using one of the plurality of PUCCH resources in the PUCCH resource set. When configured with a plurality of PUCCH resource sets, the UE may select one of the plurality of PUCCH resource sets based on a total bit length of the UCI information bits (e.g., HARQ-ACK, SR, and/or CSI). If the total bit length of UCI information bits is two or fewer, the UE may select a first PUCCH resource set having a PUCCH resource set index equal to “0”. If the total bit length of UCI information bits is greater than two and less than or equal to a first configured value, the UE may select a second PUCCH resource set having a PUCCH resource set index equal to “1”. If the total bit length of UCI information bits is greater than the first configured value and less than or equal to a second configured value, the UE may select a third PUCCH resource set having a PUCCH resource set index equal to “2”. If the total bit length of UCI information bits is greater than the second configured value and less than or equal to a third value (e.g., 1406), the UE may select a fourth PUCCH resource set having a PUCCH resource set index equal to “3”.

After determining a PUCCH resource set from a plurality of PUCCH resource sets, the UE may determine a PUCCH resource from the PUCCH resource set for UCI (HARQ-ACK, CSI, and/or SR) transmission. The UE may determine the PUCCH resource based on a PUCCH resource indicator in a DCI (e.g., with a DCI format 1_0 or DCI for 1_1) received on a PDCCH. A three-bit PUCCH resource indicator in the DCI may indicate one of eight PUCCH resources in the PUCCH resource set. Based on the PUCCH resource indicator, the UE may transmit the UCI (HARQ-ACK, CSI and/or SR) using a PUCCH resource indicated by the PUCCH resource indicator in the DCI.

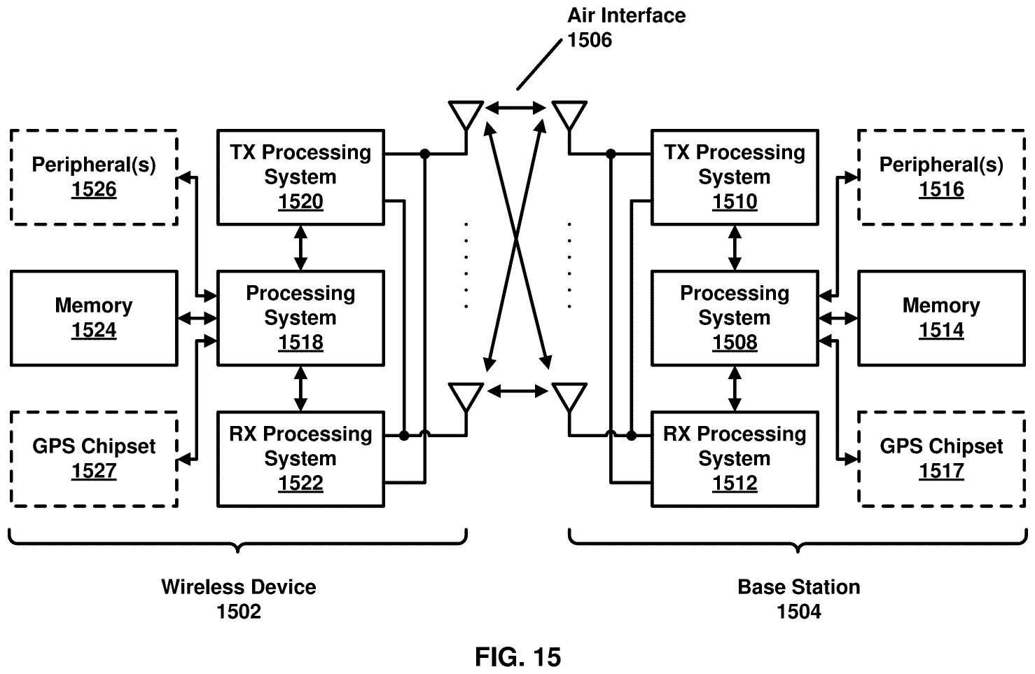

FIG. 15 illustrates an example of a wireless device 1502 in communication with a base station 1504 in accordance with embodiments of the present disclosure. The wireless device 1502 and base station 1504 may be part of a mobile communication network, such as the mobile communication network 100 illustrated in FIG. 1A, the mobile communication network 150 illustrated in FIG. 1B, or any other communication network. Only one wireless device 1502 and one base station 1504 are illustrated in FIG. 15, but it will be understood that a mobile communication network may include more than one UE and/or more than one base station, with the same or similar configuration as those shown in FIG. 15.

The base station 1504 may connect the wireless device 1502 to a core network (not shown) through radio communications over the air interface (or radio interface) 1506. The communication direction from the base station 1504 to the wireless device 1502 over the air interface 1506 is known as the downlink, and the communication direction from the wireless device 1502 to the base station 1504 over the air interface is known as the uplink. Downlink transmissions may be separated from uplink transmissions using FDD, TDD, and/or some combination of the two duplexing techniques.

In the downlink, data to be sent to the wireless device 1502 from the base station 1504 may be provided to the processing system 1508 of the base station 1504. The data may be provided to the processing system 1508 by, for example, a core network. In the uplink, data to be sent to the base station 1504 from the wireless device 1502 may be provided to the processing system 1518 of the wireless device 1502. The processing system 1508 and the processing system 1518 may implement layer 3 and layer 2 OSI functionality to process the data for transmission. Layer 2 may include an SDAP layer, a PDCP layer, an RLC layer, and a MAC layer, for example, with respect to FIG. 2A, FIG. 2B, FIG. 3, and FIG. 4A. Layer 3 may include an RRC layer as with respect to FIG. 2B.

After being processed by processing system 1508, the data to be sent to the wireless device 1502 may be provided to a transmission processing system 1510 of base station 1504. Similarly, after being processed by the processing system 1518, the data to be sent to base station 1504 may be provided to a transmission processing system 1520 of the wireless device 1502. The transmission processing system 1510 and the transmission processing system 1520 may implement layer 1 OSI functionality. Layer 1 may include a PHY layer with respect to FIG. 2A, FIG. 2B, FIG. 3, and FIG. 4A. For transmit processing, the PHY layer may perform, for example, forward error correction coding of transport channels, interleaving, rate matching, mapping of transport channels to physical channels, modulation of physical channel, multiple-input multiple-output (MIMO) or multi-antenna processing, and/or the like.

At the base station 1504, a reception processing system 1512 may receive the uplink transmission from the wireless device 1502. At the wireless device 1502, a reception processing system 1522 may receive the downlink transmission from base station 1504. The reception processing system 1512 and the reception processing system 1522 may implement layer 1 OSI functionality. Layer 1 may include a PHY layer with respect to FIG. 2A, FIG. 2B, FIG. 3, and FIG. 4A. For receive processing, the PHY layer may perform, for example, error detection, forward error correction decoding, deinterleaving, demapping of transport channels to physical channels, demodulation of physical channels, MIMO or multi-antenna processing, and/or the like.

As shown in FIG. 15, a wireless device 1502 and the base station 1504 may include multiple antennas. The multiple antennas may be used to perform one or more MIMO or multi-antenna techniques, such as spatial multiplexing (e.g., single-user MIMO or multi-user MIMO), transmit/receive diversity, and/or beamforming. In other examples, the wireless device 1502 and/or the base station 1504 may have a single antenna.

The processing system 1508 and the processing system 1518 maybe associated with a memory 1514 and a memory 1524, respectively. Memory 1514 and memory 1524 (e.g., one or more non-transitory computer readable mediums) may store computer program instructions or code that may be executed by the processing system 1508 and/or the processing system 1518 to carry out one or more of the functionalities discussed in the present application. Although not shown in FIG. 15, the transmission processing system 1510, the transmission processing system 1520, the reception processing system 1512, and/or the reception processing system 1522 may be coupled to a memory (e.g., one or more non-transitory computer readable mediums) storing computer program instructions or code that may be executed to carry out one or more of their respective functionalities.

The processing system 1508 and/or the processing system 1518 may comprise one or more controllers and/or one or more processors. The one or more controllers and/or one or more processors may comprise, for example, a general-purpose processor, a digital signal processor (DSP), a microcontroller, an application specific integrated circuit (ASIC), a field programmable gate array (FPGA) and/or other programmable logic device, discrete gate and/or transistor logic, discrete hardware components, an on-board unit, or any combination thereof. The processing system 1508 and/or the processing system 1518 may perform at least one of signal coding/processing, data processing, power control, input/output processing, and/or any other functionality that may enable the wireless device 1502 and the base station 1504 to operate in a wireless environment.

The processing system 1508 and/or the processing system 1518 may be connected to one or more peripherals 1516 and one or more peripherals 1526, respectively. The one or more peripherals 1516 and the one or more peripherals 1526 may include software and/or hardware that provide features and/or functionalities, for example, a speaker, a microphone, a keypad, a display, a touchpad, a power source, a satellite transceiver, a universal serial bus (USB) port, a hands-free headset, a frequency modulated (FM) radio unit, a media player, an Internet browser, an electronic control unit (e.g., for a motor vehicle), and/or one or more sensors (e.g., an accelerometer, a gyroscope, a temperature sensor, a radar sensor, a lidar sensor, an ultrasonic sensor, a light sensor, a camera, and/or the like). The processing system 1508 and/or the processing system 1518 may receive user input data from and/or provide user output data to the one or more peripherals 1516 and/or the one or more peripherals 1526. The processing system 1518 in the wireless device 1502 may receive power from a power source and/or may be configured to distribute the power to the other components in the wireless device 1502. The power source may comprise one or more sources of power, for example, a battery, a solar cell, a fuel cell, or any combination thereof. The processing system 1508 and/or the processing system 1518 may be connected to a GPS chipset 1517 and a GPS chipset 1527, respectively. The GPS chipset 1517 and the GPS chipset 1527 may be configured to provide geographic location information of the wireless device 1502 and the base station 1504, respectively.

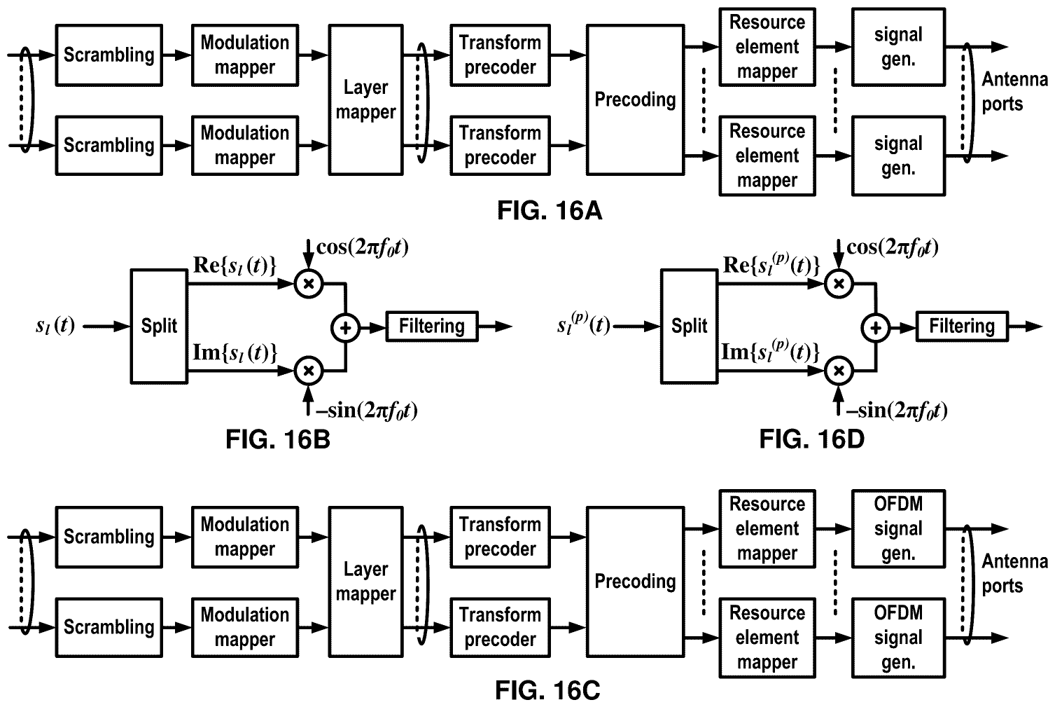

FIG. 16A illustrates an example structure for uplink transmission. A baseband signal representing a physical uplink shared channel may perform one or more functions. The one or more functions may comprise at least one of: scrambling; modulation of scrambled bits to generate complex-valued symbols; mapping of the complex-valued modulation symbols onto one or several transmission layers; transform precoding to generate complex-valued symbols; precoding of the complex-valued symbols; mapping of precoded complex-valued symbols to resource elements; generation of complex-valued time-domain Single Carrier-Frequency Division Multiple Access (SC-FDMA) or CP-OFDM signal for an antenna port; and/or the like. In an example, when transform precoding is enabled, a SC-FDMA signal for uplink transmission may be generated. In an example, when transform precoding is not enabled, an CP-OFDM signal for uplink transmission may be generated by FIG. 16A. These functions are illustrated as examples and it is anticipated that other mechanisms may be implemented in various embodiments.

FIG. 16B illustrates an example structure for modulation and up-conversion of a baseband signal to a carrier frequency. The baseband signal may be a complex-valued SC-FDMA or CP-OFDM baseband signal for an antenna port and/or a complex-valued Physical Random Access Channel (PRACH) baseband signal. Filtering may be employed prior to transmission.

FIG. 16C illustrates an example structure for downlink transmissions. A baseband signal representing a physical downlink channel may perform one or more functions. The one or more functions may comprise: scrambling of coded bits in a codeword to be transmitted on a physical channel; modulation of scrambled bits to generate complex-valued modulation symbols; mapping of the complex-valued modulation symbols onto one or several transmission layers; precoding of the complex-valued modulation symbols on a layer for transmission on the antenna ports; mapping of complex-valued modulation symbols for an antenna port to resource elements; generation of complex-valued time-domain OFDM signal for an antenna port; and/or the like. These functions are illustrated as examples and it is anticipated that other mechanisms may be implemented in various embodiments.

FIG. 16D illustrates another example structure for modulation and up-conversion of a baseband signal to a carrier frequency. The baseband signal may be a complex-valued OFDM baseband signal for an antenna port. Filtering may be employed prior to transmission.

A wireless device may receive from a base station one or more messages (e.g. RRC messages) comprising configuration parameters of a plurality of cells (e.g. primary cell, secondary cell). The wireless device may communicate with at least one base station (e.g. two or more base stations in dual-connectivity) via the plurality of cells. The one or more messages (e.g. as a part of the configuration parameters) may comprise parameters of physical, MAC, RLC, PCDP, SDAP, RRC layers for configuring the wireless device. For example, the configuration parameters may comprise parameters for configuring physical and MAC layer channels, bearers, etc. For example, the configuration parameters may comprise parameters indicating values of timers for physical, MAC, RLC, PCDP, SDAP, RRC layers, and/or communication channels.

A timer may begin running once it is started and continue running until it is stopped or until it expires. A timer may be started if it is not running or restarted if it is running. A timer may be associated with a value (e.g. the timer may be started or restarted from a value or may be started from zero and expire once it reaches the value). The duration of a timer may not be updated until the timer is stopped or expires (e.g., due to BWP switching). A timer may be used to measure a time period/window for a process. When the specification refers to an implementation and procedure related to one or more timers, it will be understood that there are multiple ways to implement the one or more timers. For example, it will be understood that one or more of the multiple ways to implement a timer may be used to measure a time period/window for the procedure. For example, a random access response window timer may be used for measuring a window of time for receiving a random access response. In an example, instead of starting and expiry of a random access response window timer, the time difference between two time stamps may be used. When a timer is restarted, a process for measurement of time window may be restarted. Other example implementations may be provided to restart a measurement of a time window.

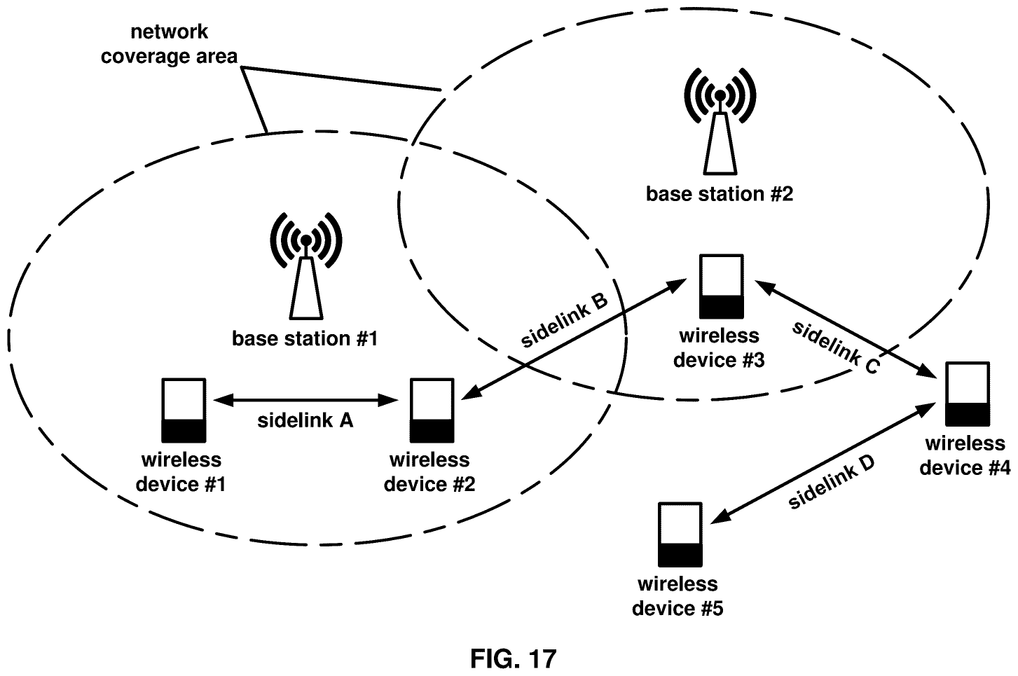

FIG. 17 illustrates examples of device-to-device (D2D) communication, in which there is a direct communication between wireless devices. In an example, D2D communication may be performed via a sidelink (SL). The wireless devices may exchange sidelink communications via a sidelink interface (e.g., a PC5 interface). Sidelink differs from uplink (in which a wireless device communicates to a base station) and downlink (in which a base station communicates to a wireless device). A wireless device and a base station may exchange uplink and/or downlink communications via a user plane interface (e.g., a Uu interface).

As shown in FIG. 17, wireless device #1 and wireless device #2 may be in a coverage area of base station #1. For example, both wireless device #1 and wireless device #2 may communicate with the base station #1 via a Uu interface. Wireless device #3 may be in a coverage area of base station #2. Base station #1 and base station #2 may share a network and may jointly provide a network coverage area. Wireless device #4 and wireless device #5 may be outside of the network coverage area.

In-coverage D2D communication may be performed when two wireless devices share a network coverage area. Wireless device #1 and wireless device #2 are both in the coverage area of base station #1. Accordingly, they may perform an in coverage intra-cell D2D communication, labeled as sidelink A. Wireless device #2 and wireless device #3 are in the coverage areas of different base stations, but share the same network coverage area. Accordingly, they may perform an in coverage inter-cell D2D communication, labeled as sidelink B. Partial-coverage D2D communications may be performed when one wireless device is within the network coverage area and the other wireless device is outside the network coverage area. Wireless device #3 and wireless device #4 may perform a partial coverage D2D communication, labeled as sidelink C. Out-of-coverage D2D communications may be performed when both wireless devices are outside of the network coverage area. Wireless device #4 and wireless device #5 may perform an out-of coverage D2D communication, labeled as sidelink D.

Sidelink communications may be configured using physical channels, for example, a physical sidelink broadcast channel (PSBCH), a physical sidelink feedback channel (PSFCH), a physical sidelink discovery channel (PSDCH), a physical sidelink control channel (PSCCH), and/or a physical sidelink shared channel (PSSCH). PSBCH may be used by a first wireless device to send broadcast information to a second wireless device. PSBCH may be similar in some respects to PBCH. The broadcast information may comprise, for example, a slot format indication, resource pool information, a sidelink system frame number, or any other suitable broadcast information. PSFCH may be used by a first wireless device to send feedback information to a second wireless device. The feedback information may comprise, for example, HARQ feedback information. PSDCH may be used by a first wireless device to send discovery information to a second wireless device. The discovery information may be used by a wireless device to signal its presence and/or the availability of services to other wireless devices in the area. PSCCH may be used by a first wireless device to send sidelink control information (SCI) to a second wireless device. PSCCH may be similar in some respects to PDCCH and/or PUCCH. The control information may comprise, for example, time/frequency resource allocation information (RB size, a number of retransmissions, etc.), demodulation related information (DMRS, MCS, RV, etc.), identifying information for a transmitting wireless device and/or a receiving wireless device, a process identifier (HARQ, etc.), or any other suitable control information. The PSCCH may be used to allocate, prioritize, and/or reserve sidelink resources for sidelink transmissions. PSSCH may be used by a first wireless device to send and/or relay data and/or network information to a second wireless device. PSSCH may be similar in some respects to PDSCH and/or PUSCH. Each of the sidelink channels may be associated with one or more demodulation reference signals. Sidelink operations may utilize sidelink synchronization signals to establish a timing of sidelink operations. Wireless devices configured for sidelink operations may send sidelink synchronization signals, for example, with the PSBCH. The sidelink synchronization signals may include primary sidelink synchronization signals (PSSS) and secondary sidelink synchronization signals (SSSS).

Sidelink resources may be configured to a wireless device in any suitable manner. A wireless device may be pre-configured for sidelink, for example, pre-configured with sidelink resource information. Additionally or alternatively, a network may broadcast system information relating to a resource pool for sidelink. Additionally or alternatively, a network may configure a particular wireless device with a dedicated sidelink configuration. The configuration may identify sidelink resources to be used for sidelink operation (e.g., configure a sidelink band combination).

The wireless device may operate in different modes, for example, an assisted mode (which may be referred to as mode 1) or an autonomous mode (which may be referred to as mode 2). Mode selection may be based on a coverage status of the wireless device, a radio resource control status of the wireless device, information and/or instructions from the network, and/or any other suitable factors. For example, if the wireless device is idle or inactive, or if the wireless device is outside of network coverage, the wireless device may select to operate in autonomous mode. For example, if the wireless device is in a connected mode (e.g., connected to a base station), the wireless device may select to operate (or be instructed by the base station to operate) in assisted mode. For example, the network (e.g., a base station) may instruct a connected wireless device to operate in a particular mode.

In an assisted mode, the wireless device may request scheduling from the network. For example, the wireless device may send a scheduling request to the network and the network may allocate sidelink resources to the wireless device. Assisted mode may be referred to as network-assisted mode, gNB-assisted mode, or base station-assisted mode. In an autonomous mode, the wireless device may select sidelink resources based on measurements within one or more resource pools (for example, pre-configure or network-assigned resource pools), sidelink resource selections made by other wireless devices, and/or sidelink resource usage of other wireless devices.

To select sidelink resources, a wireless device may observe a sensing window and a selection window. During the sensing window, the wireless device may observe SCI transmitted by other wireless devices using the sidelink resource pool. The SCIs may identify resources that may be used and/or reserved for sidelink transmissions. Based on the resources identified in the SCIs, the wireless device may select resources within the selection window (for example, resource that are different from the resources identified in the SCIs). The wireless device may transmit using the selected sidelink resources.

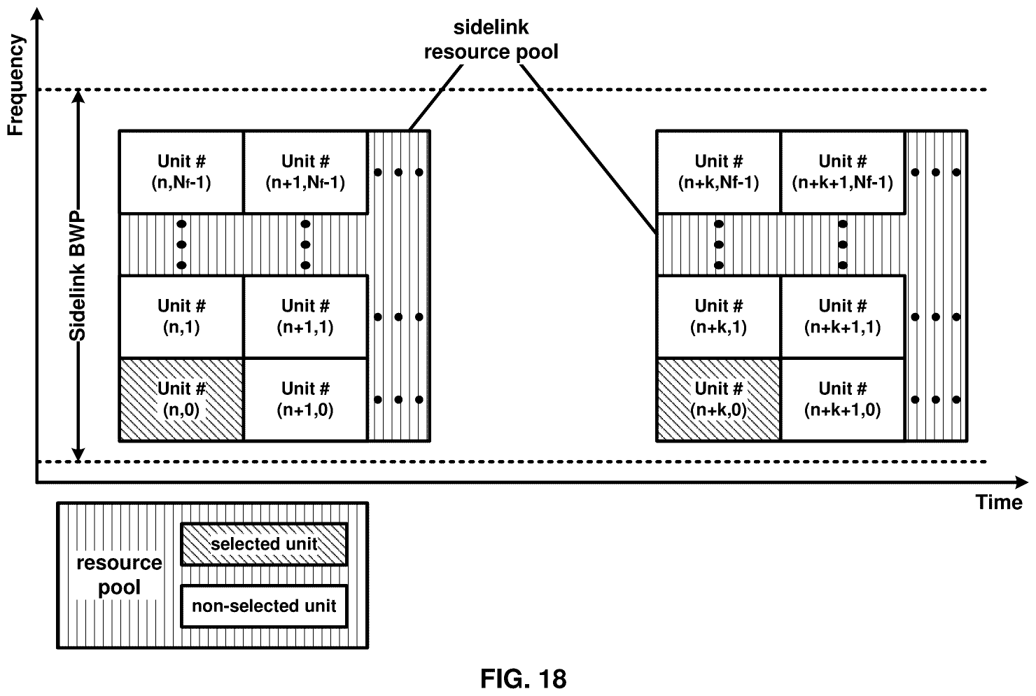

FIG. 18 illustrates an example of a resource pool for sidelink operations. A wireless device may operate using one or more sidelink cells. A sidelink cell may include one or more resource pools. Each resource pool may be configured to operate in accordance with a particular mode (for example, assisted or autonomous). The resource pool may be divided into resource units. In the frequency domain, each resource unit may comprise, for example, one or more resource blocks which may be referred to as a sub-channel. In the time domain, each resource unit may comprise, for example, one or more slots, one or more subframes, and/or one or more OFDM symbols. The resource pool may be continuous or non-continuous in the frequency domain and/or the time domain (for example, comprising contiguous resource units or non-contiguous resource units). The resource pool may be divided into repeating resource pool portions. The resource pool may be shared among one or more wireless devices. Each wireless device may attempt to transmit using different resource units, for example, to avoid collisions.

Sidelink resource pools may be arranged in any suitable manner. In the figure, the example resource pool is non-contiguous in the time domain and confined to a single sidelink BWP. In the example resource pool, frequency resources are divided into a Nf resource units per unit of time, numbered from zero to Nf 1. The example resource pool may comprise a plurality of portions (non-contiguous in this example) that repeat every k units of time. In the figure, time resources are numbered as n, n+1 . . . n+k, n+k+1 . . . , etc.

A wireless device may select for transmission one or more resource units from the resource pool. In the example resource pool, the wireless device selects resource unit (n,0) for sidelink transmission. The wireless device may further select periodic resource units in later portions of the resource pool, for example, resource unit (n+k,0), resource unit (n+2k,0), resource unit (n+3k,0), etc. The selection may be based on, for example, a determination that a transmission using resource unit (n,0) will not (or is not likely) to collide with a sidelink transmission of a wireless device that shares the sidelink resource pool. The determination may be based on, for example, behavior of other wireless devices that share the resource pool. For example, if no sidelink transmissions are detected in resource unit (n−k,0), then the wireless device may select resource unit (n,0), resource (n+k,0), etc. For example, if a sidelink transmission from another wireless device is detected in resource unit (n−k, 1), then the wireless device may avoid selection of resource unit (n,1), resource (n+k,1), etc.

Different sidelink physical channels may use different resource pools. For example, PSCCH may use a first resource pool and PSSCH may use a second resource pool. Different resource priorities may be associated with different resource pools. For example, data associated with a first QoS, service, priority, and/or other characteristic may use a first resource pool and data associated with a second QoS, service, priority, and/or other characteristic may use a second resource pool. For example, a network (e.g., a base station) may configure a priority level for each resource pool, a service to be supported for each resource pool, etc. For example, a network (e.g., a base station) may configure a first resource pool for use by unicast UEs, a second resource pool for use by groupcast UEs, etc. For example, a network (e.g., a base station) may configure a first resource pool for transmission of sidelink data, a second resource pool for transmission of discovery messages, etc.

In an example of vehicle-to-everything (V2X) communications via a Uu interface and/or a PC5 interface, the V2X communications may be vehicle-to-vehicle (V2V) communications. A wireless device in the V2V communications may be a vehicle. In an example, the V2X communications may be vehicle-to-pedestrian (V2P) communications. A wireless device in the V2P communications may be a pedestrian equipped with a mobile phone/handset. In an example, the V2X communications may be vehicle-to-infrastructure (V2I) communications. The infrastructure in the V2I communications may be a base station/access point/node/road side unit. A wireless device in the V2X communications may be a transmitting wireless device performing one or more sidelink transmissions to a receiving wireless device. The wireless device in the V2X communications may be a receiving wireless device receiving one or more sidelink transmissions from a transmitting wireless device.

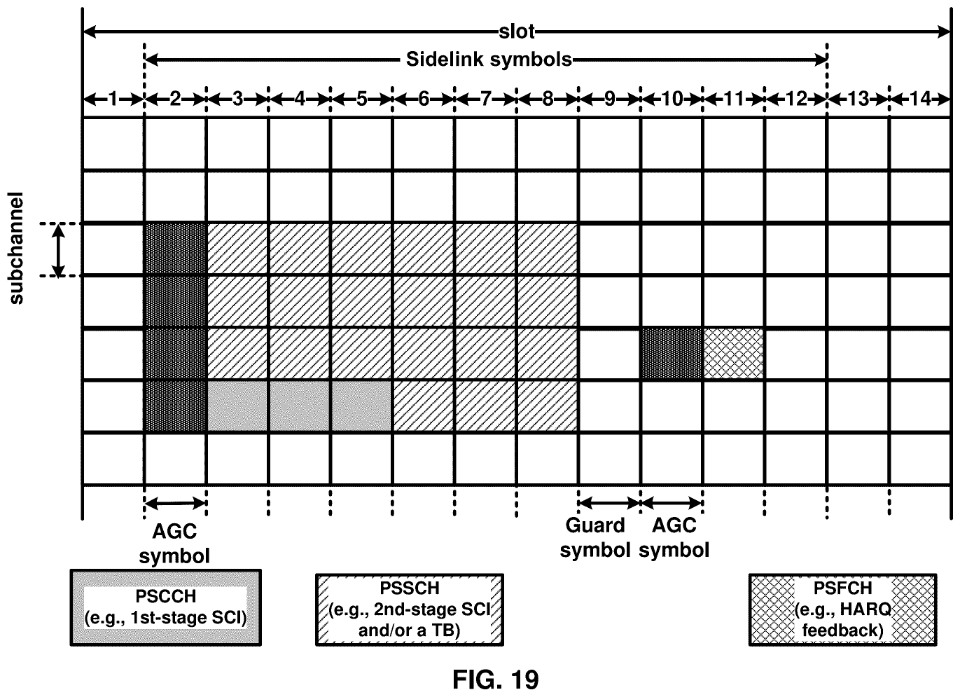

FIG. 19 illustrates an example of sidelink symbols in a slot. In an example, a sidelink transmission may be transmitted in a slot in the time domain. In an example, a wireless device may have data to transmit via sidelink. The wireless device may segment the data into one or more transport blocks (TBs). The one or more TBs may comprise different pieces of the data. A TB of the one or more TBs may be a data packet of the data. The wireless device may transmit a TB of the one or more TBs (e.g., a data packet) via one or more sidelink transmissions (e.g., via PSCCH/PSSCH in one or more slots). In an example, a sidelink transmission (e.g., in a slot) may comprise SCI. The sidelink transmission may further comprise a TB. The SCI may comprise a 1st-stage SCI and a 2nd-stage SCI. A PSCCH of the sidelink transmission may comprise the 1st-stage SCI for scheduling a PSSCH (e.g., the TB). The PSSCH of the sidelink transmission may comprise the 2nd-stage SCI. The PSSCH of the sidelink transmission may further comprise the TB. In an example, sidelink symbols in a slot may or may not start from the first symbol of the slot. The sidelink symbols in the slot may or may not end at the last symbol of the slot. In an example of FIG. 19, sidelink symbols in a slot start from the second symbol of the slot. In an example of FIG. 19, the sidelink symbols in the slot end at the twelfth symbol of the slot. A first sidelink transmission may comprise a first automatic gain control (AGC) symbol (e.g., the second symbol in the slot), a PSCCH (e.g., in the third, fourth and the fifth symbols in a sub-channel in the slot), a PSSCH (e.g., from the third symbol to the eighth symbol in the slot), and/or a first guard symbol (e.g., the ninth symbol in the slot). A second sidelink transmission may comprise a second AGC symbol (e.g., the tenth symbol in the slot), a PSFCH (e.g., the eleventh symbol in the slot), and/or a second guard symbol for the second sidelink transmission (e.g., the twelfth symbol in the slot). In an example, one or more HARQ feedbacks (e.g., positive acknowledgement or ACK and/or negative acknowledgement or NACK) may be transmitted via the PSFCH. In an example, the PSCCH, the PSSCH, and the PSFCH may have different number of sub-channels (e.g., a different number of frequency resources) in the frequency domain.

The 1st-stage SCI may be a SCI format 1-A. The SCI format 1-A may comprise a plurality of fields used for scheduling of the first TB on the PSSCH and the 2nd-stage SCI on the PSSCH. The following information may be transmitted by means of the SCI format 1-A.
A priority of the sidelink transmission. For example, the priority may be a physical layer (e.g., layer 1) priority of the sidelink transmission. For example, the priority may be determined based on logical channel priorities of the sidelink transmission;
Frequency resource assignment of the PSSCH;
Time resource assignment of the PSSCH;
Resource reservation period/interval for a second TB;
Demodulation reference signal (DMRS) pattern;
A format of the 2nd-stage SCI;
Beta_offset indicator;
Number of DMRS port;
Modulation and coding scheme of the PSSCH;
Additional MCS table indicator;
PSFCH overhead indication;
Reserved bits.

The 2nd-stage SCI may be a SCI format 2-A. The SCI format 2-A may be used for the decoding of the PSSCH, with HARQ operation when HARQ-ACK information includes ACK or NACK, or when there is no feedback of HARQ-ACK information. The SCI format 2-A may comprise a plurality of fields indicating the following information.
HARQ process number;
New data indicator;
Redundancy version;
Source ID of a transmitter (e.g., a transmitting wireless device) of the sidelink transmission;
Destination ID of a receiver (e.g., a receiving wireless device) of the sidelink transmission;
HARQ feedback enabled/disabled indicator;
Cast type indicator indicating that the sidelink transmission is a broadcast, a groupcast and/or a unicast;
CSI request.

The 2nd-stage SCI may be a SCI format 2-B. The SCI format 2-B may be used for the decoding of the PSSCH, with HARQ operation when HARQ-ACK information includes only NACK, or when there is no feedback of HARQ-ACK information. The SCI format 2-B may comprise a plurality of fields indicating the following information.
HARQ process number;
New data indicator;
Redundancy version;
Source ID of a transmitter (e.g., a transmitting wireless device) of the sidelink transmission;
Destination ID of a receiver (e.g., a receiving wireless device) of the sidelink transmission;
HARQ feedback enabled/disabled indicator;
Zone ID indicating a zone in which a transmitter (e.g., a transmitting wireless device) of the sidelink transmission is geographic located;
Communication range requirement indicating a communication range of the sidelink transmission.

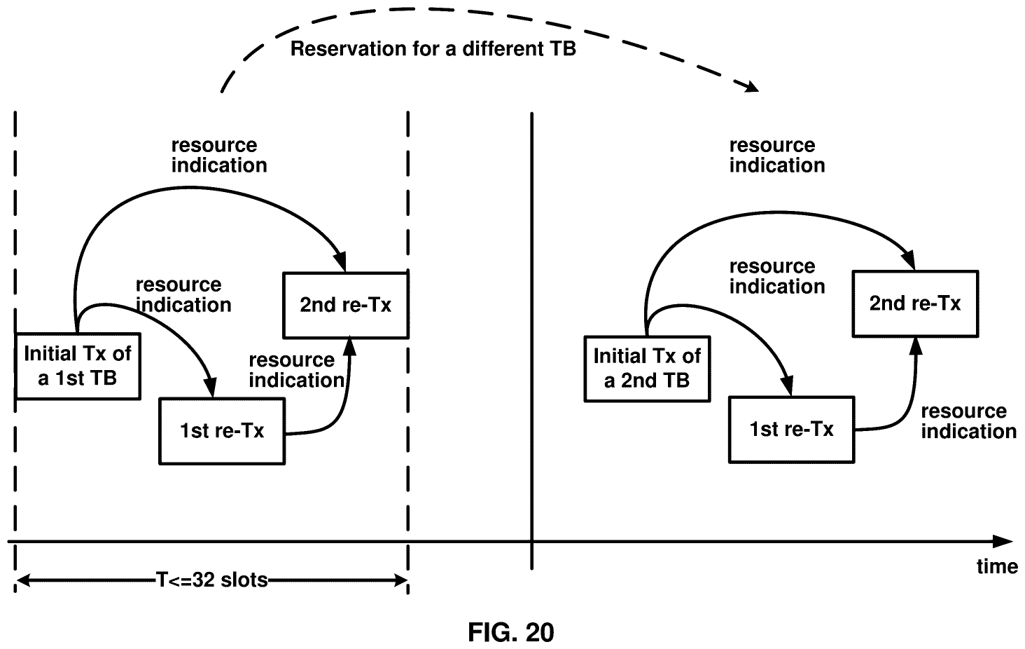

FIG. 20 illustrates an example of resource indication for a first TB (e.g, a first data packet) and resource reservation for a second TB (e.g., a second data packet). SCI of an initial transmission (e.g., a first transmission) and/or retransmission of the first TB may comprise one or more first parameters (e.g., Frequency resource assignment and Time resource assignment) indicating one or more first time and frequency (T/F) resources for transmission and/or retransmission of the first TB. The SCI may further comprise one or more second parameters (e.g., Resource reservation period) indicating a reservation period/interval of one or more second T/F resources for initial transmission and/or retransmission of the second TB.

In an example, in response to triggering a resource selection procedure, a wireless device may select one or more first T/F resources for initial transmission and/or retransmission of a first TB. As shown in FIG. 20, the wireless device may select three resources for transmitting the first TB. The wireless device may transmit an initial transmission (initial Tx of a first TB in FIG. 20) of the first TB via a first resource of the three resources. The wireless device may transmit a first retransmission (1st re-Tx in FIG. 20) of the first TB via a second resource of the three resources. The wireless device may transmit a second retransmission (2nd re-Tx in FIG. 20) of the first TB via a third resource of the three resources. A time duration between a starting time of the initial transmission of the first TB and the second retransmission of the first TB may be smaller than or equal to 32 sidelink slots (e.g., T≤32 slots in FIG. 20). A first SCI may associate with the initial transmission of the first TB. The first SCI may indicate a first T/F resource indication for the initial transmission of the first TB, the first retransmission of the first TB and the second retransmission of the first TB. The first SCI may further indicate a reservation period/interval of resource reservation for a second TB. A second SCI may associate with the first retransmission of the first TB. The second SCI may indicate a second T/F resource indication for the first retransmission of the first TB and the second retransmission of the first TB. The second SCI may further indicate the reservation period/interval of resource reservation for the second TB. A third SCI may associate with the second retransmission of the first TB. The third SCI may indicate a third T/F resource indication for the second retransmission of the first TB. The third SCI may further indicate the reservation period/interval of resource reservation for the second TB.

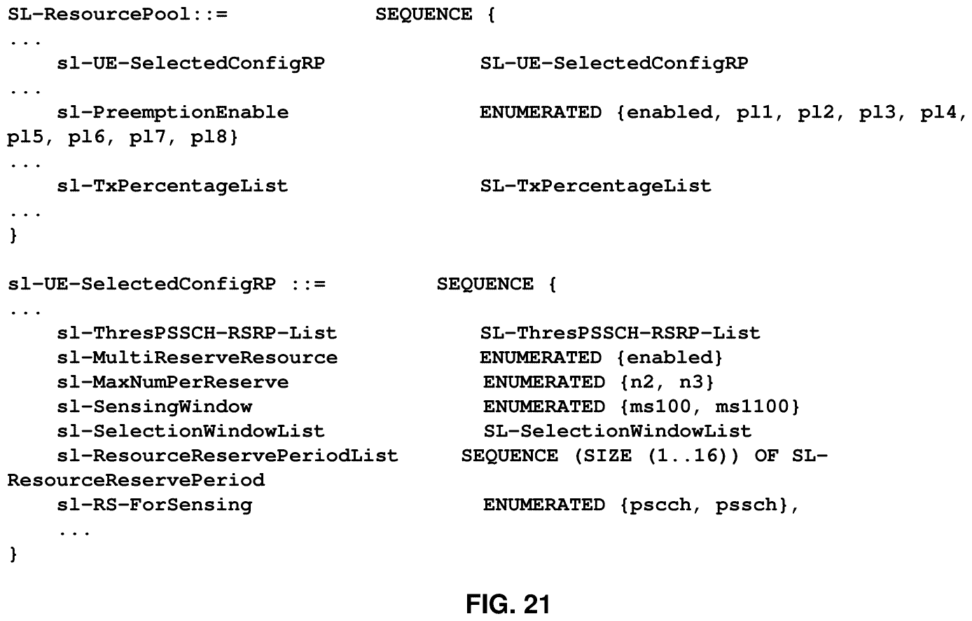

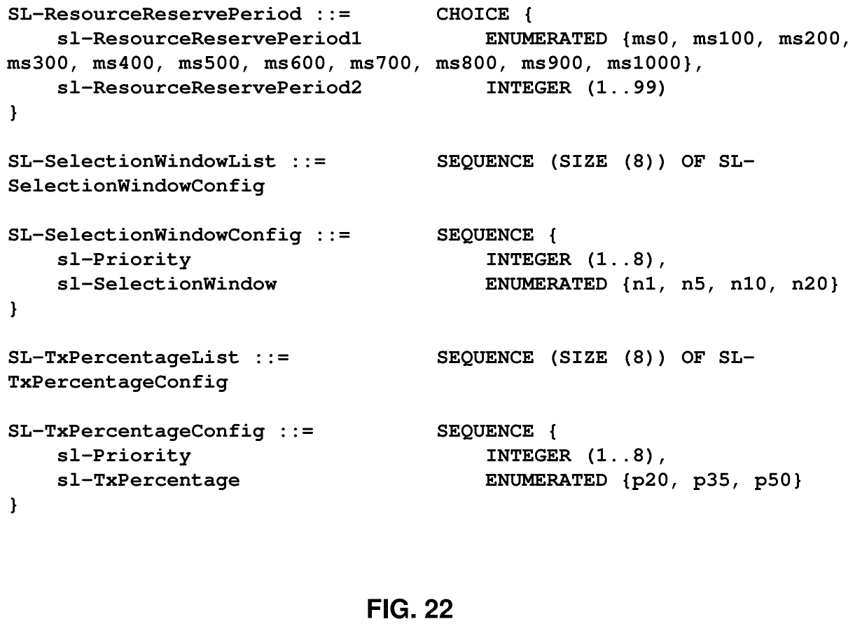

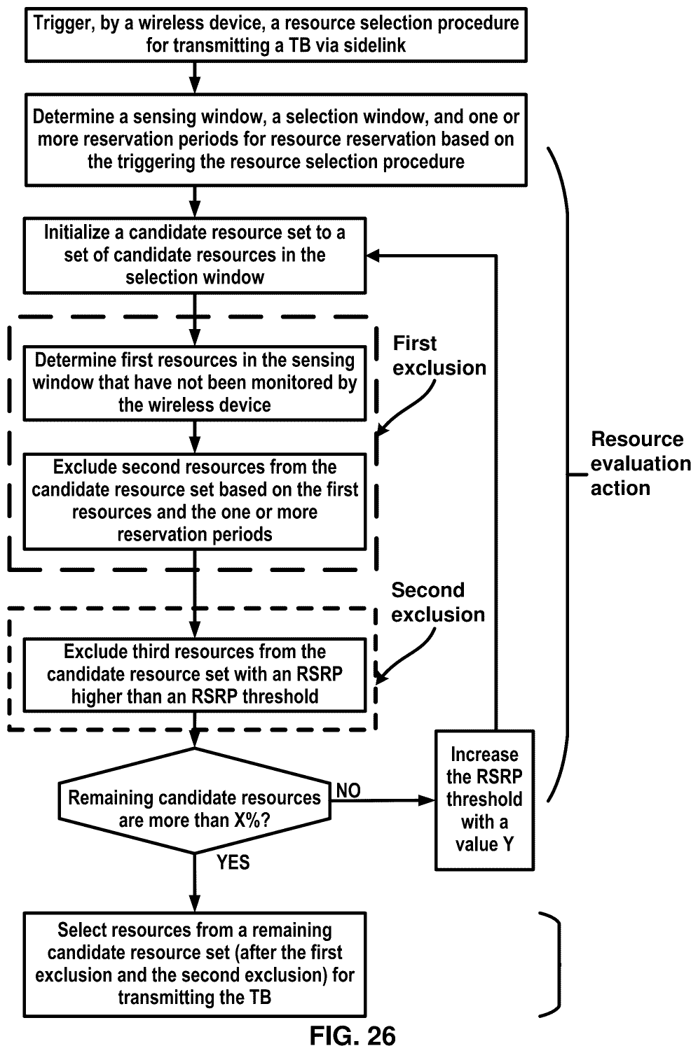

FIG. 21 and FIG. 22 illustrate examples of configuration information for sidelink communication. In an example, a base station may transmit one or more radio resource control (RRC) messages to a wireless device for delivering the configuration information for the sidelink communication. The configuration information may comprise a field of sl-UE-SelectedConfigRP. A parameter sl-ThresPSSCH-RSRP-List in the field may indicate a list of 64 thresholds. In an example, a wireless device may receive first sidelink control information (SCI) indicating a first priority. The wireless device may have second SCI to be transmitted. The second SCI may indicate a second priority. The wireless device may select a threshold from the list based on the first priority in the first SCI and the second priority in the second SCI. Referring to second exclusion in FIG. 26, the wireless device may exclude resources from candidate resource set based on the threshold. A parameter sl-MaxNumPerReserve in the field may indicate a maximum number of reserved PSCCH/PSSCH resources indicated in an SCI. A parameter sl-MultiReserveResource in the field may indicate if it is allowed to reserve a sidelink resource for an initial transmission of a TB by an SCI associated with a different TB, based on sensing and resource selection procedure. A parameter sl-ResourceReservePeriodList may indicate a set of possible resource reservation periods/intervals (e.g., SL-ResourceReservedPeriod) allowed in a resource pool. Up to 16 values may be configured per resource pool. A parameter sl-RS-ForSensing may indicate whether DMRS of PSCCH or PSSCH is used for layer 1 (e.g., physical layer) RSRP measurement in sensing operation. A parameter sl-SensingWindow may indicate a start of a sensing window. A parameter sl-SelectionWindowList may indicate an end of a selection window in resource selection procedure for a TB with respect to priority indicated in SCI. Value n1 may correspond to 1*2μ, value n5 corresponds to 5*2μ, and so on, where μ=0, 1, 2, 3 for subcarrier spacing (SCS) of 15, 30, 60, and 120 KHz respectively. A parameter SL-SelectionWindowConfig may indicate a mapping between a sidelink priority (e.g., sl-Priority) and the end of the selection window (e.g., sl-SelectionWindow).

The configuration information may comprise a parameter sl-PreemptionEnable indicating whether sidelink pre-emption is disabled or enabled in a resource pool. For example, a priority level p_preemption may be configured if the sidelink pre-emption is enabled. For example, if the sidelink pre-emption is enabled but the p_preemption is not configured, the sidelink pre-emption may be applicable to all priority levels.

The configuration information may comprise a parameter sl-TxPercentageList indicating a portion of candidate single-slot PSSCH resources over total resources. For example, value p20 may correspond to 20%, and so on. A parameter SL-TxPercentageConfig may indicate a mapping between a sidelink priority (e.g., sl-Priority) and the portion of candidate single-slot PSSCH resources over total resources (e.g., sl-TxPercentage).

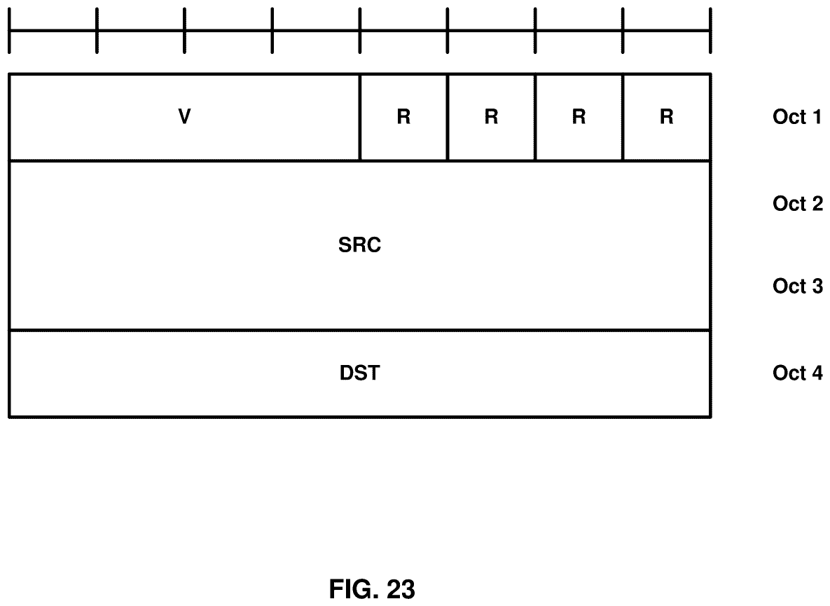

FIG. 23 illustrates an example format of a MAC subheader for sidelink shared channel (SL-SCH). The MAC subheader for SL-SCH may comprise seven header fields V/R/R/R/R/SCR/DST. The MAC subheader is octet aligned. For example, the V field may be a MAC protocol date units (PDU) format version number field indicating which version of the SL-SCH subheader is used. For example, the SRC field may carry 16 bits of a Source Layer-2 identifier (ID) field set to a first identifier provided by upper layers. For example, the DST field may carry 8 bits of the Destination Layer-2 ID set to a second identifier provided by upper layers. In an example, if the V field is set to “1”, the second identifier may be a unicast identifier. In an example, if the V field is set to “2”, the second identifier may be a groupcast identifier. In an example, if the V field is set to “3”, the second identifier may be a broadcast identifier. For example, the R field may indicate reserved bit.

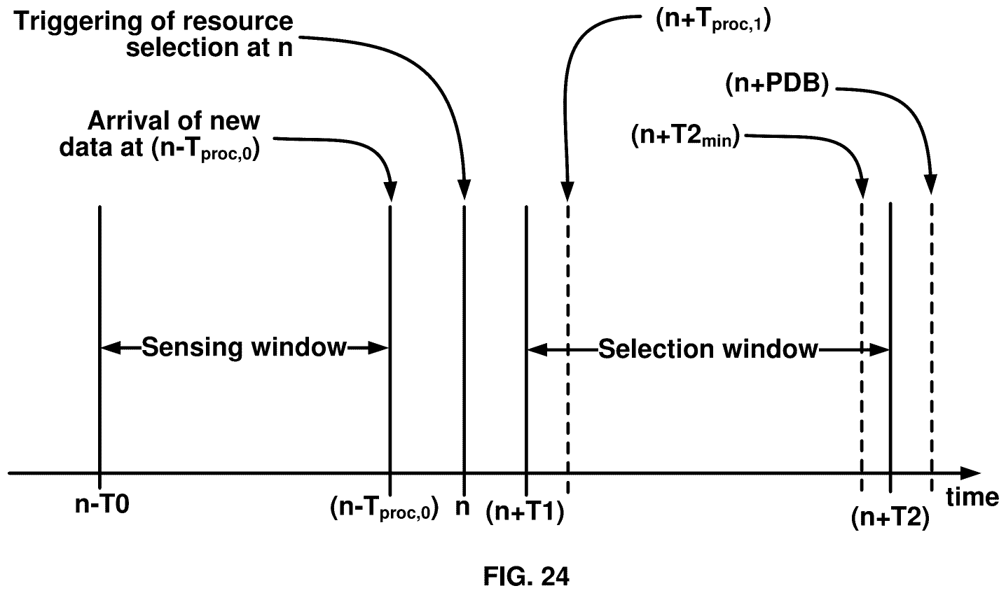

FIG. 24 illustrates an example time of a resource selection procedure. A wireless device may perform the resource selection procedure to select resources for one or more sidelink transmissions. As shown in FIG. 24, a sensing window of the resource selection procedure may start at time (n−T0) (e.g., parameter sl-SensingWindow). The sensing window may end at time (n−T_(proc,0)). New data of the one or more sidelink transmissions may arrive at the wireless device at time (n−T_(proc,0)). The time period T_(proc,0) may be a processing delay of the wireless device to determine to trigger the resource selection procedure. The wireless device may determine to trigger the resource selection procedure at time n to select the resources for the new data arrived at time (n−T_(proc,0). The wireless device may complete the resource selection procedure at time (n+T1). The wireless device may determine the parameter T1 based on a capability of the wireless device. The capability of the wireless device may be a processing delay of a processor of the wireless device. A selection window of the resource selection procedure may start at time (n+T1). The selection window may end at time (n+T2) indicating the ending of the selection window. The wireless device may determine the parameter T2 based on a parameter T2 min (e.g., sl-SelectionWindow). In an example, the wireless device may determine the parameter T2 subject to T2min≤T2≤PDB, where the PDB (packet delay budget) may be the maximum allowable delay (e.g., a delay budget) for successfully transmitting the new data via the one or more sidelink transmissions. The wireless device may determine the parameter T2 min to a corresponding value for a priority of the one or more sidelink transmissions (e.g., based on a parameter SL-SelectionWindowConfig indicating a mapping between a sidelink priority sl-Priority and the end of the selection window sl-SelectionWindow). In an example, the wireless device may set the parameter T2=PDB if the parameter T2 min>PDB.

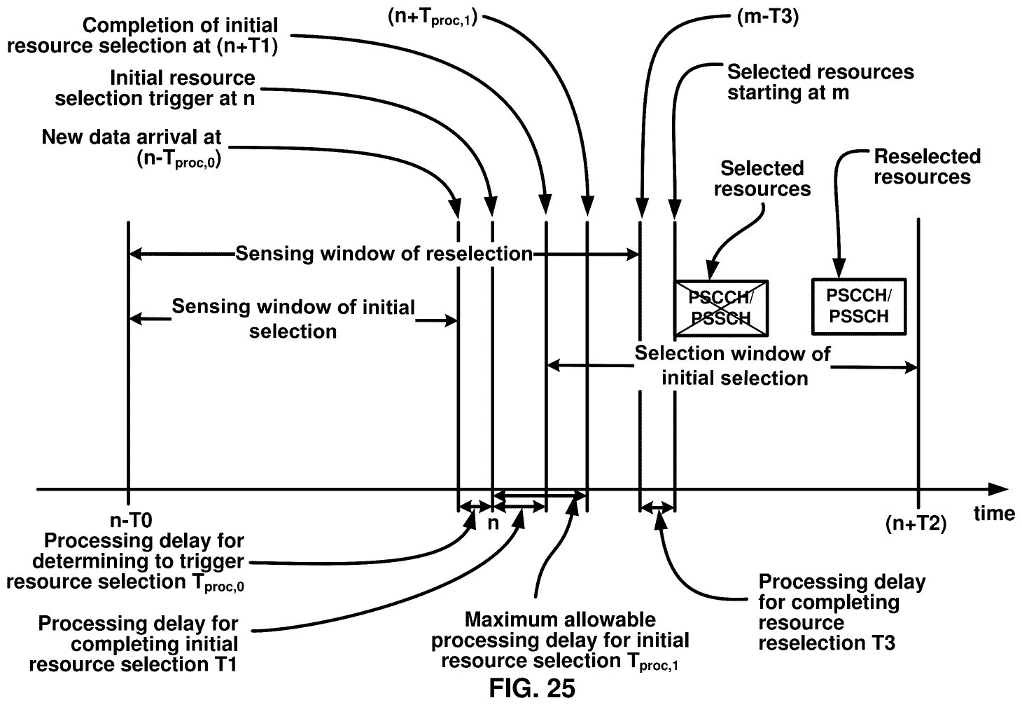

FIG. 25 illustrates an example timing of a resource selection procedure. A wireless device may perform the resource selection procedure for selecting resources for one or more sidelink transmissions. Referring to FIG. 24, a sensing window of initial selection may start at time (n−T0). The sensing window of initial selection may end at time (n−T_(proc,0)). New data of the one or more sidelink transmissions may arrive at the wireless device at the time (n−T_(proc,0)). The time period T_(proc,0) may be a processing delay for the wireless device to determine to trigger the initial selection of the resources. The wireless device may determine to trigger the initial selection at time n for selecting the resources for the new data arrived at the time (n−T_(proc,0)). The wireless device may complete the resource selection procedure at time (n+T1). The time (n+T_(proc,1) may be the maximum allowable processing latency for completing the resource selection procedure being triggered at the time n, where 0<T1≤T_(proc, 1). A selection window of initial selection may start at time (n+T1). The selection window of initial selection may end at time (n+T2). The parameter T2 may be configured, preconfigured, or determined at the wireless device.

The wireless device may determine first resources (e.g., selected resources in FIG. 25) for the one or more sidelink transmissions based on the completion of the resource selection procedure at the time (n+T1). The wireless device may select the first resources from candidate resources in the selection window of initial selection based on measurements in the sensing window for initial selection. The wireless device may determine a resource collision between the first resources and other resources reserved by another wireless device. The wireless device may determine to drop the first resources for avoiding interference. The wireless device may trigger a resource reselection procedure (e.g., a second resource selection procedure) at time (m−T3) and/or before time (m−T3). The time period T3 may be a processing delay for the wireless device to complete the resource reselection procedure (e.g., a second resource selection procedure). The wireless device may determine second resources (e.g., reselected resource in FIG. 25) via the resource reselection procedure (e.g., a second resource selection procedure). The start time of the first resources may be time m (e.g., the first resources may be in slot m).

In an example, at least one of time parameters T0, T_(proc,0), T_(proc,1), T2, and PDB may be configured by a base station to the wireless device. In an example, the at least one of the time parameters T0, T_(proc,0), T_(proc,1), T2, and PDB may be preconfigured to the wireless device. The at least one of the time parameters T0, T_(proc,0), T_(proc,1), T2, and PDB may be stored in a memory of the wireless device. In an example, the memory may be a Subscriber Identity Module (SIM) card. In an example of FIG. 24 and FIG. 25, the time n, m, T0, T1, T_(proc,0), T_(proc,1), T2, T2 min, T3, and PDB may be in terms of slots and/or slot index.

FIG. 26 illustrates an example flowchart of a resource selection procedure by a wireless device for transmitting a TB (e.g., a data packet) via sidelink.

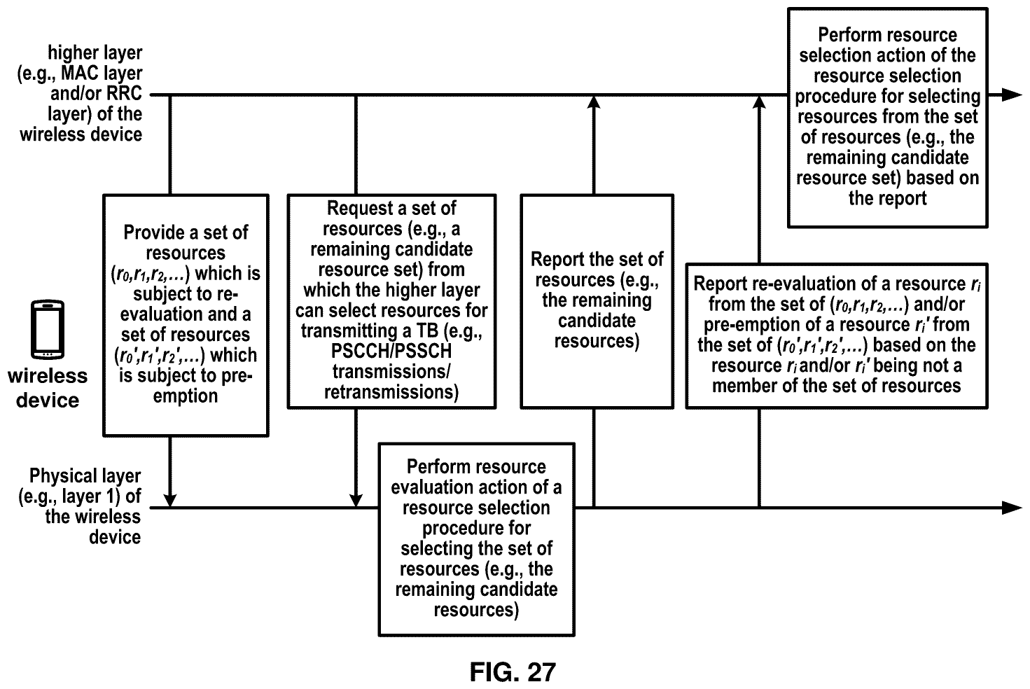

FIG. 27 illustrates an example diagram of the resource selection procedure among layers of the wireless device.

Referring to FIG. 26 and FIG. 27, the wireless device may transmit one or more sidelink transmissions (e.g., a first transmission of the TB and one or more retransmissions of the TB) for the transmitting of the TB. Referring to FIG. 19, a sidelink transmission of the one or more sidelink transmission may comprise a PSCCH. The sidelink transmission may comprise a PSSCH. The sidelink transmission may comprise a PSFCH. The wireless device may trigger the resource selection procedure for the transmitting of the TB. The resource selection procedure may comprise two actions. The first action of the two actions may be a resource evaluation action. Physical layer (e.g., layer 1) of the wireless device may perform the first action. The physical layer may determine a subset of resources based on the first action and report the subset of resources to higher layer (e.g., RRC layer and/or MAC layer) of the wireless device. The second action of the two actions may be a resource selection action. The higher layer (e.g., RRC layer and/or MAC layer) of the wireless device may perform the second action based on the reported the subset of resources from the physical layer.

In an example, higher layer (e.g., RRC layer and/or MAC layer) of a wireless device may trigger a resource selection procedure for requesting the wireless device to determine a subset of resources. The higher layer may select resources from the subset of resources for PSSCH and/or PSCCH transmission. To trigger the resource selection procedure, e.g., in slot n, the higher layer may provide the following parameters for the PSSCH and/or PSCCH transmission:
a resource pool, from which the wireless device may determine the subset of resources;
layer 1 priority, prio_TX (e.g., sl-Priority referring to FIG. 21 and FIG. 22), of the PSSCH/PSCCH transmission;
remaining packet delay budget (PDB) of the PSSCH and/or PSCCH transmission;
a number of sub-channels, L_“subCH”, for the PSSCH and/or PSCCH transmission in a slot;
a resource reservation period/interval, P_“rsvp_TX”, in units of millisecond (ms).

In an example, if the higher layer requests the wireless device to determine a subset of resources from which the higher layer will select the resources for the PSSCH and/or PSCCH transmission for re-evaluation and/or pre-emption, the higher layer may provide a set of resources (r_0,r_1,r_2, . . . ) which may be subject to the re-evaluation and a set of resources (r_0\hat{ }′,r_1\hat{ }′,r_2\hat{ }′, . . . ) which may be subject to the pre-emption.

In an example, a base station (e.g., network) may transmit a message comprising one or more parameters to the wireless device for performing the resource selection procedure. The message may be an RRC/SIB message, a MAC CE, and/or a DCI. In an example, a second wireless device may transmit a message comprising one or more parameters to the wireless device for performing the resource selection procedure. The message may be an RRC message, a MAC CE, and/or a SCI. The one or more parameters may indicate following information.
sl-SelectionWindowList (e.g., sl-SelectionWindow referring to FIG. 21 and FIG. 22): an internal parameter T2 min (e.g., T2 min referring to FIG. 24) may be set to a corresponding value from the parameter sl-SelectionWindowList for a given value of prio_TX (e.g., based on SL-SelectionWindowConfig referring to FIG. 21 and FIG. 22).
sl-ThresPSSCH-RSRP-List (e.g., sl-ThresPSSCH-RSRP-List referring to FIG. 21 and FIG. 22): a parameter may indicate an RSRP threshold for each combination (p_i, p_j), where p_i is a value of a priority field in a received SCI format 1-A and p_j is a priority of a sidelink transmission (e.g., the PSSCH/PSCCH transmission) of the wireless device; In an example of the resource selection procedure, an invocation of p_j may be p_j=prio_TX.
sl-RS-ForSensing (e.g., sl-RS-ForSensing referring to FIG. 21 and FIG. 22): a parameter may indicate whether DMRS of a PSCCH or a PSSCH is used, by the wireless device, for layer 1 (e.g., physical layer) RSRP measurement in sensing operation.
sl-ResourceReservePeriodList (e.g., sl-ResourceReservePeriodList referring to FIG. 21 and FIG. 22)
sl-SensingWindow (e.g., sl-SensingWindow referring to FIG. 21 and FIG. 22): an internal parameter T_0 may be defined as a number of slots corresponding to t0_SensingWindow ms.
sl-TxPercentageList (e.g., based on SL-TxPercentageConfig referring to FIG. 21 and FIG. 22): an internal parameter X (e.g., sl-TxPercentage referring to FIG. 21 and FIG. 22) for a given prio_TX (e.g., sl-Priority referring to FIG. 21 and FIG. 22) may be defined as sl-xPercentage (prio_TX) converted from percentage to ratio.
sl-PreemptionEnable (e.g., p_preemption referring to FIG. 21 and FIG. 22): an internal parameter prio_pre may be set to a higher layer provided parameter sl-PreemptionEnable.

The resource reservation period/interval, P_“rsvp_TX”, if provided, may be converted from units of ms to units of logical slots, resulting in P_“rsvp\_TX”\hat{ }′.

Notation: (t_0\hat{ }SL,t_1\hat{ }SL,t_2\hat{ }SL, . . . ) may denote a set of slots of a sidelink resource pool.

In the resource evaluation action (e.g., the first action in FIG. 26), the wireless device may determine a sensing window (e.g., the sensing window shown in FIG. 24 and FIG. 25 based on sl-SensingWindow) based on the triggering the resource selection procedure. The wireless device may determine a selection window (e.g., the selection window shown in FIG. 24 and FIG. 25 based on sl-SelectionWindowList) based on the triggering the resource selection procedure. The wireless device may determine one or more reservation periods/intervals (e.g., parameter sl-ResourceReservePeriodList) for resource reservation. In an example, a candidate single-slot resource for transmission R_“x,y” may be defined as a set of L_“subCH” contiguous sub-channels with sub-channel x+j in slot t_y\hat{ }SL where j=0, . . . , L_“subCH”−1. The wireless device may assume that a set of L_“subCH” contiguous sub-channels in the resource pool within a time interval [n+T_1,n+T_2] correspond to one candidate single-slot resource (e.g., referring to FIG. 24 and FIG. 25). A total number of candidate single-slot resources may be denoted by M_“total”. In an example, referring to FIG. 24 and FIG. 25, the sensing window may be defined by a number of slots in a time duration of [n−T_0,n−T_(proc,0)\hat{ }). The wireless device may monitor a first subset of the slots, of a sidelink resource pool, within the sensing window. The wireless device may not monitor a second subset of the slots than the first subset of the slots due to half duplex. The wireless device may perform the following actions based on PSCCH decoded and RSRP measured in the first subset of the slots. In an example, an internal parameter Th(p_i,p_j) may be set to the corresponding value of RSRP threshold indicated by the i-th field in sl-ThresPSSCH-RSRP-List, where i=p_i+(p_j−1)*8.

Referring to FIG. 26 and FIG. 27, in the resource evaluation action (e.g., the first action in FIG. 26), the wireless device may initialize a candidate resource set (e.g., a set S_A) to be a set of candidate resources. In an example, the candidate resource set may be the union of candidate resources within the selection window. In an example, a candidate resource may be a candidate single-subframe resource. In an example, a candidate resource may be a candidate single-slot resource. In an example, the set S_A may be initialized to a set of all candidate single-slot resources.

Referring to FIG. 26 and FIG. 27, in the resource evaluation action (e.g., the first action in FIG. 26), the wireless device may perform a first exclusion for excluding second resources from the candidate resource set based on first resources and one or more reservation periods/intervals. In an example, the wireless device may not monitor the first resources within a sensing window. In an example, the one or more reservation periods/intervals may be configured/associated with a resource pool of the second resources. In an example, the wireless device may determine the second resources within a selection window which might be reserved by a transmission transmitted via the first resources based on the one or more reservation periods/intervals. In an example, the wireless device may exclude a candidate single-slot resource R_“x,y” from the set S_A based on following conditions:
the wireless device has not monitored slot t_m\hat{ }SL in the sensing window.
for any periodicity value allowed by the parameter sl-ResourceReservePeriodList and a hypothetical SCI format 1-A received in the slot t_m\hat{ }SL with “Resource reservation period” field set to that periodicity value and indicating all sub-channels of the resource pool in this slot, condition c of a second exclusion would be met.

Referring to FIG. 26 and FIG. 27, in the resource evaluation action (e.g., the first action in FIG. 26), the wireless device may perform a second exclusion for excluding third resources from the candidate resource set. In an example, a SCI may indicate a resource reservation of the third resources. The SCI may further indicate a priority value (e.g., indicated by a higher layer parameter sl-Priority). The wireless device may exclude the third resources from the candidate resource set based on a reference signal received power (RSRP) of the third resources being higher than an RSRP threshold (e.g., indicated by a higher layer parameter sl-ThresPSSCH-RSRP-List). The RSRP threshold may be related to the priority value based on a mapping list of RSRP thresholds to priority values configured and/or pre-configured to the wireless device. In an example, a base station may transmit a message to the wireless device for configuring the mapping list. The message may be a radio resource control (RRC) message. In an example, the mapping list may be pre-configured to the wireless device. A memory of the wireless device may store the mapping list. In an example, a priority indicated by the priority value may be a layer 1 priority (e.g., physical layer priority). In an example, a bigger priority value may indicate a higher priority of a sidelink transmission. A smaller priority value may indicate a lower priority of the sidelink transmission. In another example, a bigger priority value may indicate a lower priority of a sidelink transmission. A smaller priority value may indicate a higher priority of the sidelink transmission. In an example, the wireless device may exclude a candidate single-slot resource R_“x,y” from the set S_A based on following conditions:
a) the wireless device receives an SCI format 1-A in slot t_m\hat{ }SL, and “Resource reservation period” field, if present, and “Priority” field in the received SCI format 1-A indicate the values P_“rsvp_RX” and prio_RX;
b) the RSRP measurement performed, for the received SCI format 1-A, is higher than Th(prio_RX,prio_TX);
c) the SCI format received in slot t_m\hat{ }SL or the same SCI format which, if and only if the “Resource reservation period” field is present in the received SCI format 1-A, is assumed to be received in slot(s) t_(m+q×P_(rsvp\_RX)\hat{ }′)\hat{ }SL determines the set of resource blocks and slots which overlaps with R_(x,y+j×P_(rsvp_TX)\hat{ }′) for q=1, 2, . . . , Q and j=0, 1, . . . , C_resel-1. Here, P_(rsvp\_RX)\hat{ }′ is P_“rsvp_RX” converted to units of logical slots, Q=┌T_scal/P_(rsvp\_RX)┐ if P_(rsvp_RX)<T_scal and n\hat{ }′-m≤P_(rsvp\_RX)\hat{ }′, where t_(n\hat{ }′)\hat{ }SL=n if slot n belongs to the set (t_0\hat{ }SL,t_1\hat{ }SL, . . . , t_(T_max)\hat{ }SL), otherwise slot t_(n\hat{ }′)\hat{ }SL is the first slot after slot n belonging to the set (t_0\hat{ }SL,t_1\hat{ }SL, . . . , t_(T_max)\hat{ }SL); otherwise Q=1. T_scal is set to selection window size T2 converted to units of ms.

Referring to FIG. 26 and FIG. 27, in the resource evaluation action (e.g., the first action in FIG. 26), the wireless device may determine whether remaining candidate resources in the candidate resource set are sufficient for selecting resources for the one or more sidelink transmissions of the TB based on a condition, after performing the first exclusion and the second exclusion. In an example, the condition may be the total amount of the remaining candidate resources in the candidate resource set being more than X percent (e.g., indicated by a higher layer parameter sl-TxPercentageList) of the candidate resources in the candidate resource set before performing the first exclusion and the second exclusion. If the condition is not met, the wireless device may increase the RSRP threshold used to exclude the third resources with a value Y and iteratively re-perform the initialization, first exclusion, and second exclusion until the condition being met. In an example, if the number of remaining candidate single-slot resources in the set S_A is smaller than X·M_“total”, then Th(p_i,p_j) may be increased by 3 dB and the procedure continues with re-performing of the initialization, first exclusion, and second exclusion until the condition being met. In an example, the wireless device may report the set S_A (e.g., the remaining candidate resources of the candidate resource set) to the higher layer of the wireless device. In an example, the wireless device may report the set S_A (e.g., the remaining candidate resources of the candidate resource set when the condition is met) to the higher layer of the wireless device, based on that the number of remaining candidate single-slot resources in the set S_A being greater than or equal to X·M_“total”.

Referring to FIG. 26 and FIG. 27, in the resource selection action (e.g., the second action in FIG. 26), the wireless device (e.g., the higher layer of the wireless device) may select fourth resources from the remaining candidate resources of the candidate resource set (e.g., the set S_A reported by the physical layer) for the one or more sidelink transmissions of the TB. In an example, the wireless device may randomly select the fourth resources from the remaining candidate resources of the candidate resource set.

Referring to FIG. 26 and FIG. 27, in an example, if a resource r_i from the set (r_0,r_1,r_2, . . . ) is not a member of S_A (e.g., the remaining candidate resources of the candidate resource set when the condition is met), the wireless device may report re-evaluation of the resource r_i to the higher layers.

Referring to FIG. 26 and FIG. 27, in an example, if a resource r_i\hat{ }′ from the set (r_0\hat{ }′,r_1\hat{ }′,r_2\hat{ }′, . . . ) meets the conditions below, then the wireless device may report pre-emption of the resource r_i\hat{ }′ to the higher layers.
r_i\hat{ }′ is not a member of S_A, and
r_i\hat{ }′ meets the conditions for the second exclusion, with Th(prio_RX,prio_TX) set to a final threshold for reaching X·M_total, and
the associated priority prio_RX, satisfies one of the following conditions:
sl-PreemptionEnable is provided and is equal to ‘enabled’ and prio_TX>prio_RX
sl-PreemptionEnable is provided and is not equal to ‘enabled’, and prio_RX<prio_pre and prio_TX>prio_RX

In an example, if the resource r_i is indicated for re-evaluation by the wireless device (e.g., the physical layer of the wireless device), the higher layer of the wireless device may remove the resource r_i from the set (r_0,r_1,r_2, . . . ). In an example, if the resource r_i′ is indicated for pre-emption by the wireless device (e.g., the physical layer of the wireless device), the higher layer of the wireless device may remove the resource r_i′ from the set (r_0\hat{ }′,r_1\hat{ }′,r_2\hat{ }′, . . . ). The higher layer of the wireless device may randomly select new time and frequency resources from the remaining candidate resources of the candidate resource set (e.g., the set S_A reported by the physical layer) for the removed resources r_i and/or r_i′. The higher layer of the wireless device may replace the removed resources r_i and/or r_i′ by the new time and frequency resources. For example, the wireless device may remove the resources r_i and/or r_i′ from the set (r_0,r_1,r_2, . . . ) and/or the set (r_0\hat{ }′,r_1\hat{ }′,r_2\hat{ }′, . . . ) and add the new time and frequency resources to the set (r_0,r_1,r_2, . . . ) and/or the set (r_0\hat{ }′,r_1\hat{ }′,r_2\hat{ }′, . . . ) based on the removing of the resources r_i and/or r_i′.

Sidelink pre-emption may happen between a first wireless device and a second wireless device. The first wireless device may select first resources for a first sidelink transmission. The first sidelink transmission may have a first priority. The second wireless device may select second resources for a second sidelink transmission. The second sidelink transmission may have a second priority. The first resources may partially and/or fully overlap with the second resources. The first wireless device may determine a resource collision between the first resources and the second resources based on that the first resources and the second resources being partially and/or fully overlapped. The resource collision may imply fully and/or partially overlapping between the first resources and the second resources in time, frequency, code, power, and/or spatial domain. Referring to an example of FIG. 18, the first resources may comprise one or more first sidelink resource units in a sidelink resource pool. The second resources may comprise one or more second sidelink resource units in the sidelink resource pool. A partial resource collision between the first resources and the second resources may indicate that the at least one sidelink resource unit of the one or more first sidelink resource units belongs to the one or more second sidelink resource units. A full resource collision between the first resources and the second resources may indicate that the one or more first sidelink resource units may be the same as or a subset of the one or more second sidelink resource units. In an example, a bigger priority value may indicate a lower priority of a sidelink transmission. A smaller priority value may indicate a higher priority of the sidelink transmission. In an example, the first wireless device may determine the sidelink pre-emption based on the resource collision and the second priority being higher than the first priority. That is, the first wireless device may determine the sidelink pre-emption based on the resource collision and a value of the second priority being smaller than a value of the first priority. In another example, the first wireless device may determine the sidelink pre-emption based on the resource collision, the value of the second priority being smaller than a priority threshold, and the value of the second priority being smaller than the value of the first priority.

Referring to FIG. 25, a first wireless device may trigger a first resource selection procedure for selecting first resources (e.g., selected resources after resource selection with collision in FIG. 25) for a first sidelink transmission. A second wireless device may transmit an SCI indicating resource reservation of the first resource for a second sidelink transmission. The first wireless device may determine a resource collision on the first resources between the first sidelink transmission and the second sidelink transmission. The first wireless device may trigger a resource re-evaluation (e.g., a resource evaluation action of a second resource selection procedure) at and/or before time (m−T3) based on the resource collision. The first wireless device may trigger a resource reselection (e.g., a resource selection action of the second resource selection procedure) for selecting second resources (e.g., reselected resources after resource reselection in FIG. 25) based on the resource re-evaluation. The start time of the second resources may be time m.

A UE may receive one or more messages (e.g., RRC messages and/or SIB messages) comprising configuration parameters of a sidelink BWP. The configuration parameters may comprise a first parameter (e.g., sl-StartSymbol) indicating a sidelink starting symbol. The first parameter may indicate a starting symbol (e.g., symbol #0, symbol #1, symbol #2, symbol #3, symbol #4, symbol #5, symbol #6, symbol #7, etc.) used for sidelink in a slot. For example, the slot may not comprise a SL-SSB (S-SSB). In an example, the UE may be (pre-) configured with one or more values of the sidelink starting symbol per sidelink BWP. The configuration parameters may comprise a second parameter (e.g., sl-LengthSymbols) indicating number of symbols (e.g., 7 symbols, 8 symbols, 9 symbols, 10 symbols, 11 symbols, 12 symbols, 13 symbols, 14 symbols, etc.) used sidelink in a slot. For example, the slot may not comprise a SL-SSB (S-SSB). In an example, the UE may be (pre-) configured with one or more values of the sidelink number of symbols (symbol length) per sidelink BWP.

The configuration parameters of the sidelink BWP may indicate one or more sidelink (communication) resource pools of the sidelink BWP (e.g., via SL-BWP-PoolConfig and/or SL-BWP-PoolConfigCommon). A resource pool may be a sidelink receiving resource pool (e.g., indicated by sl-RxPool) on the configured sidelink BWP. For example, the receiving resource pool may be used for PSFCH transmission/reception, if configured. A resource pool may be a sidelink transmission resource pool (e.g., indicated by sl-TxPool, and/or sl-ResourcePool) on the configured sidelink BWP. For example, the transmission resource pool may comprise resources by which the UE is allowed to transmit NR sidelink communication (e.g., in exceptional conditions and/or based on network scheduling) on the configured BWP. For example, the transmission resource pool may be used for PSFCH transmission/reception, if configured.

Configuration parameters of a resource pool may indicate a size of a sub-channel of the resource pool (e.g., via sl-SubchannelSize) in unit of PRB. For example, the sub-channel size may indicate a minimum granularity in frequency domain for sensing and/or for PSSCH resource selection. Configuration parameters of a resource pool may indicate a lowest/starting RB index of a sub-channel with a lowest index in the resource pool with respect to lowest RB index RB index of the sidelink BWP (e.g., via sl-StartRB-Subchannel). Configuration parameters of a resource pool may indicate a number of sub-channels in the corresponding resource pool (e.g., via sl-NumSubchannel). For example, the sub-channels and/or the resource pool may consist of contiguous PRBs.

Configuration parameters of a resource pool may indicate configuration of one or more sidelink channels on/in the resource pool. For example, the configuration parameters may indicate that the resource pool is configured with PSSCH and/or PSCCH and/or PSFCH.

Configuration parameters of PSCCH may indicate a time resource for a PSCCH transmission in a slot. Configuration parameters of PSCCH (e.g., SL-PSCCH-Config) may indicate a number of symbols of PSCCH (e.g., 2 or 3) in the resource pool (e.g., via sl-TimeResourcePSCCH). Configuration parameters of PSCCH (e.g., SL-PSCCH-Config) may indicate a frequency resource for a PSCCH transmission in a corresponding resource pool (e.g., via sl-FreqResourcePSCCH). For example, the configuration parameters may indicate a number of PRBs for PSCCH in a resource pool, which may not be greater than a number of PRBs of a sub-channel of the resource pool (sub-channel size).

Configuration parameters of PSSCH may indicate one or more DMRS time domain patterns (e.g., PSSCH DMRS symbols in a slot) for the PSSCH that may be used in the resource pool.

A resource pool may or may not be configured with PSFCH. Configuration parameters of PSFCH may indicate a period for the PSFCH in unit/number of slots within the resource pool (e.g., via sl-PSFCH-Period). For example, a value 0 of the period may indicate that no resource for PSFCH is configured in the resource pool and/or HARQ feedback for (all) transmissions in the resource pool is disabled. For example, the period may be 1 slot or 2 slots or 4 slots, etc. Configuration parameters of PSFCH may indicate a set of PRBs that are (actually) used for PSFCH transmission and reception (e.g., via sl-PSFCH-RB-Set). For example, a bitmap may indicate the set of PRBs, wherein a leftmost bit of the bitmap may refer to a lowest RB index in the resource pool, and so on. Configuration parameters of PSFCH may indicate a minimum time gap between PSFCH and the associated PSSCH in unit of slots (e.g., via sl-MinTimeGapPSFCH). Configuration parameters of PSFCH may indicate a number of PSFCH resources available for multiplexing HARQ-ACK information in a PSFCH transmission (e.g., via sl-PSFCH-CandidateResourceType).

A UE may be configured by higher layers (e.g., by RRC configuration parameters) with one or more sidelink resource pools. A sidelink resource pool may be for transmission of PSSCH and/or for reception of PSSCH. A sidelink resource pool may be associated with sidelink resource allocation mode 1 and/or sidelink resource allocation mode 2. In the frequency domain, a sidelink resource pool consists of one or more (e.g., sl-NumSubchannel) contiguous sub-channels. A sub-channel consists of one or more (e.g., sl-SubchannelSize) contiguous PRBs. For example, higher layer parameters (e.g., RRC configuration parameters) may indicate a number of sub-channels in a sidelink resource pool (e.g., sl-NumSubchannel) and/or a number of PRBs per sub-channel (e.g., sl-SubchannelSize).

A set of slots that may belong to a sidelink resource pool. The set of slots may be denoted by (t_0\hat{ }SL,t_1\hat{ }SL, . . . , t_(T_max−1)\hat{ }SL) where [symbol] 0≤t [symbol] _\hat{ }SL<10240×2μ,0≤i<T_max. The slot index may be relative to slot #0 of the radio frame corresponding to SFN 0 of the serving cell or DFN 0. The set includes all the slots except N_(S_SSB) slots in which S-SS/PSBCH block (S-SSB) is configured. The set includes all the slots except N_nonSL slots in each of which at least one of Y-th, (Y+1)-th, . . . , (Y+X−1)-th OFDM symbols are not semi-statically configured as UL as per the higher layer parameter (e.g., tdd-UL-DL-ConfigurationCommon-r16 of the serving cell if provided and/or sl-TDD-Configuration-r16 if provided and/or sl-TDD-Config-r16 of the received PSBCH if provided). For example, a higher layer (e.g., MAC or RRC) parameter may indicate a value of Y as the sidelink starting symbol of a slot (e.g., sl-StartSymbol). For example, a higher layer (e.g., MAC or RRC) parameter may indicate a value of X as the number of sidelink symbols in a slot (e.g., sl-LengthSymbols). The set includes all the slots except one or more reserved slots. The slots in the set may be arranged in increasing order of slot index. The UE may determine the set of slot assigned to a sidelink resource pool based on a bitmap (b_0,b_1, . . . , b_(L_bitmap-1)) associated with the resource pool where L_bitmap the length of the bitmap is configured by higher layers. A slot t_k\hat{ }SL (0≤k<10240×2\hat{ }μ−N_(S_SSB)−N_nonSL−N_reserved) may belong to the set of slots if b_(k\hat{ })=1 where k\hat{ }′=k mod L_bitmap. The slots in the set are re-indexed such that the subscripts i of the remaining slots [symbol] t [symbol] _i\hat{ }SL are successive {0, 1, . . . , [symbol] T′ [symbol] _max−1} where [symbol] T′ [symbol] _max is the number of the slots remaining in the set.

The UE may determine the set of resource blocks assigned to a sidelink resource pool, wherein the resource pool consists of N_PRB PRBs. The sub-channel m for m=0, 1, . . . , numSubchannel−1 consists of a set of n_subCHsize contiguous resource blocks with the physical resource block number n_PRB=n_subCHRBstart+m·n_subCHsize+j for j=0, 1, . . . , n_subCHsize−1, where n_subCHRBstart and n_subCHsize are given by higher layer parameters sl-StartRB-Subchannel and sl-SubchannelSize, respectively. A UE may not be expected to use the last N_PRB “mod” n_subCHsize PRBs in the resource pool.

A UE may be provided/configured with a number of symbols in a resource pool for PSCCH (e.g., by sl-TimeResourcePSCCH). The PSCCH symbols may start from a second symbol that is available for sidelink transmissions in a slot. The UE may be provided/configured with a number of PRBs in the resource pool for PSCCH (e.g., by sl-FreqResourcePSCCH). The PSCCH PRBs may start from the lowest PRB of the lowest sub-channel of the associated PSSCH, e.g., for a PSCCH transmission with a SCI format 1-A. In an example, PSCCH resource/symbols may be configured in every slot of the resource pool. In an example, PSCCH resource/symbols may be configured in a subset of slot of the resource pool (e.g., based on a period comprising two or more slots).

In an example, each PSSCH transmission is associated with an PSCCH transmission. The PSCCH transmission may carry the 1st stage of the SCI associated with the PSSCH transmission. The 2nd stage of the associated SCI may be carried within the resource of the PSSCH. In an example, the UE transmits a first SCI (e.g., 1st stage SCI, SCI format 1-A) on PSCCH according to a PSCCH resource configuration in slot n and PSCCH resource m. For the associated PSSCH transmission in the same slot, the UE may transmit one transport block (TB) with up to two layers (e.g., one layer or two layers). The number of layers (D) may be determined according to the ‘Number of DMRS port’ field in the SCI. The UE may determine the set of consecutive symbols within the slot for transmission of the PSSCH. The UE may determine the set of contiguous resource blocks for transmission of the PSSCH. Transform precoding may not be supported for PSSCH transmission. For example, wideband precoding may be supported for PSSCH transmission.

The UE may set the contents of the second SCI (e.g., 2nd stage SCI, SCI format 2-A). The UE may set values of the SCI fields comprising the ‘HARQ process number’ field, the ‘NDI’ field, the ‘Source ID’ field, the ‘Destination ID’ field, the ‘HARQ feedback enabled/disabled indicator’ field, the ‘Cast type indicator’ field, and/or the ‘CSI request’ field, as indicated by higher (e.g., MAC and/or RRC) layers. The UE may set the contents of the second SCI (e.g., 2nd stage SCI, SCI format 2-B). The UE may set values of the SCI fields comprising the ‘HARQ process number’ field, the ‘NDI’ field, the ‘Source ID’ field, the ‘Destination ID’ field, the ‘HARQ feedback enabled/disabled indicator’ field, the ‘Zone ID’ field, and/or the ‘Communication range requirement’ field, as indicated by higher (e.g., MAC and/or RRC) layers.

In an example, one transmission scheme may be defined for the PSSCH and may be used for all PSSCH transmissions. PSSCH transmission may be performed with up to two antenna ports, e.g., with antenna ports 1000-1001.

In sidelink resource allocation mode 1, for PSSCH and/or PSCCH transmission, dynamic grant, configured grant type 1 and/or configured grant type 2 may be supported. The configured grant Type 2 sidelink transmission is semi-persistently scheduled by a SL grant in a valid activation DCI.

The UE may transmit the PSSCH in the same slot as the associated PSCCH. The (minimum) resource allocation unit in the time domain may be a slot. The UE may transmit the PSSCH in consecutive symbols within the slot. The UE may not transmit PSSCH in symbols which are not configured for sidelink. A symbol may be configured for sidelink, according to higher layer parameters indicating the starting sidelink symbol (e.g., startSLsymbols) and a number of consecutive sidelink symbols (e.g., lengthSLsymbols). For example, startSLsymbols is the symbol index of the first symbol of lengthSLsymbols consecutive symbols configured for sidelink. Within the slot, PSSCH resource allocation may start at symbol startSLsymbols+1 (e.g., second sidelink symbol of the slot). The UE may not transmit PSSCH in symbols which are configured for use by PSFCH, if PSFCH is configured in this slot. The UE may not transmit PSSCH in the last symbol configured for sidelink (e.g., last sidelink symbol of the slot). The UE may not transmit PSSCH in the symbol immediately preceding the symbols which are configured for use by PSFCH, if PSFCH is configured in this slot. FIG. 19 shows an example of sidelink symbols and the PSSCH resource allocation within the slot.

A Sidelink grant may be received dynamically on the PDCCH, and/or configured semi-persistently by RRC, and/or autonomously selected by the MAC entity of the UE. The MAC entity may have a sidelink grant on an active SL BWP to determine a set of PSCCH duration(s) in which transmission of SCI occurs and a set of PSSCH duration(s) in which transmission of SL-SCH associated with the SCI occurs. A sidelink grant addressed to SLCS-RNTI with NDI=1 is considered as a dynamic sidelink grant. The UE may be configured with Sidelink resource allocation mode 1. The UE may for each PDCCH occasion and for each grant received for this PDCCH occasion (e.g., for the SL-RNTI or SLCS-RNTI of the UE), use the sidelink grant to determine PSCCH duration(s) and/or PSSCH duration(s) for initial transmission and/or one or more retransmission of a MAC PDU for a corresponding sidelink process (e.g., associated with a HARQ buffer and/or a HARQ process ID).

The UE may be configured with Sidelink resource allocation mode 2 to transmit using pool(s) of resources in a carrier, based on sensing or random selection. The MAC entity for each Sidelink process may select to create a selected sidelink grant corresponding to transmissions of multiple MAC PDUs, and SL data may be available in a logical channel. The UE may select a resource pool, e.g., based on a parameter enabling/disabling sidelink HARQ feedback. The UE may perform the TX resource (re-)selection check on the selected pool of resources. The UE may select the time and frequency resources for one transmission opportunity from the resources pool and/or from the resources indicated by the physical layer, according to the amount of selected frequency resources and the remaining PDB of SL data available in the logical channel(s) allowed on the carrier. The UE may use the selected resource to select a set of periodic resources spaced by the resource reservation interval for transmissions of PSCCH and PSSCH corresponding to the number of transmission opportunities of MAC PDUs. The UE may consider the first set of transmission opportunities as the initial transmission opportunities and the other set(s) of transmission opportunities as the retransmission opportunities. The UE may consider the sets of initial transmission opportunities and retransmission opportunities as the selected sidelink grant. The UE may consider the set as the selected sidelink grant. The UE may use the selected sidelink grant to determine the set of PSCCH durations and the set of PSSCH durations.

The UE may for each PSSCH duration and/or for each sidelink grant occurring in this PSSCH duration, select a MCS table allowed in the pool of resource which is associated with the sidelink grant. The UE may determine/set the resource reservation interval to a selected value (e.g., 0 or more). In an example, if the configured sidelink grant has been activated and this PSSCH duration corresponds to the first PSSCH transmission opportunity within this period of the configured sidelink grant, the UE may set the HARQ Process ID to the HARQ Process ID associated with this PSSCH duration and, if available, all subsequent PSSCH duration(s) occurring in this period for the configured sidelink grant. The UE may flush the HARQ buffer of Sidelink process associated with the HARQ Process ID. The UE may deliver the sidelink grant, the selected MCS, and the associated HARQ information to the Sidelink HARQ Entity for this PSSCH duration.

The MAC entity may include at most one Sidelink HARQ entity for transmission on SL-SCH, which maintains a number of parallel Sidelink processes. The (maximum) number of transmitting Sidelink processes associated with the Sidelink HARQ Entity may be a value (e.g., 16). A sidelink process may be configured for transmissions of multiple MAC PDUs. For transmissions of multiple MAC PDUs with Sidelink resource allocation mode 2, the (maximum) number of transmitting Sidelink processes associated with the Sidelink HARQ Entity may be a second value (e.g., 4). A delivered sidelink grant and its associated Sidelink transmission information may be associated with a Sidelink process. Each Sidelink process may support one TB.

For each sidelink grant and for the associated Sidelink process, the Sidelink HARQ Entity may obtain the MAC PDU to transmit from the Multiplexing and assembly entity, if any. The UE may determine Sidelink transmission information of the TB for the source and destination pair of the MAC PDU. The UE may set the Source Layer-1 ID to the 8 LSB of the Source Layer-2 ID of the MAC PDU, and set the Destination Layer-1 ID to the 16 LSB of the Destination Layer-2 ID of the MAC PDU. The UE may set the following information of the TB: cast type indicator, HARQ feedback enabler/disabler, priority, NDI, RV. The UE may deliver the MAC PDU, the sidelink grant and the Sidelink transmission information of the TB to the associated Sidelink process. The MAC entity of the UE may instruct the associated Sidelink process to trigger a new transmission or a retransmission.

In sidelink resource allocation mode 1, for sidelink dynamic grant, the PSSCH transmission may be scheduled by a DCI (e.g., DCI format 3_0). In sidelink resource allocation mode 1, for sidelink configured grant type 2, the configured grant may be activated by a DCI (e.g., DCI format 3_0). In sidelink resource allocation mode 1, for sidelink dynamic grant and sidelink configured grant type 2 the “Time gap” field value m of the DCI may provide an index m+1 into a slot offset table (e.g., the table may be configured by higher layer parameter sl-DCI-ToSL-Trans). The table value at index m+1 may be referred to as slot offset K_SL. The slot of the first sidelink transmission scheduled by the DCI may be the first SL slot of the corresponding resource pool that starts not earlier than T_“DL”-T_“TA”/2+K_SL×T_“slot”, where T_“DL” is the starting time of the downlink slot carrying the corresponding DCI, T_“TA” is the timing advance value corresponding to the TAG of the serving cell on which the DCI is received and K_SL is the slot offset between the slot of the DCI and the first sidelink transmission scheduled by DCI and T_slot is the SL slot duration. The “Configuration index” field of the DCI, if provided and not reserved, may indicate the index of the sidelink configured type 2. In sidelink resource allocation mode 1, for sidelink configured grant type 1, the slot of the first sidelink transmissions may follow the higher layer configuration.

The resource allocation unit in the frequency domain may be the sub-channel. The sub-channel assignment for sidelink transmission may be determined using the “Frequency resource assignment” field in the associated SCI. The lowest sub-channel for sidelink transmission may be the sub-channel on which the lowest PRB of the associated PSCCH is transmitted. For example, if a PSSCH scheduled by a PSCCH would overlap with resources containing the PSCCH, the resources corresponding to a union of the PSCCH that scheduled the PSSCH and associated PSCCH DM-RS may not be available for the PSSCH.

The redundancy version for transmitting a TB may be given by the “Redundancy version” field in the 2nd stage SCI (e.g., SCI format 2-A or 2-B). The modulation and coding scheme IMCS may be given by the ‘Modulation and coding scheme’ field in the 1st stage SCI (e.g., SCI format 1-A). The UE may determine the MCS table based on the following: a pre-defined table may be used if no additional MCS table is configured by higher layer parameter sl-MCS-Table; otherwise an MCS table is determined based on the ‘MCS table indicator’ field in the 1st stage SCI (e.g., SCI format 1-A). The UE may use IMCS and the MCS table determined according to the previous step to determine the modulation order (Qm) and Target code rate (R) used in the physical sidelink shared channel.

The UE may determine the TB size (TBS) based on the number of REs (NRE) within the slot. The UE may determine the number of REs allocated for PSSCH within a PRB (N_RE\hat{ }′) by N_RE\hat{ }′=N_sc\hat{ }RB (N_symb\hat{ }sh−N_symb\hat{ }PSFCH)−N_oh\hat{ }PRB−N_RE\hat{ }DMRS, where N_sc\hat{ }RB=12 is the number of subcarriers in a physical resource block; N_symb\hat{ }sh=sl-LengthSymbols−2, where sl-LengthSymbols is the number of sidelink symbols within the slot provided by higher layers; N_symb\hat{ }PSFCH=3 if ‘PSFCH overhead indication’ field of SCI format 1-A indicates “1”, and N_symb\hat{ }PSFCH=0 otherwise, if higher layer parameter sl-PSFCH-Period is 2 or 4. If higher layer parameter sl-PSFCH-Period is 0, N_symb\hat{ }PSFCH=0. If higher layer parameter sl-PSFCH-Period is 1, N_symb\hat{ }PSFCH=3. N_oh\hat{ }PRB is the overhead given by higher layer parameter sl-X-Overhead. N_RE\hat{ }DMRS is given by higher layer parameter sl-PSSCH-DMRS-TimePattern. The UE may determine the total number of REs allocated for PSSCH ( ) by N_RE=N_RE\hat{ }′·n_PRB-N_RE\hat{ }(SCI, 1)−N_RE\hat{ }(SCI,2), where nPRB is the total number of allocated PRBs for the PSSCH; N_RE\hat{ }(SCI,1) is the total number of REs occupied by the PSCCH and PSCCH DM-RS; N_RE\hat{ }(SCI,2) is the number of coded modulation symbols generated for 2nd-stage SCI transmission (prior to duplication for the 2nd layer, if present). The UE may determine the TBS based on the total number of REs allocated for PSSCH ( ) and/or the modulation order (Qm) and Target code rate (R) used in the physical sidelink shared channel.

For the single codeword q=0 of a PSSCH, the block of bits b\hat{ }(q)) (0), . . . , b\hat{ }(q)) (M_“bit”\hat{ }((q))−1), where M_“bit” \hat{ }(q))=M_“bit, \hat{ }”\hat{ }(q)+M_“bit, data”\hat{ }(q) is the number of bits in codeword q transmitted on the physical channel, may be scrambled prior to modulation (e.g., using a scrambling sequence based on a CRC of the PSCCH associated with the PSSCH). For the single codeword q=0, the block of scrambled bits may be modulated, resulting in a block of complex-valued modulation symbols d\hat{ }(q)) (0) . . . , d\hat{ }((q)) (M_“symb”\hat{ }(q))−1) where M_“symb”\hat{ }(q))=M_“symb,1”\hat{ }(q)+M_“symb,2”\hat{ }(q). Layer mapping may be done with the number of layers u∈{1,2}, resulting in x(i)=[▪(x\hat{ }(0) (i) & . . . &x\hat{ }(u−1)) (i))]\hat{ }“T”, i=0, 1, . . . , M_“symb”\hat{ }“layer”−1. The block of vectors [▪(x\hat{ }(0)) (i) & . . . &x\hat{ }(u−1)) (i))]\hat{ }“T” may be pre-coded where the precoding matrix W equals the identity matrix and M_“symb”\hat{ }“ap”=M_“symb” \hat{ }“layer”. For each of the antenna ports used for transmission of the PSSCH, the block of complex-valued symbols z\hat{ }((p)) (0), . . . , z\hat{ }((p)) (M_“symb”\hat{ }“ap”−1) may be multiplied with the amplitude scaling factor β_“DMRS”\hat{ }“PSSCH” in order to conform to the transmit power and mapped to resource elements [symbol] (k′,l) [symbol] _(p,μ) in the virtual resource blocks assigned for transmission, where k\hat{ }′=0 is the first subcarrier in the lowest-numbered virtual resource block assigned for transmission. The mapping operation may be done in two steps: first, the complex-valued symbols corresponding to the bit for the 2nd-stage SCI in increasing order of first the index k′ over the assigned virtual resource blocks and then the index l, starting from the first PSSCH symbol carrying an associated DM-RS, wherein the corresponding resource elements in the corresponding physical resource blocks are not used for transmission of the associated DM-RS, PT-RS, or PSCCH; secondly, the complex-valued modulation symbols not corresponding to the 2nd-stage SCI shall be in increasing order of first the index k′ over the assigned virtual resource blocks, and then the index l with the starting position, wherein the resource elements are not used for 2nd-stage SCI in the first step; and/or the corresponding resource elements in the corresponding physical resource blocks are not used for transmission of the associated DM-RS, PT-RS, CSI-RS, or PSCCH.

The resource elements used for the PSSCH in the first OFDM symbol in the mapping operation above, including DM-RS, PT-RS, and/or CSI-RS occurring in the first OFDM symbol, may be duplicated in the OFDM symbol immediately preceding the first OFDM symbol in the mapping (e.g., for AGC training purposes).

Virtual resource blocks may be mapped to physical resource blocks according to non-interleaved mapping. For non-interleaved VRB-to-PRB mapping, virtual resource block n is mapped to physical resource block n.

For a PSCCH, the block of bits b(0), . . . , b(M_“bit”−1), where M_“bit” is the number of bits transmitted on the physical channel, may be scrambled prior to modulation, resulting in a block of scrambled bits b\tilde{ } (0), . . . , b\tilde{ } (M_“bit”−1) according to b\tilde{ } (i)=(b(i)+c(i) “mod” 2. The block of scrambled bits b\tilde{ }(0), . . . , b\tilde{ } (M_“bit”−1) may be modulated using QPSK, resulting in a block of complex-valued modulation symbols d(0), . . . , d(M_“symb”−1) where M_“symb”=M_“bit”/2. The set of complex-valued modulation symbols d(0), . . . , d(M_“symb”−1) may be multiplied with the amplitude scaling factor β_“DMRS” \hat{ }“PSCCH” in order to conform to the transmit power and mapped in sequence starting with d(0) to resource elements (k,l)_(p,μ) assigned for transmission, and not used for the demodulation reference signals associated with PSCCH, in increasing order of first the index k over the assigned physical resources, and then the index l on antenna port p (e.g., p=2000).

The resource elements used for the PSCCH in the first OFDM symbol in the mapping operation above, including DM-RS, PT-RS, and/or CSI-RS occurring in the first OFDM symbol, may be duplicated in the immediately preceding OFDM symbol (e.g., for AGC training purposes).

For sidelink resource allocation mode 1, a UE upon detection of a first SCI (e.g., SCI format 1-A) on PSCCH may decode PSSCH according to the detected second SCI (e.g., SCI formats 2-A and/or 2-B), and associated PSSCH resource configuration configured by higher layers. The UE may not be required to decode more than one PSCCH at each PSCCH resource candidate. For sidelink resource allocation mode 2, a UE upon detection of a first SCI (e.g., SCI format 1-A) on PSCCH may decode PSSCH according to the detected second SCI (e.g., SCI formats 2-A and/or 2-B), and associated PSSCH resource configuration configured by higher layers. The UE may not be required to decode more than one PSCCH at each PSCCH resource candidate. A UE may be required to decode neither the corresponding second SCI (e.g., SCI formats 2-A and/or 2-B) nor the PSSCH associated with a first SCI (e.g., SCI format 1-A) if the first SCI indicates an MCS table that the UE does not support.

Throughout this disclosure, a (sub) set of symbols of a slot, associated with a resource pool of a sidelink BWP, that is (pre-) configured for sidelink communication (e.g., transmission and/or reception) may be referred to as ‘sidelink symbols’ of the slot. The sidelink symbols may be contiguous/consecutive symbols of a slot. The sidelink symbols may start from a sidelink starting symbol (e.g., indicated by an RRC parameter), e.g., sidelink starting symbol may be symbol #0 or symbol #1, and so on. The sidelink symbols may comprise one or more symbols of the slot, wherein a parameter (e.g., indicated by RRC) may indicate the number of sidelink symbols of the slot. The sidelink symbols may comprise one or more guard symbols, e.g., to provide a time gap for the UE to switch from a transmission mode to a reception mode. For example, the OFDM symbol immediately following the last symbol used for PSSCH, PSFCH, and/or S-SSB may serve as a guard symbol. As shown in FIG. 19, the sidelink symbols may comprise one or more PSCCH resources/occasions and/or one or more PSCCH resources and/or zero or more PSFCH resources/occasions. The sidelink symbols may comprise one or more AGC symbols.

An AGC symbol may comprise duplication of (content of) the resource elements of the immediately succeeding/following symbol (e.g., a TB and/or SCI may be mapped to the immediately succeeding symbol). In an example, the AGC symbol may be a dummy OFDM symbol. In an example, the AGC symbol may comprise a reference signal. For example, the first OFDM symbol of a PSSCH and its associated PSCCH may be duplicated (e.g., in the AGC symbol that is immediately before the first OFDM symbol of the PSSCH). For example, the first OFDM symbol of a PSFCH may be duplicated (e.g., for AGC training purposes).

In a sidelink slot structure configuration, the first symbol is used for automatic gain control (AGC) and the last symbol is used for a gap. During an AGC symbol, a receiving and/or sensing UE may perform AGC training. For AGC training, a UE detects the energy/power of a signal in the channel during the AGC symbol and applies a hardware gain to maximize the signal amplitude to the dynamic range of the analog to digital convertor (ADC) at the receiver. The receiver may determine a gain for a received signal, and an AGC duration allows time for the receiver to determine the gain and apply the gain (e.g., hardware gain component) such that when the receiver receives the data (e.g., in the next symbol(s), the gain of the amplifier has already been adjusted.

For sidelink communication, the transmitter UE may not map data/control information to the AGC symbol. The AGC symbol may not be used for communication and sending information other than energy. The AGC symbol may be a last symbol prior to an earliest symbol of a transmission, such that a gap between AGC symbol and signal/channel transmission is minimized and an accurate gain is determined for receiving the following signal/channel. For example, the AGC symbol, as shown in FIG. 19, maybe a symbol immediately preceding the first/earliest symbol of a resource used for a transmission via a channel (e.g., PSCCH and/or PSSCH and/or PSFCH transmission).

In an example, the AGC symbol may comprise duplication of resource elements of the next (immediately following) OFDM symbol. In an example, the AGC symbol may comprise any signal, e.g., a per-defined signal/sequence and/or dummy information. The purpose of the AGC symbol is to allow the receiver UE to perform AGC training and adjust the hardware gain for a most efficient reception of the following signal.

Throughout this disclosure, the “AGC symbol” may be referred to as “duplicated symbol” and/or “duplication” and/or “the symbol used for duplication” and/or “the immediately preceding symbol comprising the duplication of a first symbol”.

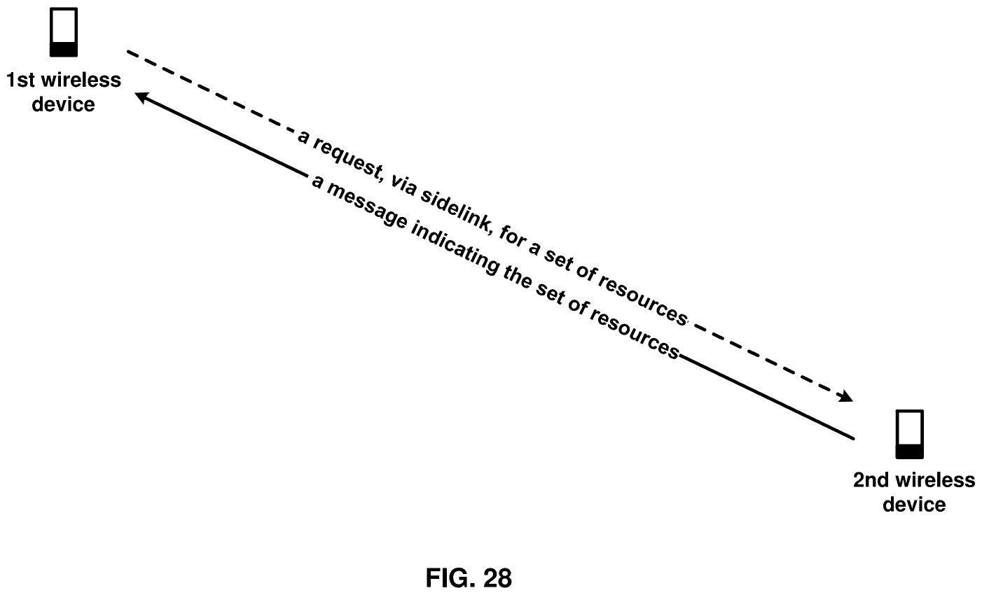

FIG. 28 illustrates an example of a sidelink inter-UE coordination (e.g., an inter-UE coordination scheme 1). A first wireless device and a second wireless device may receive an RRC message comprising sidelink configuration parameters (e.g., SL-InterUE-CoordinationConfig and/or SL-InterUE-CoordinationScheme1) indicating the sidelink inter-UE coordination (IUC) is enabled/configured, e.g., for a resource pool. A first wireless device and a second wireless device may perform an inter-UE coordination. The first wireless device may be a requesting wireless device of the inter-UE coordination between the first wireless device and the second wireless device. The first wireless device may be a transmitter of one or more sidelink transmissions. The second wireless device may be a coordinating wireless device of the inter-UE coordination. The second wireless device may or may not be an intended receiver of the one or more sidelink transmissions by the first wireless device.

Referring to FIG. 19, a sidelink transmission may comprise a PSCCH, a PSSCH and/or a PSFCH. A SCI of the sidelink transmission may comprise a destination ID of the sidelink transmission. A wireless device may be an intended receiver of the sidelink transmission when the wireless device has a same ID as the destination ID in the SCI.

In an example, before transmitting the one or more sidelink transmissions, the first wireless device may request, via control signaling and from the second wireless device, coordination information (e.g., assistance information) for the one or more sidelink transmissions. For example, the sidelink configuration parameters may indicate that inter-UE coordination information triggered by an explicit request is enabled (e.g., via sl-IUC-Explicit). The first wireless device may send/transmit, to the second wireless device and via sidelink, a request message, for the requesting of the coordination information (e.g., the first set of resources), to trigger the inter-UE coordination. For example, the first wireless device may transmit a control signal (e.g., SCI or SCI format 2-C and/or MAC-CE), comprising an inter-UE coordination request, to the second wireless device. The second wireless device may trigger the inter-UE coordination based on the receiving of the request message from the first wireless device. In an example, the first wireless device may not transmit a request message to trigger the inter-UE coordination. For example, the sidelink configuration parameters may indicate that inter-UE coordination information triggered by an explicit request is disabled (e.g., via sl-IUC-Explicit). The second wireless device may trigger the inter-UE coordination based on an event and/or condition. For example, the sidelink configuration parameters may indicate that inter-UE coordination information triggered by a condition is enabled (e.g., via sl-IUC-Condition), e.g., other than/independent of the explicit request reception.

The control signal (SCI/SCI format 2-C and/or MAC-CE) indicating inter-UE coordination request may comprise: a Providing/Requesting indicator field indicating a value (e.g., 1) indicating that the control signal is used to request inter-UE coordination information; a priority field indicating the priority of the one or more sidelink transmissions for which the inter-UE coordination information is requested; Number of subchannels field indicating the number of subchannels required for the one or more sidelink transmissions for which the inter-UE coordination information is requested; Resource reservation period (RP) field indicating the resource reservation period of the one or more sidelink transmissions for which the inter-UE coordination information is requested; Resource selection window location (RSWL) field indicating the location of the resource selection window for the one or more sidelink transmissions for which the inter-UE coordination information is requested; and/or Resource set type (RT) field indicating a request for inter-UE coordination information providing preferred resource set (e.g., by value 0) or indicating a request for inter-UE coordination information providing non-preferred resource set (e.g., by value 1).

The inter-UE coordination information request may indicate a first set/window of time/frequency resources from which one or more resources are selected for transmitting the one or more sidelink transmissions. The first wireless device may use the coordination information received from the second wireless device for/during the resource selection procedure of the one or more sidelink transmissions.

In response to the triggering the inter-UE coordination (e.g., based on an explicit request and/or one or more conditions being met), the second wireless device may trigger procedure for determining a set of preferred or non-preferred resources for the first wireless device's transmission (the one or more sidelink transmissions). The second wireless device may determine a resource selection window, [n+T_1,n+T_2] e.g., based on the RSWL, within which the preferred or non-preferred resources are to be determined. When determining a preferred resource set (e.g., if the resource set type indicates preferred set), the second wireless device performs UE procedure for determining the subset of resources to be reported to higher layers in PSSCH resource selection in sidelink resource allocation mode 2 (e.g., resource selection procedure), e.g., based on the determined resource selection window. The second wireless device may exclude candidate resource(s) belonging to slot(s) where the second wireless device does not expect to perform SL reception of a TB due to half-duplex operation, e.g., if the second wireless device is a destination UE of the TB for whose transmission the preferred resource set is being determined. When determining a non-preferred resource set, the second wireless device may consider any resource(s) within the resource selection window, if indicated by a received explicit request, and satisfying at least one of the following conditions as non-preferred resource(s): resource(s) indicated by a received SCI (e.g., SCI format 1-A) wherein the RSRP measurement performed for the received SCI is higher than a threshold, and the threshold is associated with the priority field in the received SCI; and/or resource(s) indicated by a received SCI (e.g., SCI format 1-A) wherein the second wireless device is a destination UE of a TB associated with the received SCI and the RSRP measurement performed for the received SCI is lower than a threshold, where the threshold is associated with the priority field in the received SCI; and/or resources(s) in slot(s) in which the second wireless device does not expect to perform SL reception due to half duplex operation, if the second wireless device is a destination UE of a TB for whose transmission the non-preferred resource set is being determined.

In response to triggering the inter-UE coordination, the second wireless device may select a second set of resources, e.g., a subset of the first set of resources indicated via the request, for the inter-UE coordination. In an example, the second wireless device may trigger a first resource selection procedure for selecting the second set of resources. In an example, the second wireless device may not trigger a first resource selection procedure for selecting the first set of resources. The second wireless device may select the second set of resources based on resource reservation/allocation information at the second wireless device. For example, the second wireless device may select the second set of resources based on that the second set of resources are reserved for uplink transmissions of the intended receiver of the one or more sidelink transmissions. For example, the second wireless device may select the second set of resources based on that the intended receiver of the one or more sidelink transmissions would receive other sidelink transmissions via the second set of resources. In an example, the second set of resources may be a set of preferred resources by the first wireless device for the one or more sidelink transmissions. The second set of resources may be a set of preferred resources by an intended receiver of the one or more sidelink transmissions. In an example, the second set of resources may be a set of non-preferred resources by the first wireless device for the one or more sidelink transmissions. The second set of resources may be a set of non-preferred resources by the intended receiver of the one or more sidelink transmissions.

The second wireless device may transmit, to the first wireless device and via sidelink, a message (e.g., the coordination information) comprising/indicating the second set of resources. The message may comprise a RRC, MAC-CE, and/or SCI. Referring to FIG. 19, the SCI may comprise a first stage SCI and/or a second stage SCI. In an example, the first stage of the SCI may comprise/indicate the second set of resources. In an example, the second stage of the SCI may comprise/indicate the second set of resources.

In response to receiving the message comprising the inter-UE coordination information, the first wireless device may select a third set of resources based on the second set of resources. In an example, the first wireless device may trigger a second resource selection procedure for the selecting of the third set of resources. In an example, the first wireless device may not trigger a second resource selection procedure for the selecting of the third set of resources. The first wireless device may select the third set of resources based on (e.g., from) the second set of resources. For example, the first wireless device may randomly select a resource, from the second set of resources, for the third set of resources. For example, the first wireless device may select a resource, from the second set of resources, for the third set of resources, if the resource is in a selection window of the second resource selection procedure. For example, the first wireless device may select a resource, from the second set of resources, for the third set of resources, if the resource is before a PDB (e.g., no later than the PDB) of the one or more sidelink transmissions.

The example of the inter-UE coordination in FIG. 28 may be an inter-UE coordination scheme 1. In the inter-UE coordination scheme 1, a coordinating wireless device may select a set of preferred resources and/or a set of non-preferred resources for a requesting wireless device. The coordinating wireless device may transmit/send/provide/indicate the set of preferred resources and/or the set of non-preferred resources (e.g., coordination information/assistance information) to the requesting wireless device. The requesting wireless device may transmit one or more sidelink transmissions based on the set of preferred resources and/or the set of non-preferred resources.

In an example, a preferred resource, for transmitting (e.g., by a requesting wireless device of an inter-UE coordination) and/or receiving (e.g., by a coordinating wireless device of the inter-UE coordination) a sidelink transmission, may be a resource with a RSRP (e.g., measured by the coordinating wireless device) being lower than a RSRP threshold. In an example, a preferred resource, for transmitting (e.g., by a requesting wireless device of an inter-UE coordination) and/or receiving (e.g., by a coordinating wireless device of the inter-UE coordination) a sidelink transmission, may be a resource with a priority value being greater than a priority threshold.

In an example, a non-preferred resource, for transmitting (e.g., by a requesting wireless device of an inter-UE coordination) and/or receiving (e.g., by a coordinating wireless device of the inter-UE coordination) a sidelink transmission, may be a resource with a RSRP (e.g., measured by the coordinating wireless device) being higher than a RSRP threshold (e.g., hidden node problem with high interference level). In an example, a non-preferred resource, for transmitting (e.g., by a requesting wireless device of an inter-UE coordination) and/or receiving (e.g., by a coordinating wireless device of the inter-UE coordination) a sidelink transmission, may be a resource with a priority value being smaller than the priority threshold (e.g., resource collision problem with another sidelink transmission/reception, which has a high priority). In an example, a non-preferred resource, for transmitting (e.g., by a requesting wireless device of an inter-UE coordination) and/or receiving (e.g., by a coordinating wireless device of the inter-UE coordination) a sidelink transmission, may be a resource being reserved for a second sidelink and/or uplink transmission by the coordinating wireless device and/or an intended receiver (e.g., half-duplex problem). The coordinating wireless device may or may not perform a resource selection procedure for selecting a set of non-preferred resources. The coordinating wireless device may select the set of non-preferred resources based on sensing results of the coordinating wireless device.

In an example, a larger priority value may indicate a lower priority. A smaller priority value may indicate a higher priority. For example, a first sidelink transmission may have a first priority value. A second sidelink transmission may have a second priority value. The first priority value may be greater than the second priority value, while a first priority of the first sidelink transmission indicated by the first priority value is lower than a second priority of the second sidelink transmission indicated by the second priority value.

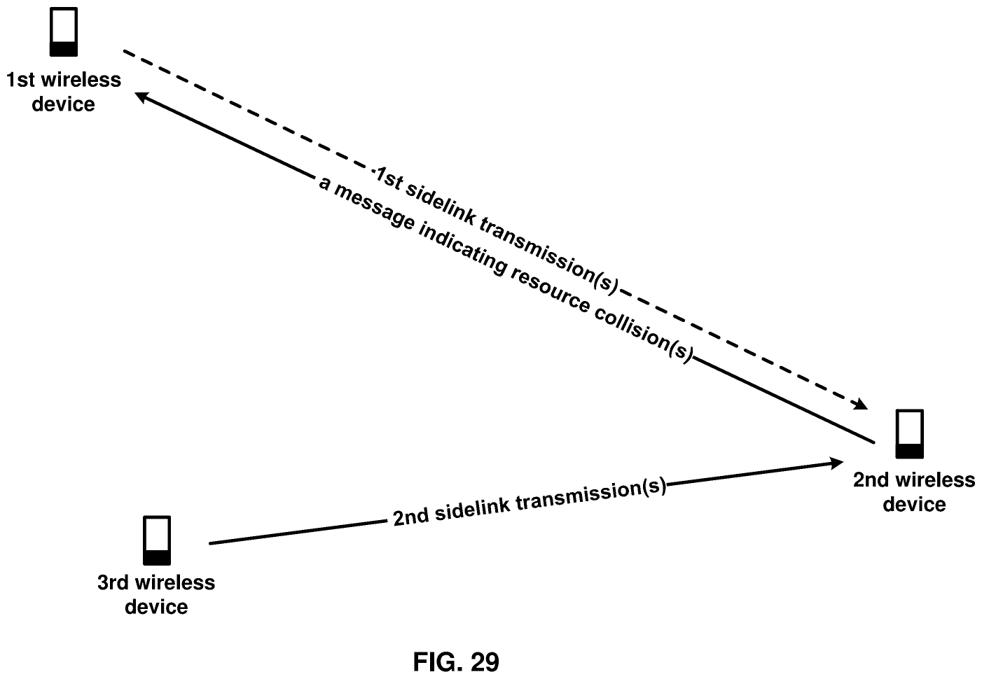

FIG. 29 illustrates an example of a sidelink inter-UE coordination (e.g., an inter-UE coordination scheme 2). A first wireless device and a second wireless device may perform an inter-UE coordination. The first wireless device may be a requesting wireless device of the inter-UE coordination between the first wireless device and the second wireless device. The first wireless device may be a transmitter of one or more first sidelink transmissions. The second wireless device may be a coordinating wireless device of the inter-UE coordination. The second wireless device may or may not be an intended receiver of the one or more first sidelink transmissions by the first wireless device.

Referring to FIG. 19, a sidelink transmission may comprise a PSCCH, a PSSCH and/or a PSFCH. A SCI of the sidelink transmission may comprise a destination ID of the sidelink transmission. A wireless device may be an intended receiver of the sidelink transmission when the wireless device has a same ID as the destination ID in the SCI

In an example, the first wireless device may request, from the second wireless device, coordination information (e.g., assistance information) for the one or more sidelink transmissions. The first wireless device may send/transmit, to the second wireless device and via sidelink, a request message, for the requesting of the coordination information, to trigger the inter-UE coordination. The second wireless device may trigger the inter-UE coordination based on the receiving of the request message from the first wireless device. In an example, the first wireless device may not transmit a request message to trigger the inter-UE coordination. The second wireless device may trigger the inter-UE coordination based on an event and/or condition.

In an example, the second wireless device may receive a first SCI from the first wireless device. The first SCI may reserve one or more first resources for the one or more sidelink transmissions. In an example, the request message may comprise the first SCI. In an example, the one or more sidelink transmissions may comprise the first SCI. In an example, the second wireless device may receive, from a third wireless device, one or more second sidelink transmissions. The one or more second sidelink transmissions may comprise a second SCI. The second SCI may reserve one or more second resources for the one or more second sidelink transmissions. The second wireless device may or may not be an intended receiver of the one or more second sidelink transmissions.

In response to the triggering of the inter-UE coordination, the second wireless device may determine the coordination information for the inter-UE coordination. In an example, the second wireless device may determine the coordination information based on the first SCI. The second wireless device may determine the one or more first resources comprising resources on which the second wireless device would not receive the one or more first sidelink transmissions, e.g., when the second wireless device is an intended receiver of the one or more first sidelink transmissions. The second wireless device may transmit via sidelink and/or uplink via the resources on which the second wireless device would not receive the one or more first sidelink transmissions. The second wireless device may experience half-duplex when transmitting via the resources (e.g., transmit via sidelink). The coordination information may comprise/indicate the resources on which the second wireless device would not receive the one or more first sidelink transmissions, e.g., when the second wireless device is an intended receiver of the one or more first sidelink transmissions. In an example, the second wireless device may determine the coordination information based on the first SCI and/or the second SCI. In an example, the second wireless device may determine the one or more first resources fully/partially overlapping with the one or more second resources. The second wireless device may determine the coordination information indicating overlapped resources of the one or more first resources and the one or more second resources. The overlapped resources may be expected/potential overlapped resources (e.g., future resources) and/or detected overlapped resources (e.g., past resources). The coordination information may comprise/indicate the overlapped resources between the one or more first resources and the one or more second resources. Fully overlapping between a first set of resources and a second set of resources may indicate that the first set of resources is the same as the second set of resources (e.g., or is the same as a subset of the second set of resources). Partially overlapping between a first set of resources and a second set of resources may indicate that the first set of resources and the second set of resources comprise overlapped (e.g., identical) one or more first sidelink resource units and/or non-overlapped (e.g., different) one or more second sidelink resource units.

In an example, the second wireless device may transmit, to the first wireless device and via sidelink, a message (e.g., coordination information/assistance information) comprising/indicating the coordination information, e.g., comprising indication of one or more resources based on example embodiments described above. The message may comprise a RRC, MAC CE, SCI and/or a PSFCH (e.g., a PSFCH format 0). A PSFCH format 0 may be a pseudo-random (PN) sequence defined by a length-31 Gold sequence. An index of a PN sequence of a PSFCH format 0 may indicate a resource collision on a resource, when the resource is associated with a PSFCH resource conveying the PSFCH format 0. Referring to FIG. 19, the SCI may comprise a first stage and a second stage. In an example, the first stage of the SCI may comprise/indicate the coordination information. In an example, the second stage of the SCI may comprise/indicate the coordination information.

In response to receiving the message, the first wireless device may select and/or update a set of resources for the one or more first sidelink transmissions based on the coordination information. In an example, the first wireless device may trigger a resource selection procedure for the selecting/updating of the set of resources. In an example, the first wireless device may not trigger a resource selection procedure for the selecting/updating of the set of resources. In an example, the first wireless device may determine whether to retransmit the one or more first sidelink transmissions based on the coordination information.

The example of the inter-UE coordination in FIG. 29 may be an inter-UE coordination scheme 2. In the inter-UE coordination scheme 2, a coordinating wireless device may determine coordination information based on expected/potential overlapped/collided resources (e.g., future resources) and/or detected overlapped/collided resources (e.g., past resources) between a first set of resources reserved by a requesting wireless device and a second set of resources reserved by a third wireless device.

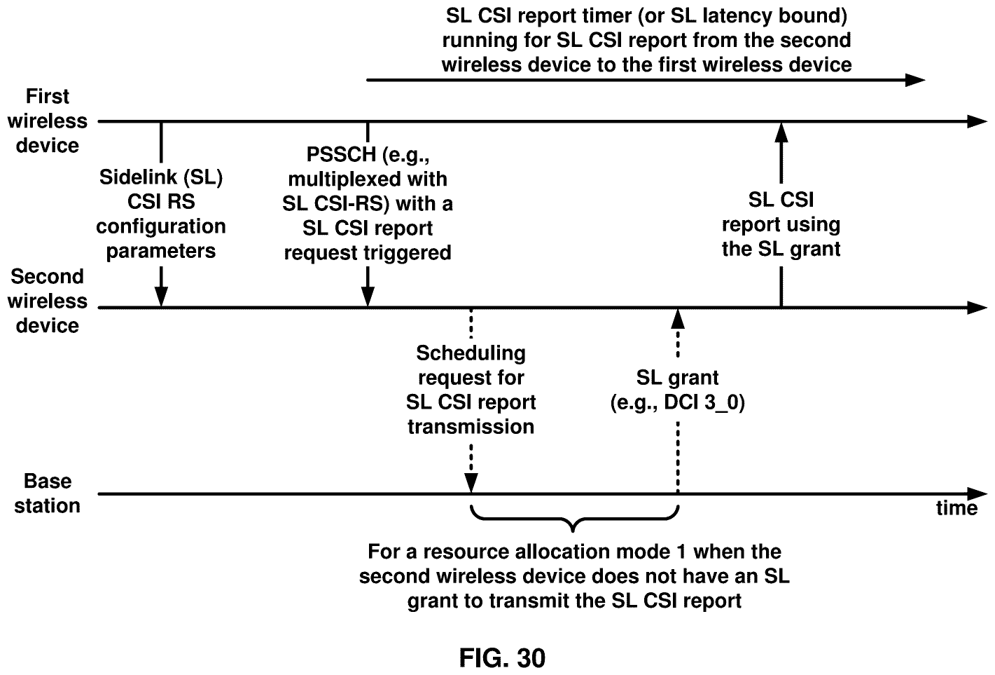

FIG. 30 illustrates an example of sidelink CSI-RS transmission and a sidelink CSI reporting procedure as per an aspect of an example embodiment of the present disclosure. A first wireless device (transmitter UE, Tx UE) may initiate (trigger, perform, run, and/or apply) a sidelink RRC reconfiguration procedure with a second wireless device (receiver UE, Rx UE). Purposes of the sidelink RRC reconfiguration procedure may comprise to indicate (e.g., configure or reconfigure) one or more parameters on sidelink measurement and reporting, to indicate (e.g., configure or reconfigure) sidelink CSI reference signal resources, and/or to indicate (e.g., configure or reconfigure) a CSI reporting latency bound.

For example, referring to FIG. 30, the first wireless device may initiate the sidelink RRC reconfiguration procedure on (e.g., for) a corresponding PC5-RRC connection and/or PC5 link (e.g., established between the first the wireless device and the second wireless device). In an example, in response to or after initiating the sidelink RRC reconfiguration procedure, the first wireless device may transmit a message (e.g., an RRC message, e.g., RRCReconfigurationSidelink) to the second wireless device. For example, the message may comprise one or more parameters, e.g., that comprise SL CSI RS configuration parameters in FIG. 30. The one or more parameters may comprise sl-LatencyBoundCSI-Report (e.g., latency bound in FIG. 30). sl-LatencyBoundCSI-Report (e.g., sidelink latency bound in FIG. 30) may indicate the SL CSI reporting latency bound. The one or more parameters included in the message may comprise, for SL CSI-RS transmission (and/or reception), a time resource allocation and/or time resource offset (e.g., sl-CSI-RS-FirstSymbol) indicating a first OFDM symbol in a PRB used for (e.g., that carries, if/when sidelink CSI reporting is triggered) SL CSI-RS; and/or a frequency resource allocation and/or frequency resource offset (e.g., sl-CSI-RS-FreqAllocation) indicating the number of antenna ports and/or the frequency domain allocation for (e.g., indicating frequency radio resource(s) that carries, if/when CSI reporting is triggered) SL CSI-RS. The time resource allocation and/or the time resource offset may start from a reference symbol in a slot where the wireless device receives SCI indicating a SL CSI-RS report/request. For example, the reference symbol may be a first symbol of the slot, a first symbol of PSCCH transmission in the slot, a first symbol of PSSCH transmission in the slot. The frequency resource allocation, and/or the frequency resource offset may start from a reference PRB (or RB or subchannel) in a slot where the wireless device receives the SCI indicating the SL CSI-RS report. For example, the reference PRB (or RB) may be a lowest PRB (or RB) of (e.g., carrying) the PSSCH and/or PSCCH transmission in a frequency domain. For example, the reference subchannel may be a lowest subchannel of (e.g., carrying) the PSSCH/PSCCH transmission in a frequency domain. For example, the reference PRB (or RB) may be a lowest PRB (or RB) of a lowest subchannel of (e.g., carrying) the PSSCH/PSCCH transmission in a frequency domain.

In an example, referring to FIG. 30, the first wireless device may transmit, via a slot (e.g., a single slot) a sidelink transmission comprising SCI that comprises a value of a field (e.g., and/or an indicator) triggering (e.g., indicating a trigger of or a request of) a transmission of SL CSI report and/or a transmission of SL CSI-RS(s). For example, the sidelink transmission comprises a first sidelink transmission via the slot and a second sidelink transmission via the slot. The first sidelink transmission may be a PSCCH transmission (e.g., PSCCH) that comprises a first stage SCI (e.g., as shown in FIG. 19). The second sidelink transmission may be a PSSCH transmission (e.g., PSSCH) that comprises a second stage SCI and SL-SCH data (e.g., comprising MAC PDU, MAC SDU(s) and/or MAC CE(s)) (e.g., as shown in FIG. 19). The SCI triggering the SL CSI report may be at least one of the first stage SCI and/or the second stage SCI. The first wireless device may transmit the sidelink CSI-RS within or via a PSSCH transmission. The sidelink transmission may be a unicast transmission. The PSSCH transmission may be a unicast PSSCH transmission.

Referring to FIG. 30, at least one of the first stage SCI and/or the second stage SCI may comprise a destination identifier associated with a unicast PC5 link (e.g., ProSe and/or V2X application layer(s)/server(s) send the destination identifier to the first wireless device). The second wireless device may receive the sidelink transmission. The second wireless device may determine that the destination identifier in the sidelink transmission matches an identifier of the second wireless device. The second wireless device may determine that the destination identifier in the sidelink transmission matches an identifier of the second wireless device. The second wireless device may determine that the value of the field in the SCI indicates a trigger of (e.g., triggering) a sidelink CSI report. The second wireless device may determine to transmit (e.g., may transmit) the sidelink CSI report to the first wireless device, e.g., if the second wireless device determines that the destination identifier in the sidelink transmission matches an identifier of the second wireless device, and/or if the value of the field in the SCI indicates a trigger of (e.g., triggering) the sidelink CSI report.

In an example, referring to FIG. 30, the second wireless device may start a timer or a window (e.g., sl-CSI-ReportTimer), e.g., if (e.g., in response to and/or after) e.g., the second wireless device determines to transmit (e.g., transmits) the sidelink CSI report. The first wireless device may start a second timer or a second window (e.g., sl-CSI-ReportTimer) that is the same as the timer or the window that the second wireless device starts, e.g., if (e.g., in response to and/or after) e.g., the first wireless device transmits the SCI indicating the trigger of the SL CSI report. The second wireless device may transmit the sidelink CSI report before the timer expires and/or while the timer is running. The SL latency bound in FIG. 30 may be a value for the timer. For example, the timer may run during a time duration indicated by the SL latency bound.

In an example, referring to FIG. 30, the second wireless device, e.g., configured with a resource allocation mode 1, receives, from a base station, a grant (e.g., SL grant (e.g., DCI 3_0) in FIG. 30) indicating a sidelink resource that is used for transmission of the SL CSI report to the first wireless device and/or that is located (e.g., occurs) within the SL latency bound that starts from a starting time of the timers. The second wireless device may transmit, to the base station, a scheduling request to receive the grant (e.g., SL grant in FIG. 30), e.g., if the second wireless device does not have an SL grant transmit the SL CSI report. The base station may transmit the grant (e.g., SL grant in FIG. 30) to the second wireless device, e.g., in response to and/or after receiving the scheduling request from the second wireless device. For example, the second wireless device, e.g., configured with a resource allocation mode 2, selects a sidelink resource that is used for transmission of the SL CSI report to the first wireless device and/or that is located within the SL latency bound that starts from a starting time of the timers.

In an example, referring to FIG. 30, the second wireless device may transmit to the first wireless device, the sidelink CSI report via the sidelink resource (indicated by the SL grant in FIG. 30 or selected by the second wireless device configured with resource allocation mode 2), e.g., before the timer expires, while the timer is running, and/or within the latency bound that starts from a starting time of the timer. For example, if the timer runs for the time duration indicated by the latency bound, the second wireless device may determine that the timer expires. The second wireless device may cancel the triggered sidelink CSI report (e.g., may cancel a transmission of the sidelink CSI report), e.g., if (e.g., the second wireless device determines that) the timer expires and/or if the second wireless device does not transmitting the sidelink CSI report before/until the timer expires, while the timer is running, and/or within the latency bound that starts from a starting time of the timer.

Conditions for the first wireless device to transmit the sidelink CSI-RS(s) may comprise that 1) sidelink CSI reporting is enabled by a higher layer parameter (e.g., sl-CSI-Acquisition); and 2) a field (e.g., the ‘CSI request’ field) in a corresponding SCI (e.g., SCI format 2-A) is set to 1. The corresponding SCI may schedule the PSSCH (e.g., be used for decoding of the PSSCH). The first wireless device may set a value of the ‘CSI request’ field as indicated by higher layers (e.g., to 1). When the first wireless device is configured with Qp={1,2} sidelink CSI-RS port(s) in sidelink and the number of scheduled layers is

$${n}_{layer}^{PSSCH} ,$$

the sidelink CSI-RS scaling factor β_{CSIRS} is given by

$${β}_{CSIRS} = {β}_{DMRS}^{PSSCH} \cdot \sqrt{\frac{{n}_{layer}^{PSSCH}}{{Q}_{p}}} ,$$

where

$${β}_{DMRS}^{PSSCH}$$

is the scaling factor for the corresponding PSSCH.

A SL CSI report may comprise SL CSI. The SL CSI may comprise information and/or one or more measurement quantities indicating a channel state that the second wireless device may determine and/or measure from/based on the sidelink CSI-RS received from the first wireless device. For example, the information and/or the one or more measurement quantities may comprise CQI, RI, LI, CRI, PMI, L1-RSRP, L1-SINR, and/or any combination thereof. The second wireless device may transmit, to the first wireless device, the SL CSI via a SL CSI report. The CQI and RI may be reported together. A procedure of transmitting the SL CSI report (and generating the sidelink CSI) may be denoted as SL CSI reporting. The CSI reporting may be aperiodic or periodic. Configured SL CSI-RS(s) may be aperiodic, semi-persistent, or periodic.

In the present embodiments, a SL CSI-RS may be interchangeable with and/or referred to as a CSI-RS, e.g., if the CSI-RS is transmitted via/as a sidelink transmission. In the present embodiments, a SL CSI report (or reporting) may be interchangeable with and/or referred to as a CSI-RS report (or reporting), e.g., if the CSI in the CSI-RS report comprise information and/or one or more measurement quantities indicating a channel state that a wireless device may determine and/or measure from the SL CSI-RS received from another wireless device.

In an example, referring to FIG. 30, the CSI report triggered by the SCI may be aperiodic CSI report. The SCI (e.g., SCI format 2-A) may comprise ‘CSI request’ field with a value set to 1 that indicate a trigger of (e.g., aperiodic) CSI report. The first wireless device (e.g., A CSI-triggering wireless device or a wireless device transmitting CSI-RS) may not be allowed to trigger (e.g., aperiodic) CSI report for the same wireless device (e.g., second wireless device) before/until a slot or a symbol in which the SL CSI report timer expires or before/until receiving the CSI report triggered by the SCI (e.g., SCI format 2-A) with the ‘CSI request’ field set to 1. The second wireless device may not be expected to transmit a sidelink CSI-RS and a sidelink PT-RS which overlap.

In FIG. 30, the second wireless device may receive a message (e.g., RRC message and/or RRCReconfigurationSidelink) comprising SL CSI-RS configuration parameters. The message may comprise SL-CSI-RS-Config. The SL-CSI-RS-Config may comprise SL CSI-RS configuration parameters, e.g., sl-CSI-RS-FreqAllocation, sl-CSI-RS-FirstSymbol, that indicate a resource allocation of SL CSI-RS in a frequency domain and a time domain.

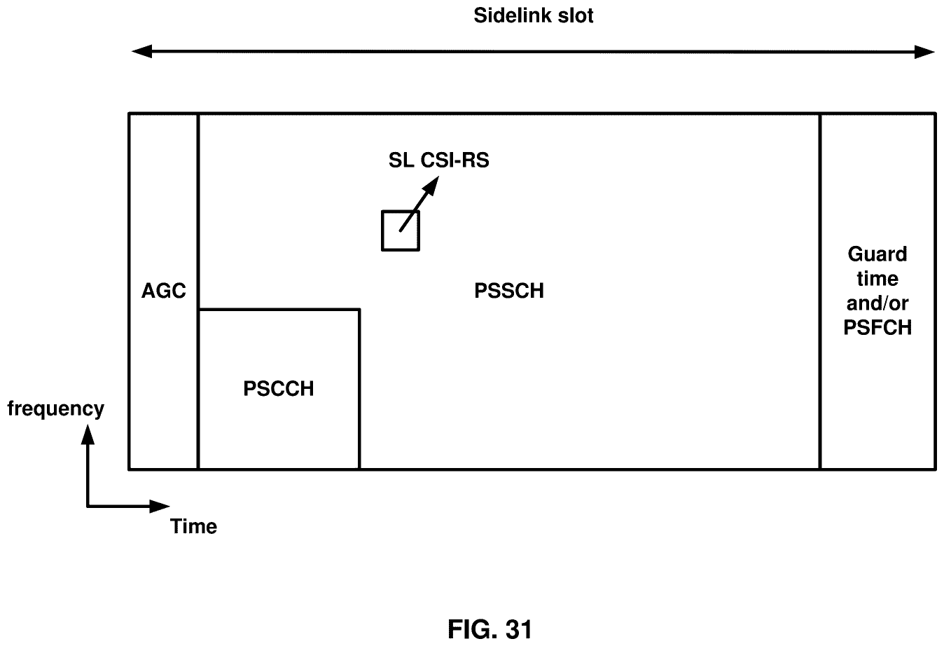

FIG. 31 illustrates an example of resource allocation of SL CSI-RS. The SL CSI-RS configuration parameters that the first wireless device transmits and/or that the second wireless device receives in FIG. 30 may indicate a starting frequency and a starting time of the SL CSI-RS in a slot where the first wireless device transmits a SCI triggering a SL CSI report. For example, the SL CSI-RS configuration parameters may indicate how many symbols and/or how many REs, and/or how many PRB carry the SL CSI-RS.

The second wireless device may determine (e.g., assume) non-zero transmission power for SL CSI-RS. A SL CSI-RS and the PSCCH (that is located in the same slot and/or that schedules PSSCH carrying the SL CSI-RS) may not be mapped to the same resource element. The SL CSI-RS and PSSCH DM-RS may not be scheduled, mapped, allocated in a same symbol. The SL CSI-RS and SCI (1st-stage CSI and/or 2nd-stage SCI) may not be scheduled, mapped, allocated in a same symbol. The first wireless device may transmit the SL CSI-RS in resource block(s) used for transmitting the PSSCH, e.g., that carries the SCI format 2-A scheduling the PSSCH, triggering a SL CSI report comprising SL CSI measured based on the SL CSI-RS. The second wireless device may receive, e.g., from the first wireless device, one SL latency bound, sl-LatencyBoundCSI-Report, configured for different SL CSI-RS transmissions.

In an example, the SL CSI reporting (e.g., SL CSI reporting procedure) may be used to provide a peer wireless device (the first wireless device) with sidelink CSI. For example, the SL latency bound, sl-LatencyBoundCSI-Report, may be defined, configured, and/or received per (e.g., for) each PC5-RRC connection. For example, the second wireless device may receive a first SL latency bound from a first wireless device for a first PC5-RRC connection and/or first a PC5 link established with the first wireless device. For example, the second wireless device may receive a second SL latency bound from a third wireless device for a second PC5-RRC connection and/or second a PC5 link established with the third wireless device.

In an example, a MAC entity (of the first wireless device and/or the second wireless device) may maintain a timer (e.g., sl-CSI-ReportTimer, SL CSI report timer in FIG. 30) for each pair of the Source Layer-2 ID and the Destination Layer-2 ID corresponding to a PC5-RRC connection. The sl-CSI-ReportTimer may be used for an SL-CSI reporting wireless device (e.g., the second wireless device) to follow the latency requirement (e.g., sl-LatencyBoundCSI-Report) signaled from a CSI-report-triggering wireless device (e.g., the first wireless device). The value (e.g., an initial value) of sl-CSI-ReportTimer may be the same as the latency requirement of the SL-CSI reporting in the sl-LatencyBoundCSI-Report configured by RRC. The value indicates a (e.g., maximum) running time of the sl-CSI-ReportTimer. If the sl-CSI-ReportTimer runs for a duration indicated by the value, the wireless device may determine that the sl-CSI-ReportTimer expires. The wireless device may stop the sl-CSI-ReportTimer if the wireless device receives a CSI report. The MAC entity may for each pair of the Source Layer-2 ID and the Destination Layer-2 ID corresponding to the PC5-RRC connection which has been established by upper layers:
1> if the SL-CSI reporting has been triggered by an SCI and not cancelled:
   2> if the sl-CSI-ReportTimer for the triggered SL-CSI reporting is not running:
      3> start the sl-CSI-ReportTimer.
   2> if the sl-CSI-ReportTimer for the triggered SL-CSI reporting expires:
      3> cancel the triggered SL-CSI reporting.
   2> else if the MAC entity has SL resources allocated for new transmission and the SL-SCH resources can accommodate the SL-CSI reporting MAC CE and its subheader as a result of logical channel prioritization:
      3> instruct the Multiplexing and Assembly procedure to generate a Sidelink CSI Reporting MAC CE;
      3> stop the sl-CSI-ReportTimer for the triggered SL-CSI reporting;
      3> cancel the triggered SL-CSI reporting.
   2> else if the MAC entity has been configured with Sidelink resource allocation mode 1:
      3> trigger a Scheduling Request.

The wireless device may determine that a SL CSI report is pending (e.g., until canceling the SL CSI report), e.g., if the wireless device triggers the SL CSI report. The MAC entity configured with Sidelink resource allocation mode 1 may trigger a Scheduling Request (e.g., FIG. 30) if transmission of a pending SL-CSI reporting with the sidelink grant(s) cannot fulfil the latency requirement associated to the SL-CSI reporting.

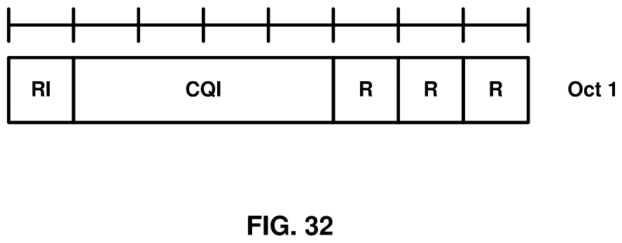

FIG. 32 illustrates an example of SL CSI report as per an aspect of an example embodiment of the present disclosure. For example, the SL CSI report may comprise a MAC CE that includes SL CSI. For example, the MAC CE may be a Sidelink CSI Reporting MAC CE is identified by a MAC subheader with LCID predefined. A priority of the Sidelink CSI Reporting MAC CE is fixed to a predefined value (e.g., ‘1’ indicating a highest priority). In FIG. 32, the RI may be a field indicating a derived value of the Rank Indicator for sidelink CSI reporting from the measurement results of the SL CSI-RS. The length of the RI field is predefined (e.g., 1 bit). In FIG. 32, the CQI may be a field indicating a derived value of the Channel Quality Indicator for sidelink CSI reporting from the measurement results of the SL CSI-RS. The length of the CQI field may be predefined (e.g., 4 bits). In FIG. 32, the R may indicate one or more reserved bits, e.g., that are set to a predefined value (e.g., 0).

In an example, the sidelink transmission may be beam-centric. For example, between peer wireless devices, a transmission of PSCCH, PSSCH, and/or PSFCH may be performed via, through, and/or using a particular beam. A sidelink reference signal (e.g., SL SSB, and/or SL CSI-RS) may represent a particular beam for the sidelink transmission.

In sidelink, a wireless device may perform a beam sweeping for the beam-centric sidelink transmission. For example, a first wireless device may transmit, as the beam sweeping, a plurality of sidelink reference signal (SL RSs) (e.g., SL CSI-RSs) to a second wireless device. Each of the plurality of SL RSs may be corresponding to (e.g., associated with and/or represent) a respective beam of the first wireless device.

The beam sweeping may be for a sidelink unicast link between a pair of a source UE (e.g., identified/indicated by a source identifier, e.g., Layer-2 Source ID) and a destination UE (e.g., identified/indicated by a destination identifier, e.g., Layer-2 Destination ID). A source UE and/or a destination UE may refer to an Application Layer ID in a wireless device that supports one or more V2X services that communicate using a same PC5 unicast link. A PC5 unicast link is bi-directional, e.g., the wireless device may transmit to and receive from another wireless device using the PC5 unicast link. The UE (e.g., the application layer of the wireless device) may use the source ID when transmitting in sidelink using the PC5 unicast link. The UE (e.g., the application layer of the wireless device) may use the destination ID when receiving in sidelink using the PC5 unicast link. A source UE may be referred to as source. A destination UE may be referred to as destination. A pair of wireless devices may comprise/have/be associated with one or more PC5 unicast links, and thus, one or more pairs of (Source ID, Destination ID).

The sidelink unicast link may refer to direct communication link established between the pair of the source and the destination. The sidelink unicast link may be referred to as a PC5 (Proximity Service Communication 5) link, PC5 unicast link, PC5-RRC connection, and/or the like. For example, PC5-RRC connection may refer to a PC5 link over which a RRC layer is setup/established between the source and the destination.

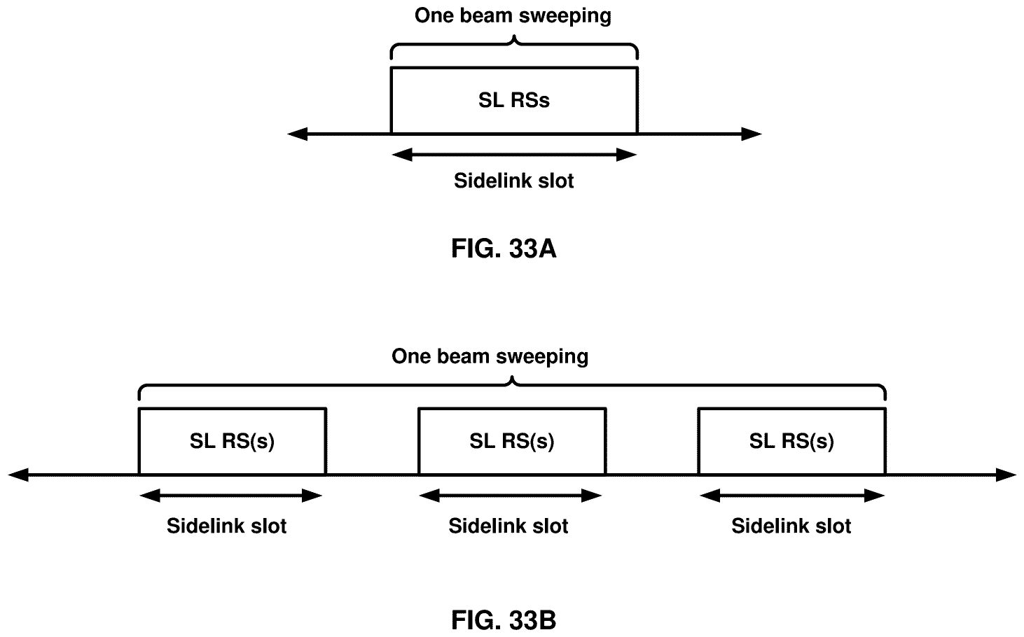

FIG. 33A and FIG. 33B illustrate examples of SL RSs as per an aspect of an example embodiment of the present disclosure. For example, as illustrated in FIG. 33A, a first wireless device may transmit a plurality of SL RSs (e.g., a group/set of SL RSs), corresponding to (e.g., for or associated with) a respective beam sweeping, within a sidelink slot (a.k.a., intra-slot beam sweeping). For example, as illustrated in FIG. 33B, a first wireless device may transmit a plurality of SL RSs (e.g., a group/set of SL RSs), corresponding to (e.g., for or associated with) a respective beam sweeping, via (e.g., across) multiple sidelink slots (a.k.a., inter-slot beam sweeping). The first wireless device may transmit one or more SL RSs via each of the sidelink slots in FIG. 33B.

The plurality of SL RSs in FIG. 33A and/or in FIG. 33B are associated with a particular set or group (e.g., beam sweeping group) of SL RS transmission. For example, each of the plurality of SL RSs is associated with a same set or a same group. For example, a set or a group (e.g., that is associated with one or more SL RSs or that comprises one or more SL RSs) may be associated with a particular beam sweeping of SL RS transmission. Each set or group (or its respective beam sweeping) may be associated with a particular purpose of SL RS transmission. For example, a particular set or group (or its respective beam sweeping) may be for a periodic transmission of a plurality of SL RSs, aperiodic transmission of a plurality of SL RSs, and/or semi-persistent transmission of the plurality of SL RS, transmission(s) of a plurality of SL RSs for an initial beam pairing procedure, transmission(s) of a plurality of SL RSs for beam management procedure, transmission(s) of a plurality of SL RSs for a beam failure detection/recovery procedure, and/or any combination thereof.

For example, a first wireless device may transmit, to a second wireless device, a message comprising a plurality of configurations (e.g., sl-CSIRS-ResourceConfig IE or the like). Each of the plurality of configurations may be associated with a respective set (or a group) of a plurality of sets (or groups). Each of the plurality of configurations may comprise a respective configuration identifier (additionally or alternatively, a respective set identifier or a respective group identifier) that indicates a respective set (or a group) of the plurality of sets (or groups). Each of the plurality of configurations may comprise parameters indicating one or more SL RSs associated with a respective set (or a group).

In FIG. 33A and FIG. 33B, the first wireless device may transmit, to a second wireless device, the SL RSs with an indication of a set and/or a group associated with the SL RSs. For example, in a sidelink slot in FIG. 33A, the first wireless device may transmit, to the second wireless device, a control information (e.g., SCI, a first stage SCI, and/or a second stage SCI) comprising a field value (e.g., set identifier, group identifier, and/or configuration identifier) indicating the set and/or the group associated with the SL RSs. For example, the first wireless device transmits the control information via a sidelink slot where the first wireless device transmits the SL RSs. The second wireless device may determine that the control information (comprising the field value) indicates a transmission of the SL RSs, associated with the set and/or the group (indicated by the field value in the SCI). The second wireless device may determine that the SL RSs are being transmitted in the sidelink slot. In FIG. 33B, in at least one sidelink slot (e.g., the firstly located sidelink slot or all of three sidelink shots) of three shots in FIG. 33B, the first wireless device may transmit, to the second wireless device, a control information (e.g., SCI, a first stage SCI, and/or a second stage SCI) comprising a field value (e.g., set identifier, group identifier, and/or configuration identifier) indicating the set and/or the group associated with the SL RSs. The second wireless device may determine that the control information (comprising the field value) indicates a transmission of the SL RSs, associated with the set and/or the group (indicated by the field value in the SCI), being in the at least one sidelink slot and/or in all three sidelink slots.

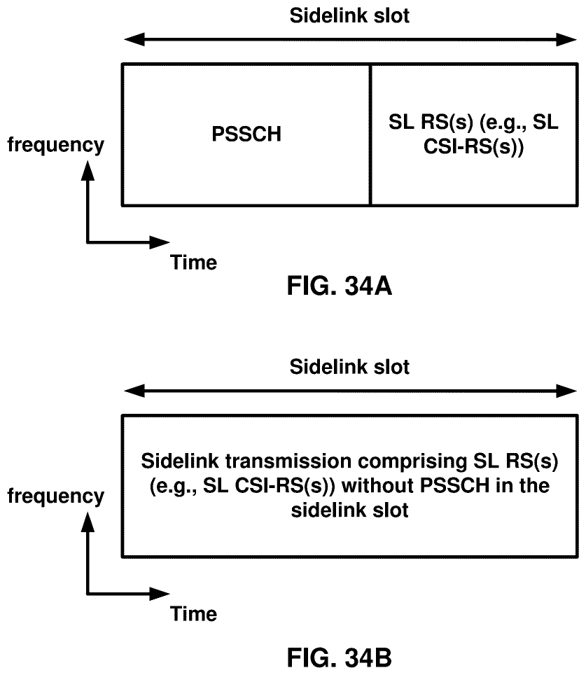

FIG. 34A illustrates an example for SL RS transmission as per an aspect of an embodiment of the present disclosure. A first wireless device may transmit, to a second wireless device, a SL RS (e.g., SL CSI-RS), e.g., each of SL RS(s) (e.g., SL CSI-RS(s), with a (e.g., unicast) PSSCH in a sidelink (e.g., same) slot, as illustrated in FIG. 34A. For example, the first wireless device may transmit a plurality of SL RSs and PSSCH in a same sidelink slot. The first wireless device may transmit the SL RS(s) in FIG. 34A for a beam sweeping (e.g., an initial beam pairing procedure, a beam management procedure, and/or a beam failure detection/recovery procedure). The SL RS(s) in FIG. 34A may be at least one of the SL RSs in FIG. 33A or any one of SL RS(s) in one of three sidelink slots in FIG. 33B. The sidelink slot in FIG. 34A may be a sidelink slot in FIG. 33A or any one of sidelink slots in FIG. 33B.

FIG. 34A is an example of multiplexing SL RS(s) with PSSCH in a time-division multiplexing (TDM) manner. For example, the SL RS may be multiplexed with PSSCH in a sidelink (e.g., same) slot in different ways. In an example, one or more PSSCH symbols may be firstly located in the sidelink slot, followed by one or more SL RS symbols in the sidelink (e.g., same) slot. In an example, SL RS symbols may be firstly located in the sidelink slot, followed by one or more PSSCH symbols in the sidelink slot. In an example, one or more PSSCH symbols may be allocated between two SL RS symbols in the sidelink slot. The transmission of SL RS(s) with PSSCH in a same slot may be referred to as a non-standalone transmission of SL RS(s) or the like. In FIG. 34A, the first wireless device may transmit PSCCH and/or SCI in the sidelink slot where the first wireless device transmits the SL RS(s) and/or the PSSCH. The PSCCH and/or SCI may comprise one or fields whose values indicates at least one of: a number of SL RS(s) in the sidelink slot; a starting position (symbol), in a slot, of each of the SL RS(s) in the sidelink slot; an ending position (symbol), in the sidelink slot, of each of the SL RS(s) in the sidelink slot; and/or a frequency resource allocation of each of the SL RS(s) in the sidelink slot.

FIG. 34B illustrates an example for SL RS transmission as per an aspect of an embodiment of the present disclosure. A first wireless device may transmit, to a second wireless device, a SL RS (e.g., SL CSI-RS), e.g., each of SL RS(s) (e.g., SL CSI-RS(s)), without a (e.g., unicast) PSSCH in a same slot, as illustrated in FIG. 34B. The first wireless device may transmit the SL RS(s) in FIG. 34B for a beam sweeping (e.g., an initial beam pairing procedure, a beam management procedure, and/or a beam failure detection/recovery procedure). The SL RS(s) in FIG. 34B may be at least one of the SL RSs in FIG. 33A or any one of SL RS(s) in one of three sidelink slots in FIG. 33B. The sidelink slot in FIG. 34A may be a sidelink slot in FIG. 33A or any one of sidelink slots in FIG. 33B.

The transmission of SL RS(s) without PSSCH in a sidelink slot, as illustrated in FIG. 34B, may be referred to as a standalone transmission of SL RS(s) or the like. In FIG. 34B, the first wireless device may transmit PSCCH and/or SCI in the sidelink (e.g., same) slot where the first wireless device transmits the SL RS(s). The PSCCH and/or SCI may comprise one or fields whose values indicates at least one of: a number of SL RS(s) in the sidelink slot; a starting position (symbol), in a slot, of each of the SL RS(s) in the sidelink slot; an ending position (symbol), in the sidelink slot, of each of the SL RS(s) in the sidelink slot; and/or a frequency resource allocation of each of the SL RS(s) in the sidelink slot.

In an example, a transmission of a SL RS may be a transmission of a sequence of SL RS (e.g., SL CSI-RS). For example, a sequence of SL RS may be denoted by r(m). A first wireless device may generate the sequence r(m) as a formular predefined. For example, the sequency r(m) may be

$$r ( m ) = \frac{1}{\sqrt{2}} ( 1 - 2 c ( 2 m ) ) + j \frac{1}{\sqrt{2}} ( 1 - 2 c ( 2 m + 1 ) ) .$$

c(i) may be a pseudo-random sequence. c(i) may be initialized with

$${c}_{init} = ( {2}^{10} ( {N}_{symb}^{slot} {n}_{s , f}^{μ} + l + 1 ) ( 2 {n}_{ID} + 1 ) + {n}_{ID} )$$

mod 2³¹ at the start of each OFDM symbol.

$${n}_{s , f}^{μ}$$

may be the slot number (or index) within a radio frame. l may be the OFDM symbol number (or index) within a slot. In an example, a first wireless device may transmit a SL RS via a symbol with the OFDM symbol number l within the slot. In an example, the parameter sl-CSI-RS-FirstSymbol may indicate the OFDM symbol number l. A second wireless device may receive the SL RS via the symbol within the slot.

A first wireless device may transmit a plurality of SL RSs (e.g., SL CSI RSs) via a plurality of OFDM symbols within a slot (e.g., for SL beam management), for example, as illustrated in FIG. 33A, FIG. 33B, FIG. 34A, and/or FIG. 34B. The first wireless device may transmit the plurality of SL RSs with a PSSCH in the slot (e.g., in FIG. 34A) or without a PSSCH in the slot (in FIG. 34B). The plurality of SL RSs and the PSSCH may occupy (or be carried on, or be scheduled in) different OFDM symbols in the slot, e.g., if the first wireless device transmits the plurality of SL RSs and the PSSCH in the same slot. The plurality of OFDM symbols may be allocated to SL RSs. An indication (e.g., a field of a SCI within the slot) may indicate the presence of SL RSs for beam measurement in transmission of the PSSCH. For example, a 1 bit field in a SCI Format 1-A may inform (or indicate) that transmitted SL RS is used for beam management.

In example embodiments of present disclosure, a beam sweeping may refer to or comprise a transmission of a plurality of SL RSs from one wireless device to another wireless device. The transmission of the plurality of SL RSs may occur during a plurality symbols via a slot (e.g., FIG. 33A) or via/across multiple slots (e.g., FIG. 33B). Each of the plurality of SL RS may be associated with or be grouped into a same configuration IE (e.g., sl-CSIRS-ResourceConfig IE or the like), a same set, and/or a same group. The same configuration IE (e.g., sl-CSIRS-ResourceConfig IE or the like), the same set, and/or the same group are identified by a respective identifier (e.g., configuration id, set id, group id, and/or the like). For example, a configuration IE may comprise a value of a parameter indicating the respective identifier (e.g., configuration id, set id, group id, and/or the like).

A SL RS may be referred to as or indicated by a different terminology. For example, a SL TCI state, a SL SRI, a SL beam may be used to refer to a SL RS. For example, a SL configuration may comprise a first SL TCI state or a first SL SRI field (or container or IE) that comprises, is linked to, or associated with a first SL RS (e.g., SL CSI RS). In this case, the first SL TCI state or the first SL SRI field (or container or IE) may be used as a terminology to indicate the first SL RS. Likewise, in this case, the first SL RS may be used as a terminology to indicate the first SL TCI state or the first SL SRI field (or container or IE).

The UE may receive one or more RRC messages comprising SL configuration parameters of the SL resource pool and/or the unicast link (e.g., via PC5 link from a second UE or via downlink from a BS). In an example, one or more SL TCI states may refer to a first SL RS. For example, SL RRC configurations (e.g., SL-TCI-State) may indicate a plurality of TCI states (e.g., via SL-TCI-StateId) corresponding to a first SL RS (referenceSignal), e.g., a wide beam (S-SSB and/or SL CSI-RS). For example, each of the plurality of TCI states may indicate a spatial domain transmission/reception filter setting (e.g., RX filter and/or TX filter) that is quasi co-located (QCLed) with the first SL RS. The SL RRC configurations may comprise a parameter (e.g., SL-QCL-Info) indicating the first SL RS and a QCL type for a respective SL TCI state. For example, the QCL type may be typeA (based on Doppler shift, Doppler spread, average delay, and delay spread), typeB (based on Doppler shift and Doppler spread), typeC (based on Doppler shift, average delay), typeD (based on Spatial Rx parameter), or a combination thereof. For example, each SL TCI State may contain parameters for configuring a quasi co-location relationship between one or two sidelink reference signals and the DM-RS ports of the PSSCH, the DM-RS port of PSCCH or the SL CSI-RS port(s) of a SL CSI-RS resource. The quasi co-location relationship may be configured by the higher layer parameter QCL Type for the first SL RS in a first SL BWP and/or resource pool.

Each of the plurality of SL RS may be associated with a respective spatial filter of a wireless device. For example, a first wireless device may: determine to use a first TX spatial filter for transmitting, to a second wireless device, a first SL RS of the plurality of SL RSs; determine to use a second TX spatial filter for transmitting, to a second wireless device, a second SL RS of the plurality of SL RSs; and so on. For example, if a first SL RS and a second SL RS are associated with a same TX spatial filter, the first wireless device and/or the second wireless device may determine that the first SL RS is quasi-co located with the second SL RS. If a first SL RS and a second SL RS are linked to or associated with a same SL TCI or SL SRI, the first wireless device and/or the second wireless device may determine that the first SL RS is quasi-co located with the second SL RS.

For example, if a first SL RS and a second SL RS are associated with a same TX spatial filter, the first wireless device and/or the second wireless device may determine that the first SL RS is quasi-co located with the second SL RS. If a first SL TCI (or first SL SRI) and a second SL TCI (or second SL SRI) are linked to or associated with a same SL RS, the first wireless device and/or the second wireless device may determine that the first SL TCI is quasi-co located with the second SL TCI.

For example, a SL TCI may be referred to as or be interchangeably used with a SL TCI state. A SL TCI (or a configuration of the SL TCI) may comprise or is associated with a respective SL TCI identifier. The SL TCI identifier may be used to indicate a respective SL TCI. A SL SRI (or a configuration of the SL SRI) may comprise or is associated with a respective SL SRI identifier. The SL SRI identifier may be used to indicate a respective SL SRI. A SL RS (or a configuration of the SL RS) may comprise or is associated with a respective SL RS identifier. The SL RS identifier may be used to indicate a respective SL RS.

The RX/TX spatial filters and/or the corresponding SL RSs may be configured for (via/in) a respective unicast connection. For example, in mode 1, the UE may receive, from the BS, RRC message(s) comprising the SL configurations for a unicast link with a second UE. For example, in mode 2, the UE may receive from a second UE, or transmit to the second UE, PC5 link RRC message(s) comprising the SL configurations for the unicast link with the second UE. The SL configurations may indicate TCI states and/or SL RSs that are dedicated/specific to the respective unicast link. For example, the UE may have multiple unicast links in sidelink with one or more second UEs. The UE may determine and apply corresponding Rx/Tx spatial filters for transmission and receptions via/on/for each of these unicast links based on the respective configuration of the unicast link. For example, the PC5 unicast link may be between a first Layer-2 ID of the first UE and a first Layer-2 ID of the second UE.

During the beam sweeping in which a first wireless device transmits, to a second wireless device, a plurality of SL RSs, the second wireless device may determine a preferred SL beam or a preferred SL beam pair. For example, a (e.g., preferred) SL beam or a preferred SL beam pair may be represented by or identified by a respective SL TCI, SL SRI, or SL RS. For example, the second wireless device may determine a measurement quantity (e.g., L1 RSRP or RSRQ) of each of the plurality of SL RSs. The second wireless device may determine or select a preferred SL beam in response to the measurement quantity satisfying one or more conditions (e.g., RSRP value is higher than or equal to a RSRP threshold). For example, a preferred beam may be associated with a SL RS that has a L1 RSRP higher than the RSRP threshold.

During the beam sweeping, the second wireless device may determine/select its RX spatial filter corresponding to the (e.g., preferred) SL beam. The determined/selected preferred SL beam and the determined/selected RX spatial filter may be referred to as a (e.g., preferred) SL beam pair. The second wireless device may transmit, to the first wireless device, a signal or message (e.g., CSI report) indicating the selected (e.g., preferred) SL beam and/or a (e.g., preferred) SL beam pair. For example, the signal or message (e.g., CSI report) may comprise a field indicating a SL TCI, SL SRI, or SL RS identifier associated with the selected (e.g., preferred) SL beam and/or a (e.g., preferred) SL beam pair, e.g., as a way to indicate the selected (e.g., preferred) SL beam and/or a (e.g., preferred) SL beam pair.

A wireless device may transmit a plurality of SL RSs, as the beam sweeping, for an (e.g., initial) beam pairing procedure, a beam management (or maintenance) procedure, a beam failure detection/recovery procedure.

The (e.g., initial) beam pairing procedure may comprise a determination of beam pair that is used for a transmission via/using a unicast link between a first wireless device and a second wireless device. Before actual SL transmission, the first wireless device and the second wireless device may select a preferred TX beam (e.g., TX spatial filter or precoder) and a preferred RX beam (e.g., RX spatial filter), e.g., a beam pairing, for the SL transmission.

For example, the beam pairing procedure may comprise transmitting, by the first wireless device to the second wireless device, a plurality of SL RSs to select a beam used by the first wireless device to transmit a sidelink transmission to the second wireless device and/or to receive a sidelink transmission from the second wireless device. For example, the first wireless device may transmit the plurality of SL RSs using different beams or using different TX spatial filters (e.g., each of the plurality of SL RSs is associated with a respective beam of the different beams or with a respective TX spatial filter of the different TX spatial filters). The second wireless device may determine measurement quantity(-ies) measured on the plurality of SL RSs and transmit, to the first wireless device, a measurement report (e.g., CSI report). The measurement report may comprise one or more of the measurement quantity(-ies) of the plurality of SL RSs and/or an indication of one or more preferred/selected beams (or an index/identifier of a SL RS of the plurality of SL RSs). The first wireless device may select or determine, based on the measurement quantity(-ies) and/or the one or more preferred/selected beam, its TX beam and/or RX beam (that are associated with one of the plurality of SL RSs) for a sidelink transmission with the second wireless device.

For example, the beam pairing procedure may comprise transmitting, by the first wireless device to the second wireless device, a SL RS via (e.g., across) multiple symbols or slots for the second wireless device to sweep its RX beams to select a beam used by the second wireless device to transmit a sidelink transmission to the first wireless device and/or to receive a sidelink transmission from the first wireless device. For example, the first wireless device may transmit a SL RS using a same beam or using a same TX spatial filter via (e.g., across) multiple symbols or slots. The SL RS may be associated with (e.g., may correspond to) a preferred TX beam or RX beam that the first wireless device selects for transmitting a sidelink transmission to the first wireless device or for receiving a sidelink transmission from the second wireless device. While the first wireless device transmits the SL RS via the multiple symbols or multiple slots, the second wireless device may receive the SL RS using different RX beams (e.g., may perform a RX beam sweeping). For example, the second wireless device may determine measurement quantity(-ies) measured on the SL RS per each of RX beams and select one of the RX beams as the one to be used to transmit a sidelink transmission to the first wireless device and/or to receive a sidelink transmission from the first wireless device.

The beam pairing procedure may occur while the first wireless device and the second wireless device are establishing a unicast link (e.g., during a unicast link establishment procedure). The beam pairing procedure may occur after the first wireless device and the second wireless device complete establishing a unicast link (e.g., after completing a unicast link establishment procedure). The beam pairing procedure may comprise transmitting, by the first wireless device to the second wireless device, SL configuration parameters.

The beam management procedure may comprise transmission(s) of one or more SL RSs, a transmission(s) of measurement report(s) associated with the one or more SL RSs, and/or determination on whether to maintain or switch a current TX beam (and/or a current RX beam). For example, the beam management may comprise transmitting, by a first wireless device to a second wireless device, one or more SL RSs using one or more TX beams. For example, the beam management procedure may be for a link monitoring on a unicast link established between the first wireless device and the second wireless device. The first wireless device may transmit a message comprising configuration parameters indicating SL RSs used for the beam management procedure. The configuration parameters may comprise one or more parameters indicating a radio resource mapping of each of the SL RSs to respective RE(s), one or more reporting quantities (e.g., L1-RSRP, CQI, RI, PMI, or the like) measured by/based on each of the SL RSs and to be reported to the first wireless device, and/or the resource scheduling information (e.g., whether the SL RSs are periodic, aperiodic, or semi-persistent transmission). The second wireless device may determine measurement quantities according to the configuration parameters and transmit, to the first wireless device, a measurement report comprising one or more measurement quantities. The first wireless device and/or the second wireless device may switch their TX beam and/or RX beam used for the sidelink transmission between them to another TX beam and/or RX beam based on the measurement report.

The beam failure detection/recovery procedure may enable beamformed sidelink unicast link to quickly and effectively re-form a broken communication link, e.g., without performing the (e.g., initial) beam pairing procedure that may be time consuming. For example, the beam failure detection/recovery procedure may comprise at least one of a beam failure detection (BFD) and/or a candidate beam identification, or a beam failure recovery.

The BFD may be based on a measurement quantity of one or more first SL RSs. For example, a first wireless device may transmit, to a second wireless device, a message (e.g., SL RRC reconfiguration message) indicating the one or more first SL RSs, e.g., among a plurality of first SL RSs, as the ones for the BFD. The first wireless device may transmit to the second wireless device after transmitting the message, the one or more first SL RSs one or more times. The second wireless device may determine a measurement quantity of the received one or more first SL RSs, e.g., for each time the first wireless device transmits the one or more first SL RSs. For example, the second wireless device may determine a beam failure instance if the measurement quantity satisfies one or more BFD conditions. For example, the second wireless device may determine a beam failure instance (e.g., indicating that the BFD occurs) if an RSRP value (or the like) measured on the one or more first SL RSs is below (lower than) a BFD threshold. The second wireless device may determine BFD, e.g., if the beam failure instance occurs, e.g., consecutively, for N times (e.g., N≥1) within a time window.

The candidate beam identification may comprise: monitoring, by the second wireless device, one or more second SL RSs that the first wireless device transmits; and/or determining a candidate beam based on the one or more second SL RSs. For example, the first wireless device may transmit, to the second wireless device, a message (e.g., SL RRC reconfiguration message) indicating the one or more second SL RSs, e.g., among a plurality of second SL RSs, as the ones to monitor for the candidate beam identification. For example, the plurality of the first SL RSs may be same as the plurality of the second SL RSs. The second wireless device may determine a measurement quantity (e.g., RSRP) of each of the one or more second SL RSs. The second wireless device may determine a candidate beam (e.g., SL TCI, SL SRI, SL CSI RS) that is associated with a first SL RS of the one or more second SL RSs, e.g., if the measurement quantity (e.g., RSRP value) of the first SL RS of the one or more second SL RSs satisfies one or more second conditions (e.g., is higher than or equal to a RSRP threshold). The second wireless device may transmit a signal or message (e.g., SCI, MAC CE, and/or RRC message) comprising an identifier of the first SL RS, e.g., as a candidate beam or beam pair that the first wireless device and/or the second wireless device to switch to. For example, the identifier of the first SL RS may be an identifier of SL TCI, SL SRI associated with (or linked to) the first SL RS.

The beam failure recovery may be triggered when beam failure is detected and/or candidate beams are identified. For example, the first wireless device, that transmits (e.g., to the second wireless device) the one or more first SL RSs or one or more second SL RSs, may trigger the beam failure recovery. For example, the second wireless device, that receives (e.g., from the first wireless device) the one or more first SL RSs or one or more second SL RSs, may trigger the beam failure recovery. The beam failure recovery may comprise a transmission of a signal or message comprising the identifier of the first SL RS, e.g., as a candidate beam or beam pair that the first wireless device and/or the second wireless device to switch to.

In existing sidelink technologies, periodic RS for SL beam management may be necessary. For a UE monitoring the periodic RS transmitted by another UE for SL beam management, the periodic RS may be the source of Tx/Rx spatial filter for PSCCH/PSSCH/PSFCH transmissions/receptions for the UE, e.g., similar to Unified-TCI framework. The periodic RS for SL beam management may be the RS configured for unicast communication with the target UE (e.g., S-SSB for beam management, or SL CSI-RS). For example, a UE may transmit periodic RS for SL beam management towards a paired UE. The UE transmitting periodic RS for SL beam management may use the transmitted RS as the source of Tx/Rx spatial filter for these transmissions/receptions for the paired UE.

In sidelink mode 2 operation (e.g., out of coverage), a UE may perform resource sensing and selection. In a sidelink system, the mode 2 resource sensing/selection may be based on SCI format 1 and PSCCH/PSSCH DMRSs. For a sidelink system operating in high frequencies (e.g., FR2-SL), PSCCH/PSSCH transmissions may be beam-formed (e.g., directional) to compensate for the short coverage in those frequencies. In addition, resource sensing/selection may be based on a particular beam at the sensing UE. This may impact on reliability of mode 2 resource sensing/selection procedure, and may make the hidden node problem more severe in sidelink.

In sidelink mode 2 operation, UE can find candidate resources for its transmission by excluding reserved resources indicated by the received SCI from other UEs of which measured RSRP value is higher than a threshold. In this case, the UE can avoid high interference from other UE(s) and high interference to other UE(s). If PSCCH transmission/reception is Omni-direction, due to the lack of beam gain, the PSCCH coverage or detection performance may be limited. Moreover, using different TX spatial setting for PSCCH and PSSCH (e.g., if PSSCH is beam-formed but PSCCH is omni-directional), may not be desired due to the FDM and TDM structure of the two channels and the time required for beam change. Therefore, for better coverage, both PSCCH and PSSCH may be transmitted via beam-forming using a same Tx beam.

If the directional reception is applied to PSCCH reception, it is possible that the UE may not detect SCI(s) transmitted by other UE(s) around the UE, and it will cause the case where the UE selects its transmission resources overlapping with other UEs' reserved resources. Depending on the beam direction of TX UE's transmission and the location of destination UEs of other UE(s), the SL transmission may or may not cause high interference to other UEs.

In an example of existing technology, a first UE may have an upcoming transmission using a first Tx beam (e.g., based on a first TCI state or QCLed with a first SL RS). The first UE may perform sensing procedure for resource selection using a first Rx beam corresponding to the first Tx beam (e.g., the first RX beam may be based on a same TCI state or QCLed with the same SL RS). For example, the upcoming transmission may be associated with a unicast link to a second UE. For example, the first UE and the second UE may have established beam pairing and determined a beam pair for their unicast communication, e.g., the first Tx beam and the first Rx beam at the first UE. In an example, the first UE may determine the first Rx beam based on beam correspondence, e.g., beam correspondence between the first Tx beam and the first Rx beam. For the said sensing procedure, the first UE may use a first spatial Rx filter (Rx beam) to receive SCIs in the resource pool. However, referring to FIG. 24, there is no guarantee that the first UE can use the first spatial Rx filter (Rx beam) for sensing during all slots of the entire sensing window. For example, the first UE may use a second Rx spatial filter/beam in a slot within the sensing window, e.g., to receive a SL transmission from a third UE. For example, the first UE may have determined the second Rx beam for the unicast link with the third UE. As a result, the directional sensing results of the first UE may not be reliable and lead to collision.

In an example, the directional sensing may be more challenging if the sensing UE has a limited capability and is incapable of simultaneous transmitting or receiving PSCCH/PSSCH/PSFCH using different beams.

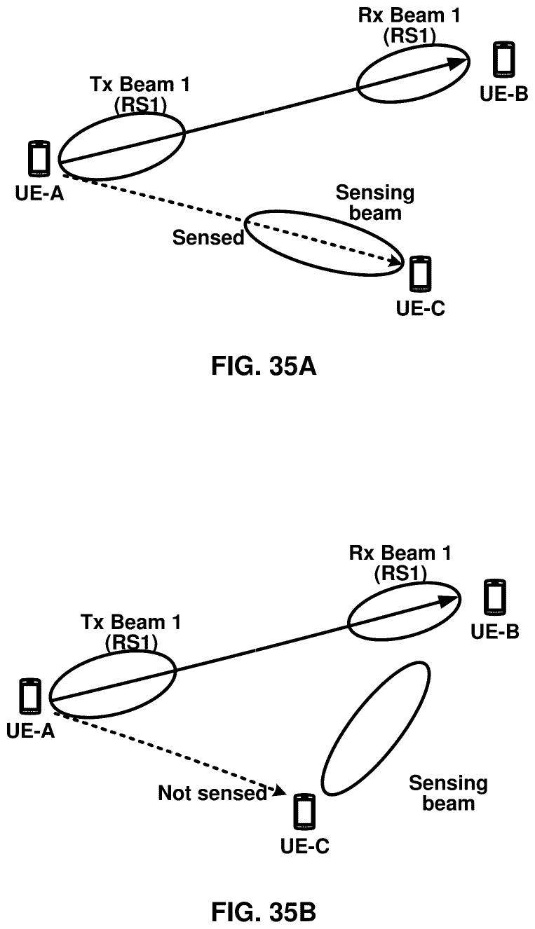

FIG. 35A and FIG. 35B show examples of directional/beam-formed sensing in sidelink. In FIG. 35A and FIG. 35B, UE-A transmits PSCCH/PSSCH to UE-B in a slot/RB, and UE-C performs sensing in the same slot/RB. All the three UEs use particular beams for Tx/Rx/sensing. In FIG. 35A, UE-C senses UE-A's transmission using a sensing beam that direct to UE-A and therefore, the UE-C takes this sensing result into account for resource selection. On the other hand, in FIG. 35B, UE-C uses sensing beam which is not directed to UE-A. In this case, UE-C may consider the resource is available as a result of sensing and may transmit on the resource using the beam corresponding to the sensing beam-causing resource collision for UE-B's reception.

In an example with directional sensing, the UE may switch RX spatial setting during the sensing window. For instance, during the sensing window, the UE may need to receive different unicast PSSCH from different UEs, and then the suitable RX spatial setting could be changed slot-by-slot. Meanwhile, UE can find candidate resources for its transmission with a certain TX spatial setting. In this case, the UE may use sensing results associated with RX spatial setting which covers TX beam corresponding to TX spatial setting for its resource (re) selection. In this case, the slot where the sensing results is not used may be treated as non-monitored slot.

For inter-UE coordination mechanism with directional transmission/reception, the RSRP measurements (PSCCH-RSRP or PSSCH-RSRP) used when excluding candidate resources from the preferred resource set or determining non-preferred resources based on overlapping resource reservations, may reflect the expected interference signal strength to be experienced during the beamformed PSCCH/PSSCH reception. Thus, such RSRP measurements may be performed using the RX beam to be used for the PSCCH/PSSCH reception. In this way, unnecessary exclusion of resources reserved by UEs located outside of the RX beam's receptive field may be avoided, thus increasing spatial reuse.

However, there is no guarantee that the sensing UE is using the same Rx beam in all slots of the sensing window. For example, due to other unicast links requiring a different Rx/Tx filter setting, the UE may change the beam in a certain slot and thus miss or fail to detect a SCI. The implementation of the existing technologies may result in the sensing UE missing directional SCI transmissions by other UEs that indicate resource reservations in the resource pool. As a result, the sensing results may not be complete in a spatial dimension, which may yield to increased interference and potential collisions throughout the sidelink network. For example, based on the existing technologies, the sensing UE may not be able to detect a directional SCI transmission indicating a reserved resource, and may not exclude that resource from the candidate resource set for resource selection, or from the preferred resource set, or may not determine the non-preferred resource set for inter-UE coordination mechanism successfully, or may not be able to detect conflicts on a mutually reserved resource. There is a need for enhancements in directional/beam-formed sensing which takes the spatial domain into account and provides more inclusive sensing results.

In the existing sidelink technologies, a conflict is detected by UE-A if two (or more) resource reservations for PSSCH transmission from two (or more) UEs overlap in time and frequency. The Rx/sensing UE (UE-A) detecting the conflict, will trigger Inter-UE Coordination (IUC) scheme 2 procedure to send the conflict indication via PSFCH to a deprioritized transmitter (UE-B) (that has a TB with lower priority and/or a TB for UE-A as a target destination). In the existing sidelink technologies, UE-A may determine resource conflict if RSRP of the deprioritized transmission is above a threshold (e.g., RSRP₂>Th(p₁, p₂), or if RSRP₂>RSRP₁+deltaRSRPThresh), e.g., if configured with a sidelink parameter enabling a conditional sensing (sl-OptionForCondition2-A-1). UE-A measures RSRP as follows: PSSCH-RSRP over the DM-RS resource elements for the PSSCH according to the received SCI format 1-A, e.g., if higher layer parameter sl-RS-ForSensing is set to ‘pssch’, and/or PSCCH-RSRP over the DM-RS resource elements for the PSCCH carrying the received SCI format 1-A if higher layer parameter sl-RS-ForSensing is set to ‘pscch’, where the PSSCH and PSCCH transmissions and receptions are via omni-directional beams.

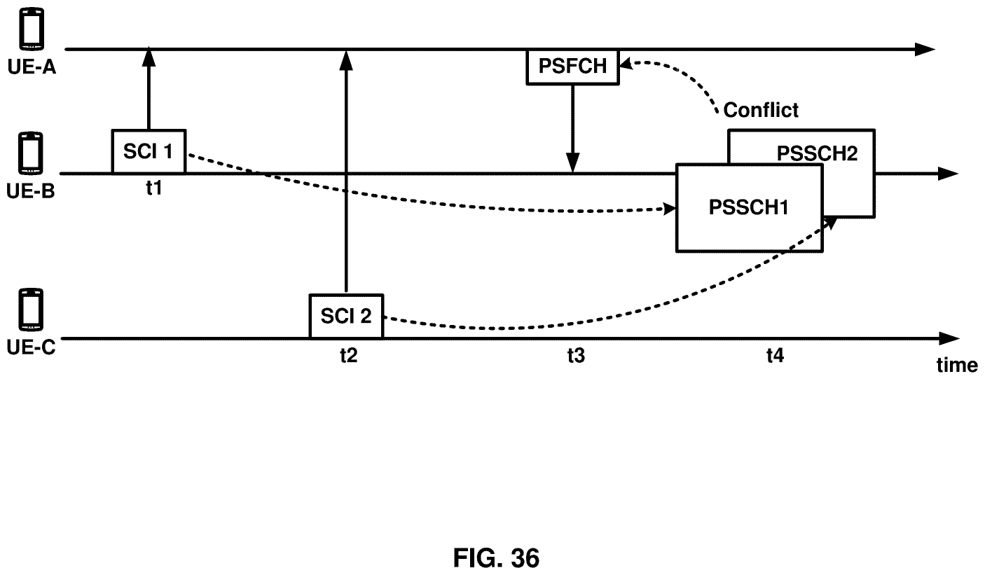

FIG. 36 illustrates an example of sidelink resource conflict based on omni-directional transmission and sensing as per an aspect of an embodiment of the present disclosure. As shown in this example, UE-A may receive a first SCI (SCI 1) from UE-B at time t1 (e.g., in slot t1). The first SCI may comprise a field indicting a first reserved resource, e.g., for a TB transmission via a PSSCH transmission occasion (PSSCH 1 in slot t4). The first SCI may indicate that UE-A is the target destination of the TB/PSSCH 1. UE-A may receive a second SCI (SCI 2) from UE-C at time t2 (e.g., in slot t2). The second SCI may comprise a field indicting a second reserved resource, e.g., for a TB transmission via a PSSCH transmission occasion (PSSCH 2 in slot t4). The second SCI may or may not indicate that UE-A is the target destination of the TB/PSSCH 2. UE-A may determine that the first reserved resource and the second reserved resource overlap in time and frequency. UE-A may determine that as a resource conflict. UE-A may determine that the reservation by UE-B has a lower priority than the reservation by UE-C. For example, the first SCI may comprise a field indicating a first priority value that is larger than (or equal to) a second priority value indicated by a filed in the second SCI. UE-A may determine that a RSRP measurement of/associated with the second SCI is higher than a threshold. UE-A may determine that a RSRP measurement of/associated with the second SCI is by a threshold higher than a RSRP measurement of/associated with the first SCI. UE-A may determine that the second PSSCH will collide/interfere with the first PSSCH. UE-A may determine to transmit a conflict indication, e.g., via a PSFCH transmission occasion in slot t3 (before t4), to UE-B. UE-B may drop/pre-empt the TB transmission via PSSCH 1 in response to the conflict indication.

In sidelink operation with beam-formed transmissions, the hidden node problem may be more severe, e.g., a hidden node may be in directions and/or locations that are undetectable via the sensing beam in use the Rx/sensing UE. As a result, the inter-UE coordination mechanisms may not work efficiently and properly anymore.

Based on the implementation of the existing technologies, it may not be clear what event would trigger a resource conflict indication (IUC scheme 2) in case of beamformed transmission/receptions. For example, what Rx beam(s)/spatial filter settings should be the basis for the conflict determination/trigger and/or for the RSRP measurements. For example, a UE may be incapable of simultaneous reception of PSCCH/PSSCH using different beams. For example, the UE may use one beam (one Rx spatial filter setting) for sensing and/or PSCCH reception at a given time/slot. The issue is that if the RSRP measurement and/or conflict determination is based on a certain first Rx beam only, there is no guarantee that the UE-A can detect conflicting reservations using the same first beam.

Similarly, even if the UE is capable of simultaneous reception of PSCCH/PSSCH using different beams, and the UE measures RSRP values on different Rx beams, for an accurate sensing result in spatial domain, those RSRP values from different directions should be taken into account as well, e.g., depending on the location/direction of the sensed transmission and/or based on the correlation between received signals via the different Rx beams. For example, the different Rx beams may be associated with the same TCI state or SL RS. For example, the different Rx beams may be QCLed. For example, due to hardware limitations, the signals received via the different Rx beams/filters may interfere with each other (e.g., power leakage between the antenna ports used for receiving those signals). The implementation of the existing technologies may fail to capture the spatial correlation between received signals via the different Rx beams.

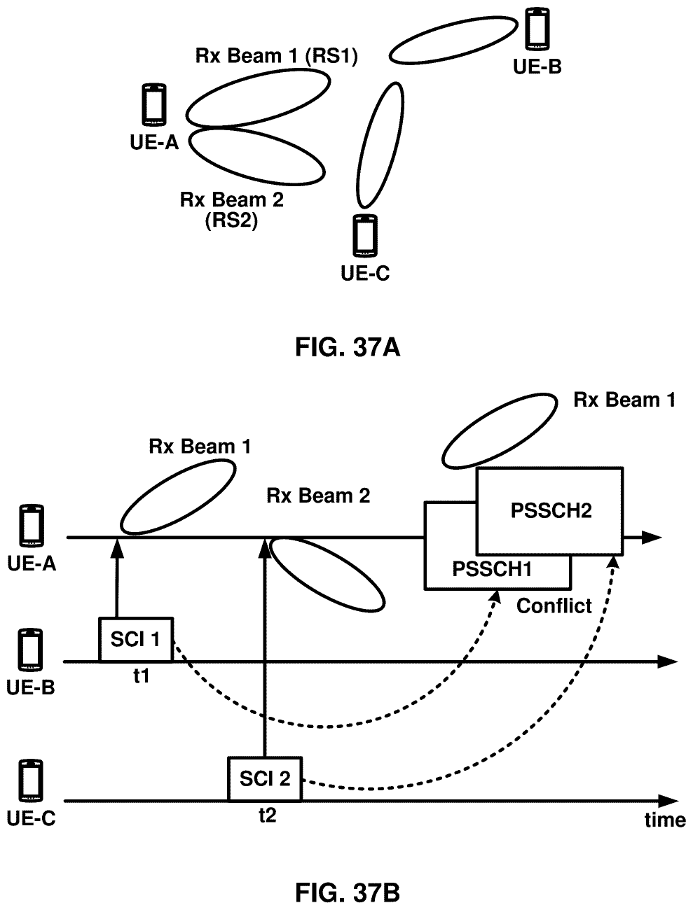

FIG. 37A and FIG. 37B illustrate examples of sidelink resource conflict based on directional (beam-formed) transmission and sensing as per an aspect of an embodiment of the present disclosure. In FIG. 37A, UE-A and UE-B have a unicast connection and determined a beam pair for their communications. For example, UE-A may determine to use Rx beam 1 (Rx filter 1 QCLed with SL RS 1) to receive UE-B's transmissions. As shown in FIG. 37B, UE-A may detect/receive a first SCI (SCI 1) from UE-B in slot t1 using Rx beam 1 (e.g., based on SL RS 1). The first SCI may indicate reception of PSSCH 1 for UE-A via a first reserved resource. As shown in FIG. 37A and FIG. 37B, UE-A may receive/detect a transmission (e.g., a second SCI, SCI 2) using Rx beam 2 (e.g., based on SL RS 2). For example, UE-A may receive the second SCI in the same slot as t1 (e.g., if capable of simultaneous reception using different Rx beams) or a different slot (e.g., t2 before t1 or after t1, e.g., if incapable of simultaneous reception using different Rx beams). For example, UE-A may apply the Rx beam 2 or Rx filter setting corresponding to a SL RS 2 (e.g., QCLed with the SL RS 2) at time t2, e.g., for reception/sensing associated with a second unicast link, and detect the second SCI. For example, the second SCI may indicate a second reserved resource, that overlaps in time and frequency with the first reserved resource. Based on the existing technologies, UE-A may not take the sensing result determined using Rx beam 2 into account for the reception via the first resource reservation using Rx beam 1. Consequently, UE-A may not be able to determine the resource conflict and trigger the conflict indication procedure (IUC scheme 2). Therefore, UE-B will transmit PSSCH1 via the first reserved resource and UE-C will transmit PSSCH2 via the second reserved resource overlapping with the first reserved resource. In an example, when UE-A receives PSSCH1 using Rx beam 1, UE-C's transmission of PSSCH2 may interfere with the received signal using Rx beam 1. In another example, UE-C's transmission of PSSCH2 may be detected on Rx beam 2, which may have some correlation with Rx beam 1. For example, a received signal using Rx beam 2 may leak some power and interfere with a simultaneously received signal using Rx beam 1. This interference may result in degradation of UE-A's reception of PSSCH1, e.g., depending on the UE-C's relative location and direction of UE-C's Tx beam with respect to UE-B's Tx beam and/or UE-A's Rx beam 1, and/or depending on the spatial correlation between UE-A's Rx beam 1 and Rx beam 2.

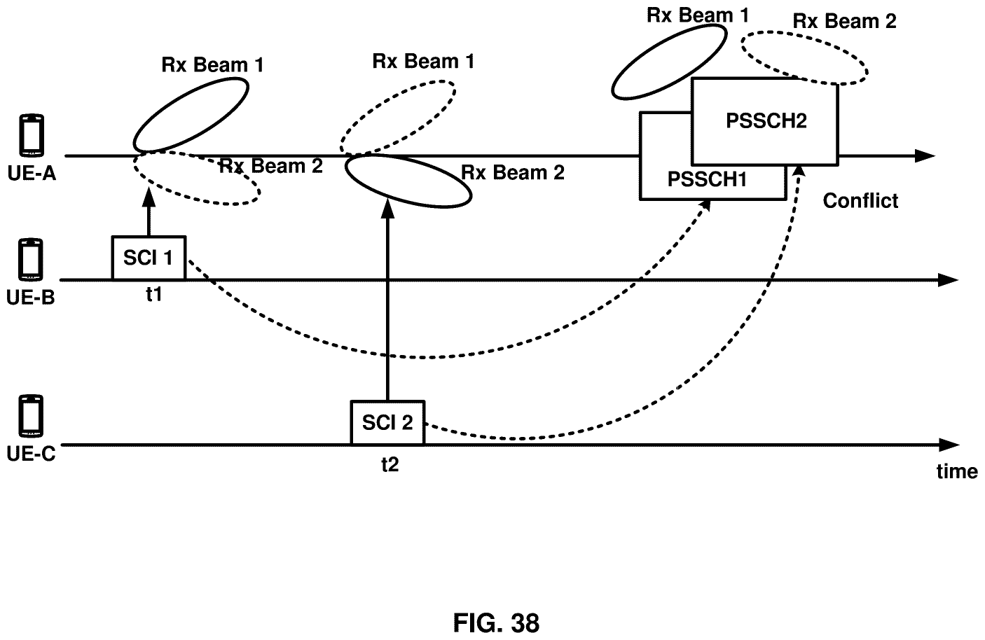

FIG. 38 illustrates an example of sidelink resource conflict based on directional (beam-formed) transmission and sensing as per an aspect of an embodiment of the present disclosure. In this example, UE-A may detect/receive a first SCI (SCI 1) from UE-B in slot t1 using Rx beam 1 (e.g., based on SL RS 1). The first SCI may indicate reception of PSSCH 1 for UE-A via a first reserved resource. UE-A may receive/detect a transmission (e.g., a second SCI, SCI 2) using Rx beam 2 (e.g., based on SL RS 2). For example, UE-A may apply the Rx beam 2 or Rx filter setting corresponding to a SL RS 2 (e.g., QCLed with the SL RS 2) at time t2, e.g., for reception/sensing associated with a second unicast link, and detect the second SCI. For example, the second SCI may indicate a second reserved resource, that overlaps in time and frequency with the first reserved resource. UE-A may not be target destination of PSSCH2. For example, the second may indicate a destination ID different from UE-A's destination ID. In an example, the beam configuration and indication may be a unicast link-specific information which cannot be decoded/determined by a non-destination sensing UE. For example, the second SCI may indicate a Tx/Rx beam for PSSCH2. Referring to FIG. 38, even if UE-A detects SCI 2 using Rx beam 2, and determines from SCI 2 that the second reservation overlaps in time and frequency with the first reservation, still cannot determine the Tx/Rx beam and the direction of PSSCH2 transmission. Thus, UE-A cannot determine whether there is a conflict in spatial domain between PSSCH1 and PSSCH2. More specifically, if UE-A is not a destination of the SCI 2, and if SCI 2 indicates a beam for the second reserved transmission, UE-A is not able to determine the direction of the second reserved transmission. Therefore, cannot determine if there is going to be any conflict or not.

Embodiments of the present disclosure are related to an approach for directional sensing for sidelink inter-UE coordination. These and other features of the present disclosure are described further below.

Embodiments of the present disclosure propose mechanisms for integrating the spatial domain correlation between sensing results using different Rx beams/filters for a comprehensive and accurate sensing result in sidelink with beamformed/directional transmission/reception and sensing. Embodiments enhance the directional sensing results by taking into account the QCL relationship between the signals received via different beams, and thus, reduce the hidden node issue by enabling a reliable inter-UE coordination mechanism.

In an example embodiment, a sensing/Rx UE determines conflict and/or preferred/non-preferred resources based on spatial domain overlap of reserved resources as well as time and frequency domains. In an example embodiment, the sensing/Rx UE may use one or more Rx beams/spatial filter settings to measure the RSRP of a SL RS of a received SCI that indicates the conflicting reservation. In an example embodiment, the sensing/Rx UE may use one or more Rx beams/spatial filter settings to measure the RSRPs of SCIs received in different directions that indicate conflicting reservation.

In an example embodiment, a sensing/Rx UE determines a resource conflict and/or preferred/non-preferred resources for a first TB/PSSCH by comparing RSRP measurement received using each Rx beam of a plurality of Rx beams against a respective threshold. In an example embodiment, the sensing/Rx UE may use a weighted RSRP measurement, comprising the RSRP measured using each of the plurality of Rx beams, to compare with a threshold for determining/triggering resource conflict and/or preferred/non-preferred resources.

In an example embodiment, RRC sidelink configurations may comprise parameter(s) indicating a threshold corresponding to each pair of Rx beam. For example, a value of RSRP threshold for a beam pair, th(b1,b2), may indicate the threshold to be used for RSRP measurement received using Rx beam 1 (b1) for determining the resulting interference for a transmission/reception using Tx/Rx beam 2 (b2).

Embodiments enable an indication of a beam/direction of a transmission via a reserved resource which helps the sensing UEs to determine potential overlaps/collisions/conflicts in spatial domain in addition to time/frequency domain.

Embodiments enable determination of a Tx beam/spatial filter/SL RS for transmission of a conflict information.

Example embodiments of the present disclosure may reduce collision rate in beam-formed/directional sidelink operation by providing enhancements for inter-UE coordination mechanisms (e.g., conflict indication and/or preferred/non-preferred resources).

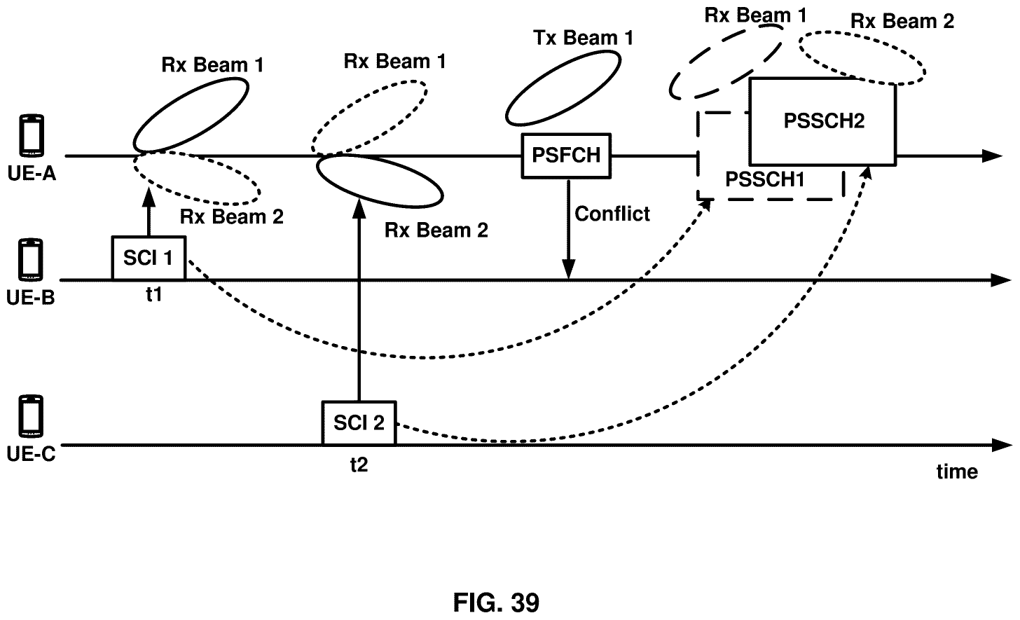

FIG. 39 illustrates an example of resource conflict indication with beam-formed sidelink transmission and reception as per an aspect of an embodiment of the present disclosure. UE-A and UE-B in FIG. 39 may establish a PC5 unicast link/connection. In an example, UE-A may receive one or more RRC messages (e.g., sidelink system information block or SIB12 and/or RRCReconfigurationSidelink) from the BS and/or UE-B comprising sidelink configuration parameters (e.g., SL-BWP-Config and/or SL-ResourcePool). In an example, UE-B may receive one or more RRC messages (e.g., sidelink system information block or SIB12 and/or RRCReconfigurationSidelink) from the BS and/or UE-A comprising sidelink configuration parameters (e.g., SL-BWP-Config and/or SL-ResourcePool). The sidelink configuration parameters may comprise configuration parameters of inter-UE coordination (IUC) mechanism (e.g., sl-InterUE-CoordinationConfig) for a sidelink resource pool (e.g., IUC scheme 2).

The configuration parameters of IUC may indicate whether IUC scheme 2 is enabled or not (e.g., via sl-IUC-Scheme2). In an embodiment, the configuration parameters of IUC may comprise a first parameter (e.g., sl-IUC-DirectionalSensing) indicate whether directional IUC scheme 2 is enabled in the resource pool or not. For example, a first value (e.g., 1 or “enabled”) of the first parameter may indicate that directional/beam-formed sensing and/or conflict indication is enabled. For example, UE-A/UE-B may use one or more Rx/Tx beams/filters, each based on a SL RS, for sensing and/or transmission of the conflict information if the first parameter indicates the first value. For example, a second value (e.g., 0 or “disabled”) of the first parameter may indicate that directional/beam-formed sensing and/or indication for conflict indication is disabled. For example, UE-A/UE-B may use an omni-direction Rx/Tx beam/filter for sensing and/or transmission of the conflict information.

In the example of FIG. 39, UE-A may receive one or more RRC messages (e.g., sidelink system information block or SIB12 and/or RRCReconfigurationSidelink) from the BS and/or UE-B comprising sidelink configuration parameters (e.g., SL-BWP-Config and/or SL-ResourcePool). In an example, UE-B may receive one or more RRC messages (e.g., sidelink system information block or SIB12 and/or RRCReconfigurationSidelink) from the BS and/or UE-A comprising sidelink configuration parameters (e.g., SL-BWP-Config and/or SL-ResourcePool). The sidelink configuration parameters may comprise configuration of the PC5 RRC connection (e.g., RRCReconfigurationSidelink), applied to the unicast sidelink communication between UE-A and UE-B. The sidelink configuration parameters may comprise configuration parameters of a plurality of SL reference signals, e.g., S-SSBs and/or SL CSI-RSs (e.g., sl-CSI-RS-Config). In an example, the plurality of SL reference signals may be transmitted from UE-B to UE-A. In an example, the plurality of SL reference signals may be transmitted from UE-A to UE-B.

The sidelink configuration parameters may comprise configuration parameters of beam management between UE-A and UE-B for the unicast sidelink communication (transmission and reception).

For example, the configuration parameters of beam management may indicate a plurality of TCI states for UE-A transmission to UE-B, e.g., a TCI state may indicate a Tx beam or a Tx spatial filter associated with a first SL RS of the unicast link. For example, the configuration parameters of beam management may indicate UE-A may use a first Tx beam/spatial filter to transmit a first signal/channel to UE-B, wherein the first Tx beam/spatial filter is QCLed with a first SL RS of the plurality of SL RSs. For example, the configuration parameters of beam management may indicate UE-A may use a first Tx beam/spatial filter for a transmission to UE-B, wherein the first Tx beam/spatial filter is associated with a first TCI state of the plurality of TCI states.

For example, the configuration parameters of beam management may indicate a plurality of TCI states for UE-A reception from UE-B, e.g., a TCI state may indicate a Rx beam or a Rx spatial filter associated with a first SL RS of the unicast link. For example, the configuration parameters of beam management may indicate UE-A may use a first Rx beam/spatial filter to receive a first signal/channel from UE-B, wherein the first Rx beam/spatial filter is QCLed with a first SL RS of the plurality of SL RSs. For example, the configuration parameters of beam management may indicate UE-A may use a first Rx beam/spatial filter for a reception from UE-B, wherein the first Rx beam/spatial filter is associated with a first TCI state of the plurality of TCI states.

In an example, based on a beam correspondence, the first Tx beam/spatial filter and the first Rx beam/spatial filter of UE-A may correspond to a same TCI state or SL RS. For example, UE-A may use same or significantly similar spatial filter setting for receiving using the first Rx beam/filter and transmitting using the first Tx beam/filter. For example, the first Rx beam/filter and the first Tx beam/filter may be associated/QCLed with a same (e.g., the first) SL RS.

UE-A and UE-B may perform initial beam pairing (e.g., beam sweeping, referring to FIG. 33A and FIG. 33B) and determine one or more preferred beam pairs for sidelink transmission and reception associated with the PC5 unicast link. A beam pair may comprise a first Tx beam at UE-A and a corresponding first Rx beam at UE-B. For example, UE-A may use the first Tx beam for a transmission of a signal/channel (e.g., a CSI-RS) to UE-B and UE-B may use the first Rx beam to receive the signal/channel transmitted by UE-A using the first Tx beam. Using the preferred beam pair may maximize the SINR. A beam pair may comprise a first Rx beam at UE-A and a corresponding first Tx beam at UE-B. For example, UE-B may use the first Tx beam for a transmission of a signal/channel (e.g., a CSI-RS) to UE-A and UE-A may use the first Rx beam to receive the signal/channel transmitted by UE-B using the first Tx beam.

For example, UE-A may determine the first Rx beam from a plurality of Rx beams configured for the unicast connection. For example, each Rx beam of the plurality of Rx beams may be associated with a respective SL RS (e.g., SL CSI-RS) and/or TCI state of the unicast connection. The first Rx beam may be associated with a first SL RS. For example, UE-A may use a same Rx spatial filter setting for receiving a signal/channel via the first Rx beam as the Rx spatial filter setting used for receiving the first SL RS (e.g., QCL relationship between the first SL RS and the first Rx beam). For example, UE-A may use a Rx spatial filter setting for receiving a signal/channel via the first Rx beam that corresponds to (e.g., based on beam correspondence) a Tx spatial filter setting used for transmitting the first SL RS.

For example, UE-A may determine the first Tx beam from a plurality of Tx beams configured for the unicast connection. For example, each Tx beam of the plurality of Tx beams may be associated with a respective SL RS (e.g., SL CSI-RS) and/or TCI state of the unicast connection. The first Tx beam may be associated with a first SL RS. For example, UE-A may use a same Tx spatial filter setting for transmitting a signal/channel via the first Tx beam as the Tx spatial filter setting used for transmitting the first SL RS (e.g., QCL relationship between the first SL RS and the first Tx beam). For example, UE-A may use a Tx spatial filter setting for transmitting a signal/channel via the first Tx beam that corresponds to (e.g., based on beam correspondence) a Rx spatial filter setting used for receiving the first SL RS.

In an example, UE-A may determine a first beam pair (e.g., the first Rx/Tx beam/spatial filter) semi-statically. For example, UE-A may receive a message (e.g., RRC message) and/or signal (e.g., a MAC-CE or DCI or SCI) from UE-B or the BS that indicates the first beam pair and/or the first Rx/Tx beam as preferred or active beam(s). For example, UE-A may receive a signal (e.g., a MAC-CE or SCI or DCI) from the BS or from UE-B indicating activation of a first TCI state corresponding to the first beam pair or the first Rx/Tx beam. For example, UE-A may determine the first beam pair and/or the first Rx/Tx beam as preferred or active beam(s) based on one or more measurements (e.g., L1 measurement based on a SL RS QCLed with the first Rx/Tx beam). In an embodiment, UE-A may keep using the first beam pair and/or the first Rx/Tx beam/spatial filter for communication to UE-B (e.g., for the PC5 unicast link), e.g., in response to an activation command and/or until a deactivation command is received from the BS or UE-B and/or until a beam maintenance timer is expired and/or until a condition (e.g., a BFD condition) is met and/or until a beam switch command/indication is received from the BS or UE-B.

In an example, UE-A may determine a first beam pair (e.g., the first Rx/Tx beam/spatial filter) dynamically, e.g., for one or more upcoming transmission/receptions. For example, UE-A may receive signal (e.g., DCI or SCI) from UE-B or the BS that indicates the first beam pair and/or the first Rx/Tx beam to be used for the one or more upcoming transmission/receptions.

Referring to FIG. 39, UE-A may determine the first Rx/Tx beam for transmission/reception corresponding to the PC5 unicast link with UE-B. For example, the first Rx beam may correspond to the first Tx beam (based on beam correspondence). For example, the first Rx beam and the first Tx beam may be associated (e.g., QCLed) with a first SL RS.

As shown in FIG. 39, UE-A may configure/employ two or more spatial filters for unicast communications (e.g., comprising the PC5 unicast connection with UE-B). For example, UE-A may determine a first Tx/Rx beam (Tx Beam 1 and Rx Beam 1) and a second Tx/Rx beam (Tx Beam 2 and Rx Beam 2) for unicast transmissions and receptions (e.g., including to/from UE-B). The first Tx/Rx beam may be associated with a first TCI state and/or a first SL RS. The second Tx/Rx beam may be associated with a second TCI state and/or a second SL RS.

UE-A may determine to use the first Tx/Rx beam for transmission to and reception from UE-B. For example, UE-A may determine to activate a first beam pair comprising the first Tx/Rx beam for the first unicast link (the PC5 unicast link with UE-B). For example, UE-A may determine to activate a first TCI state in response to a measurement result and/or in response to receiving a command (e.g., via MAC-CE and/or DCI and/pr SCI) indicating activation of the first TCI state.

Referring to FIG. 39, UE-A may receive a first SCI (SCI 1, e.g., SCI format 1-A and/or SCI format 2-A or 2-B or 2-C) form UE-B in time/slot t1. The first SCI may be associated with a first SL RS (e.g., S-SSB or CSI-RS). For example, UE-A may receive the first SCI based on the first SL RS. UE-A may use a first Rx beam/spatial filter for receiving the first SCI. The first Rx beam/spatial filter may be associated with (e.g., QCLed with) the first SL RS.

The first SCI may comprise one or more fields (e.g., frequency resource assignment, time resource assignment, and/or resource reservation period) indicating a first reserved resource for transmission of a first TB via a first PSSCH (PSSCH 1 in FIG. 39). The first SCI may comprise a priority field indicating a L1 priority value (p1) of the first TB. The first SCI may indicate (e.g., by indicating a second stage SCI comprising a field) a source ID and a destination ID of the first TB transmission via the reserved resource. For example, the destination ID may match UE-A's destination ID of the first unicast link with UE-B (source UE).

The first SCI may indicate a slot and one or more RBs for the first reserved resource in time and frequency domain. The first SCI may indicate a TCI state and/or SL RS and/or Rx beam index for reception of the first TB via the first reserved resource in spatial domain.

In an example, UE-A may determine the first Rx beam/filter or the first TCI state or the first SL RS for reception of the first PSSCH, e.g., based on the first Rx beam/filter/TCI state being active (e.g., as part of a first active/preferred beam pair). In an example, UE-A may determine the first Rx beam/filter or the first TCI state or the first SL RS for reception of the first PSSCH, e.g., based on the first SCI indicating the first Rx beam/filter or the first TCI state or the first SL RS for reception of the first PSSCH. For example, the first SCI may comprise a field indicating an index of the Rx/Tx beam corresponding to the first PSSCH (the reserved resource). For example, the first SCI may comprise a field indicating an index of the first RS corresponding to the first PSSCH (the reserved resource). For example, the first SCI may comprise a field indicating a TCI state ID indicating the first TCI state corresponding to the first PSSCH (the reserved resource). In an example, UE-A may receive the first SCI using a second Rx beam/spatial filter, e.g., based on a second SL RS. In an example, UE-A may determine the first Rx beam/filter or the first SL RS or the first TCI state for reception of the first PSSCH based on the first SCI indication (e.g., by the field in the SCI or implicit indication).

In an example, UE-A may have a second PC5 unicast connection with a third UE (e.g., UE-C in FIG. 39 or a UE-D). UE-A may determine to use the second Rx beam/filter for receiving signals and channels from the third UE. The second Rx beam/filter may be associated with a second SL RS. For example, UE-A may sense slots of the resource pool for detecting SCIs from the third UE based on the second SL RS, e.g., using the second Rx beam/filter.

In an embodiment shown in FIG. 39, UE-A may use the second Rx beam (Rx Beam 2) in time/slot t2 for sensing. For example, UE-A may determine to use the second Rx beam (Rx Beam 2) in time/slot t2 to receive a signal/channel from the third UE. For example, UE-A may determine that the third UE may transmit the signal/channel to UE-A in time/slot t2.

In an example, UE-A may be incapable of simultaneous receptions using multiple Rx beams. For example, UE-A may transmit a message comprising sidelink capability or assistance information to the BS or UE-B. The sidelink capability or assistance information may comprise a parameter indicating that UE-A is incapable of simultaneous sidelink receptions using multiple Rx beams. For example, UE-A may use Rx beam 1 in slot t1 and may change the beam to use Rx beam 2 in slot t2, e.g., due to limited hardware capability for simultaneous reception.

In an embodiment, UE-A may determine periodic cycles for sensing using each of the Rx beam within a time window and/or a frequency range, e.g., a periodic beam change/switch based on a pre-defined/configured pattern (e.g., referred to as periodic beam-formed sensing or the like) and/or a pattern activated by a MAC-CE/SCI/DCI. For example, during a first time interval (e.g., one or more slots and/or one or more symbols) UE-A may determine to use Rx beam 1 for sensing. The first time interval may be followed by a second time interval. For example, during the second time interval (e.g., one or more slots and/or one or more symbols) UE-A may determine to use Rx beam 2 for sensing, and so on. For example, the time intervals may be repeating periodically throughout the resource pool. In an example, UE-A may determine to use Rx beam 1 for sensing a first portion of RBs of the resource pool. In an example, UE-A may determine to use Rx beam 2 for sensing a second portion of RBs of the resource pool. For example, the first RBs and the second RBs may be disjoint. In an example, in response to the UE capability/assistance information indicating that UE-A is incapable of simultaneous reception using multiple beams, the BS/UE-B/UE-A may configure periodic beam-formed sensing for UE-A.

In an example, UE-A may be capable of simultaneous receptions using multiple Rx beams. For example, UE-A may transmit a message comprising sidelink capability or assistance information to the BS or UE-B. The sidelink capability or assistance information may comprise a parameter indicating that UE-A is capable of simultaneous sidelink receptions using multiple Rx beams. For example, UE-A may use Rx beam 1 and Rx beam 2 in slot t1 and slot t2.

As shown in FIG. 39, UE-A may detect/receive a second SCI (e.g., from UE-C, which may or may not be the third UE). UE-A may receive the second SCI using the second Rx beam/filter (Rx beam 2), e.g., in slot t2. In an example, slot t2 may be the same as slot t1 (e.g., if UE-A is capable of simultaneous reception using multiple beams). In an example, slot t2 may be before or after slot t1. UE-A may receive the second SCI based on the second SL RS.

The second SCI may comprise one or more fields (e.g., frequency resource assignment, time resource assignment, and/or resource reservation period) indicating a second reserved resource for transmission of a second TB via a second PSSCH (PSSCH 2 in FIG. 39). The second SCI may comprise a priority field indicating a L1 priority value (p2) of the second TB. The second SCI may indicate (e.g., by indicating a second stage SCI comprising a field) a source ID and a destination ID of the second TB transmission via the reserved resource. For example, the destination ID may or may not match UE-A's destination ID.

The second SCI may indicate a slot and one or more RBs for the second reserved resource in time and frequency domain. The second SCI may indicate a TCI state and/or SL RS and/or Rx beam index for reception of the first TB via the first reserved resource in spatial domain. In an example, if the destination ID in the second SCI matches UE-A's destination ID, it can decode and determine the unicast information in the second SCI including the TCI state and/or SL RS and/or Rx beam index. In an example, if the destination ID in the second SCI does not match UE-A's destination ID, it cannot decode and determine the unicast information in the second SCI including the TCI state and/or SL RS and/or Rx beam index. For example, UE-A may not be able to determine the direction of UE-C's transmission of the second PSSCH.

In an example, UE-A may assume/determine that UE-C transmits the second PSSCH using the same Tx beam as the second SCI, e.g., if RRC configurations of the sidelink resource pool indicate semi-static beam-forming/beam management. For example, UE-A may determine that UE-C transmits the second PSSCH using the same beam as the second SCI, e.g., if the second SCI comprises a field (e.g., a flag) indicating a value that represents same Tx beam/direction for the reserved transmission is maintained as the second SCI (e.g., in case of dynamic beam-forming). For example, UE-C may transmit the second SCI using a third Tx beam and/or based on a third SL RS. If the field in the SCI indicates a first value (e.g., 0) UE-A may determine that UE-C will transmit the second PSSCH using the third Tx beam and/or based on the third SL RS. If the field in the SCI indicates a second value (e.g., 1) UE-A may determine that UE-C will not transmit the second PSSCH using the third Tx beam and/or based on the third SL RS, e.g., UE-C may transmit the second PSSCH using a fourth Tx beam and/or based on a fourth SL RS. In an example, RRC configuration of the sidelink resource pool may indicate whether the second SCI comprises the field or not. For example, if the RRC configuration of the sidelink resource pool indicates that the second SCI does not comprise the field, UE-A may determine same transmission direction for the second SCI and the second PSSCH reserved by the second SCI.

Thus, UE-A may determine the direction of the second PSSCH transmission by UE-C based on the second SCI. In an example, if UE-A received the second SCI using the second Rx beam/filter and/or based on the second TCI state or SL RS, it may determine/expect that the second PSSCH transmission will be also received using the second Rx beam/filter and/or based on the second TCI state or SL RS.

Referring to FIG. 39, UE-A may determine that the first reserved resource for PSSCH 1 indicated by the first SCI overlaps in time and frequency with the second reserved resource for PSSCH 2 indicated by the second SCI. In an embodiment, UE-A may determine a resource conflict based on the first reserved resource overlapping with the second reserved resource in time and frequency and spatial domain. For example, UE-A may determine whether the first reserved resource overlaps with the second reserved resource in the spatial domain based on the Rx beams(s)/filter(s) used for receiving the first SCI and the second SCI. For example, UE-A may determine spatial domain overlap if the first Rx beam is the same as the second Rx beam. In an embodiment, UE-A may determine spatial domain overlap if the first Rx beam and the second Rx beam are associated with a same SL RS (e.g., a wide beam, S-SSB or SL CSI-RS). In an embodiment, UE-A may determine spatial domain overlap if the first Rx beam and the second Rx beam are associated with a same TCI state.

For example, the first SL RS and the second SL RS may be QCLed with respect to a first type (e.g., typeA or typeB or typeC or typeD). In an embodiment, UE-A may determine a resource conflict between the first reserved resource and the second reserved resource, e.g., if the first SL RS and the second SL RS are QCLed. For example, the first SL RS may be a first CSI-RS and the second SL RS may be a second CSI-RS. The first CSI-RS and the second CSI-RS may be associated/QCLed with a first S-SSB. For example, UE-A may determine a resource conflict between the first reserved resource and the second reserved resource, e.g., if the first TCI state of the first SL RS and the second TCI state of the second SL RS are QCLed (e.g., associated with the same SL RS). For example, the sidelink configuration of the unicast link may indicate that the first SL RS and the second SL RS are QCLed with respect to the first type. For example, the sidelink configuration of the unicast link may indicate that the first TCI state and the second TCI state are QCLed with respect to the first type and/or are associated with the same SL RS.

In an example, the power received using the first Rx beam/filter based on the first RS may impact/interfere with the power received using the second Rx beam/filter based on the second RS. For example, if the first SL RS or TCI state and the second SL RS or TCI state are QCLed with respect to a first type (e.g., based on Doppler shift, Doppler spread, average delay, and/or delay spread), the signals received via the first Rx beam/filter (which is based on the first SL RS/TCI state) and the second Rx beam/filter (which is based on the second SL RS/TCI state) may be correlated. Embodiments enable capturing the spatial correlation between signals received using different Rx beams towards a reliable sensing mechanism in the presence of beam-formed transmission/receptions.

Referring to FIG. 39, in an embodiment, UE-A may determine a resource conflict between the first reserved resource for PSSCH 1 and the second reserved resource for PSSCH 2, based on the first SCI and the second SCI. For example, UE-A may determine the resource conflict if the first SCI and the second SCI are received using a same Rx beam/filter. For example, UE-A may determine the resource conflict if the first SCI and the second SCI are received using QCLed Rx beams/filters. For example, UE-A may determine the resource conflict if the first SCI and the second SCI are received using Rx beams/filters that are associated with the same SL RS. For example, UE-A may determine the resource conflict if the first SCI and the second SCI are received using Rx beams/filters that are associated with the same TCI state. For example, UE-A may determine the resource conflict if the first SL RS and the second SL RS are QCLed with respect to the first type. For example, UE-A may determine the resource conflict if the first SL RS and the second SL RS are correlated (e.g., RRC sidelink configurations may indicate a correlation factor (e.g., between 0 and 1) between the first SL RS and the second SL RS). For example, UE-A may determine the resource conflict if the correlation factor between the first SL RS and the second SL RS is greater than 0 or a threshold. For example, UE-A may determine the resource conflict if the first Rx beam/filter and the second Rx beam/filter are correlated (e.g., UE-A may determine the correlation factor between the two Rx beams/filters, e.g., based on implementation). For example, UE-A may determine the resource conflict if the correlation factor between the first Rx beam and the second Rx beam is greater than 0 or a threshold.

In an embodiment, UE-A may determine a resource conflict if the first Rx beam/RS associated with the first reserved resource is the same and/or QCLed and/or correlated with the second Rx beam/RS associated with the second reserved resource. For example, the first SCI and/or a MAC-CE/RRC message from BS or UE-B may indicate the first Rx beam/RS associated with the first reserved resource, e.g., for reception of the first TB via the first PSSCH. UE-A may determine the second Rx beam/RS associated with the second reserved resource based on the second SCI, e.g., based on the second Rx beam/RS used for receiving the second SCI and/or based on the second SCI comprising a field indicating using same Tx beam for the second PSSCH transmission and/or based on the second reserved resource being within a time interval associated with periodic beam-formed sensing using the second Rx beam/RS.

In an embodiment, UE-A may not determine a resource conflict if the first Rx beam/RS associated with the first reserved resource is not the same and/or QCLed and/or correlated with the second Rx beam/RS associated with the second reserved resource. For example, the first reserved resource and the second reserved resource may overlap in time and frequency, but not in spatial domain (e.g., uncorrelated directions), and thus, may not interfere with each other.

UE-A may determine to transmit a conflict information to UE-B, e.g., based on the first SCI indicating a destination ID matching UE-A's destination ID and/or based on the first priority of the first SCI/PSSCH being lower than or equal to a second priority of the second SCI/PSSCH (e.g., p1>=p2). UE-A may transmit the conflict indication to UE-B via a PSFCH transmission occasion, e.g., before the start of the first reserved resource. The PSFCH transmission occasion may be associated with the source ID of UE-B and/or destination ID of UE-A (indicated by the first SCI).

In an embodiment, UE-A may use a first Tx beam/spatial filter for transmission of the conflict information to UE-B. For example, the first Tx beam/filter may be associated with the first SL RS or the first TCI state (e.g., unified TCI state). For example, the first Tx beam/filter may correspond to the first Rx beam/filter (e.g., based on the beam correspondence). In an embodiment, UE-A may determine the Tx beam/Rs for transmission of the conflict information based on a Rx beam used for receiving the first SCI indicating the conflicting resource reservation. In an embodiment, UE-A may determine the Tx beam/Rs for transmission of the conflict information based on a Rx beam indicated (e.g., by the first SCI) for reception of the first PSSCH/TB via the first reserved resource.

In an embodiment, RRC configurations of the sidelink resource pool may indicate a RSRP condition for conflict (IUC scheme 2). For example, the RRC configurations may comprise a parameter indicating a value of a RSRP threshold for determining a resource conflict. In an embodiment, the RRC configurations may comprise a list/table/matrix of RSRP thresholds for IUC (e.g., scheme 1 or scheme 2). For example, the list/table/matrix may comprise a plurality of RSRP thresholds, each RSRP threshold corresponding to a pair of beams. For example, for IUC scheme 2 (conflict determination), each RSRP threshold may correspond to a pair of Rx beams/filters or SL RSs or TCI states. For example, a first RSRP threshold may indicate a value of RSRP threshold associated with a first beam/Rs/RVI state pair comprising a first Rx beam/RS/TCI state and a second Rx beam/RS/TCI state. For example, the first Rx beam/RS/TCI state may be the Rx beam/RS/TCI state used for/associated with a first SCI reception (e.g., the first SCI in FIG. 39), which indicates a PSSCH reception for UE-A. The second Rx beam/RS/TCI state may be the Rx beam/RS/TCI state used for/associated with a second SCI reception (e.g., the second SCI in FIG. 39), which indicates conflicting/overlapping resource reservation with the PSSCH reception for UE-A. In an embodiment, UE-A may use the first RSRP threshold to determine whether the second SCI received using the second Rx beam/RS/TCI state overlaps/interfere with the first PSSCH reception using the first Rx beam/RS/TCI state in spatial domain or not. For example, UE-A may determine a resource conflict if the RSRP of the second SCI is higher than the first RSRP threshold. For example, UE-A may not determine a resource conflict if the RSRP of the second SCI is lower than the first RSRP threshold.

In an example, the list/table/matrix may comprise a second RSRP threshold corresponding to a second Rx beam pair comprising the first Rx beam and a third Rx beam. In an example, UE-A may receive a third SCI using the third Rx beam. In an example, UE-A may determine a resource conflict if the RSRP of the third SCI is higher than the second RSRP threshold. For example, UE-A may not determine a resource conflict if the RSRP of the third SCI is lower than the second threshold.

In an example, the list/table/matrix may comprise a third RSRP threshold corresponding to the first Rx beam (e.g., the primary beam). In an example, UE-A may receive a fourth SCI using the first Rx beam. In an example, UE-A may determine a resource conflict if the RSRP of the fourth SCI is higher than the third RSRP threshold. For example, UE-A may not determine a resource conflict if the RSRP of the fourth SCI is lower than the third threshold.

In an example, RRC configurations of the resource pool may indicate the third RSRP threshold (e.g., corresponding to the first/primary beam to be used for the reserved reception). In an embodiment, UE-A may determine the first RSRP threshold and the second RSRP threshold based on the third RSRP threshold, e.g., by applying/multiplying/adding a scaling factor (e.g., a respective scaling factor for each of the other Rx beams). The scaling factor may be predefined (e.g., based on a number/configuration of Rx beams/SL RSs/TCI states). In an embodiment, the RRC configuration may indicate the scaling factor(s) for each of other Rx beams. The scaling factor may be proportional to a spatial correlation between the two Rx beams/RSs (e.g., 0 may mean no correlation→no interference, and 1 may mean full correlation→same RSRP threshold to measuring the interference). In an embodiment, UE-A may determine the scaling factor for each of the sensing/Rx beams by implementation, e.g., based on hardware and configuration. For example, UE-A may report the scaling factors for the respective beam pairs via UE SL capability/assistance information to UE-B and/or BS. A beam pair here may comprise a first Rx beam (e.g., the Rx beam/RS used for receiving a TB via the reserved resource targeting UE-A as the target destination) and a second sensing beam (e.g., the Rx beam/RS used for sensing/detecting a SCI indicating a conflicting resource reservation).

In response to receiving the conflict information, UE-B may not transmit the first PSSCH and the collision may be avoided by incorporating spatial domain overlap of interfering transmissions.

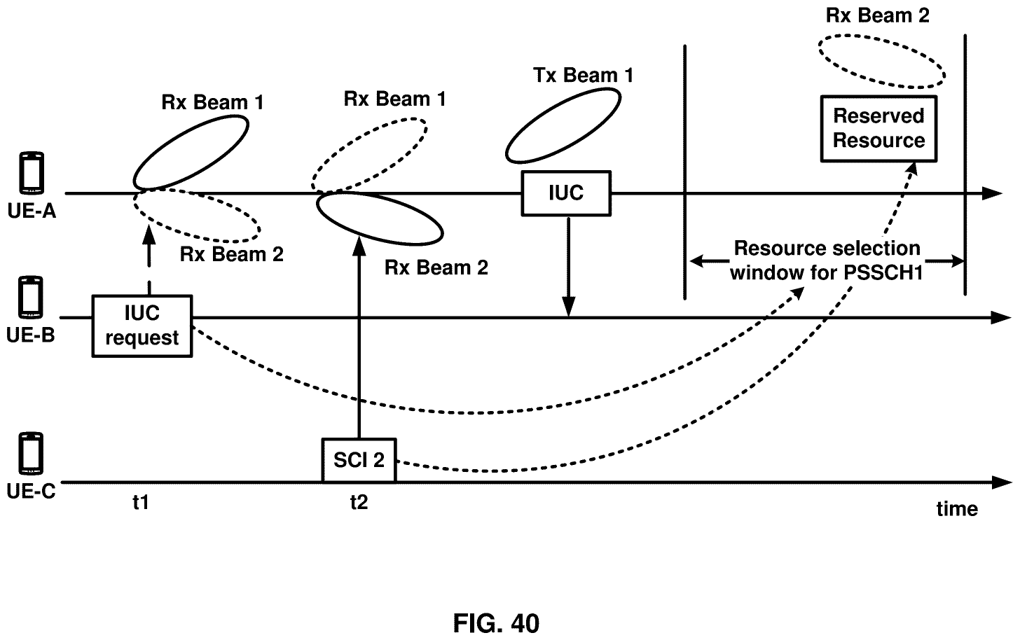

FIG. 40 illustrates an example of preferred/non-preferred resource indication with beam-formed sidelink transmission and reception as per an aspect of an embodiment of the present disclosure. UE-A and UE-B in FIG. 40 may establish a PC5 unicast link/connection. In an example, UE-A may receive one or more RRC messages (e.g., sidelink system information block or SIB12 and/or

RRCReconfigurationSidelink) from the BS and/or UE-B comprising sidelink configuration parameters (e.g., SL-BWP-Config and/or SL-ResourcePool). In an example, UE-B may receive one or more RRC messages (e.g., sidelink system information block or SIB12 and/or RRCReconfigurationSidelink) from the BS and/or UE-A comprising sidelink configuration parameters (e.g., SL-BWP-Config and/or SL-ResourcePool). The sidelink configuration parameters may comprise configuration parameters of inter-UE coordination (IUC) mechanism (e.g., sl-InterUE-CoordinationConfig) for a sidelink resource pool (e.g., IUC scheme 1).

The configuration parameters of IUC may indicate whether IUC scheme 1 is enabled or not. In an embodiment, the configuration parameters of IUC may comprise a first parameter (e.g., sl-IUC-DirectionalSensing) indicate whether directional IUC scheme 1 is enabled in the resource pool or not. For example, a first value (e.g., 1 or “enabled”) of the first parameter may indicate that directional/beam-formed sensing and/or indication for preferred/non-preferred resource set is enabled. For example, UE-A/UE-B may use one or more Rx/Tx beams/filters, each based on a SL RS, for sensing and/or transmission of the (non-) preferred resources if the first parameter indicates the first value. For example, a second value (e.g., 0 or “disabled”) of the first parameter may indicate that directional/beam-formed sensing and/or indication for preferred/non-preferred resource set is disabled. For example, UE-A/UE-B may use an omni-direction Rx/Tx beam/filter for sensing and/or transmission of the (non-) preferred resources.

Referring to FIG. 40, UE-A may determine the first Rx/Tx beam for transmission/reception corresponding to the PC5 unicast link with UE-B. For example, the first Rx beam may correspond to the first Tx beam (based on beam correspondence). For example, the first Rx beam and the first Tx beam may be associated (e.g., QCLed) with a first SL RS.

As shown in FIG. 40, UE-A may configure/employ two or more spatial filters for unicast communications (e.g., comprising the PC5 unicast connection with UE-B). For example, UE-A may determine a first Tx/Rx beam (Tx Beam 1 and Rx Beam 1) and a second Tx/Rx beam (Tx Beam 2 and Rx Beam 2) for unicast transmissions and receptions (e.g., including to/from UE-B). The first Tx/Rx beam may be associated with a first TCI state and/or a first SL RS. The second Tx/Rx beam may be associated with a second TCI state and/or a second SL RS.

UE-A may determine to use the first Tx/Rx beam for transmission to and reception from UE-B. For example, UE-A may determine to activate a first beam pair comprising the first Tx/Rx beam for the first unicast link (the PC5 unicast link with UE-B). For example, UE-A may determine to activate a first TCI state in response to a measurement result and/or in response to receiving a command (e.g., via MAC-CE and/or DCI and/pr SCI) indicating activation of the first TCI state.

Referring to FIG. 40, UE-A may receive a first SCI (SCI 1, e.g., SCI format 1-A and/or SCI format 2-A or 2-B or 2-C) form UE-B in time/slot t1. The first SCI may be associated with a first SL RS (e.g., S-SSB or CSI-RS). For example, UE-A may receive the first SCI based on the first SL RS. UE-A may use a first Rx beam/spatial filter for receiving the first SCI. The first Rx beam/spatial filter may be associated with (e.g., QCLed with) the first SL RS.

The first SCI (e.g., SCI format 2-C) may comprise one or more fields (e.g., frequency resource assignment, time resource assignment, and/or resource reservation period) indicating a request for IUC information for a transmission of a first PSSCH (PSSCH1) comprising a first TB to UE-A (e.g., IUC request, e.g., a providing/requesting indicator field in the first SCI may indicate value 1 indicating SCI format 2-C is used for requesting inter-UE coordination information). The first SCI may comprise a priority field indicating a L1 priority value (p1) of the first TB. The first SCI may indicate (e.g., by indicating a second stage SCI comprising a field) a source ID and a destination ID of the first TB transmission via the reserved resource. For example, the destination ID may match UE-A's destination ID of the first unicast link with UE-B (source UE). The first SCI may comprise a field indicating a resource set type, e.g., value 0 may indicate a request for inter-UE coordination information providing preferred resource set and value 1 may indicate a request for inter-UE coordination information providing non-preferred resource set. The first SCI may comprise a field indicating a resource selection window location (as shown in FIG. 40), indicating a window/time interval for the requested preferred/non-preferred resource set.

In an example, UE-A may determine the first Rx beam/filter or the first TCI state or the first SL RS for reception of the first PSSCH, e.g., based on the first Rx beam/filter/TCI state being active (e.g., as part of a first active/preferred beam pair). In an example, UE-A may determine the first Rx beam/filter or the first TCI state or the first SL RS for reception of the first PSSCH, e.g., based on the first SCI indicating the first Rx beam/filter or the first TCI state or the first SL RS for reception of the first PSSCH. For example, the first SCI may comprise a field indicating an index of the Rx/Tx beam corresponding to the first PSSCH (the reserved resource). For example, the first SCI may comprise a field indicating an index of the first RS corresponding to the first PSSCH (the reserved resource). For example, the first SCI may comprise a field indicating a TCI state ID indicating the first TCI state corresponding to the first PSSCH (the reserved resource). In an example, UE-A may receive the first SCI using a second Rx beam/spatial filter, e.g., based on a second SL RS. In an example, UE-A may determine the first Rx beam/filter or the first SL RS or the first TCI state for reception of the first PSSCH based on the first SCI indication (e.g., by the field in the SCI or implicit indication).

In an example, UE-A may have a second PC5 unicast connection with a third UE (e.g., UE-C in FIG. 40 or a UE-D). UE-A may determine to use the second Rx beam/filter for receiving signals and channels from the third UE. The second Rx beam/filter may be associated with a second SL RS. For example, UE-A may sense slots of the resource pool for detecting SCIs from the third UE based on the second SL RS, e.g., using the second Rx beam/filter.

In an embodiment shown in FIG. 40, UE-A may use the second Rx beam (Rx Beam 2) in time/slot t2 for sensing. For example, UE-A may determine to use the second Rx beam (Rx Beam 2) in time/slot t2 to receive a signal/channel from the third UE. For example, UE-A may determine that the third UE may transmit the signal/channel to UE-A in time/slot t2.

In an example, UE-A may be incapable of simultaneous receptions using multiple Rx beams. For example, UE-A may transmit a message comprising sidelink capability or assistance information to the BS or UE-B. The sidelink capability or assistance information may comprise a parameter indicating that UE-A is incapable of simultaneous sidelink receptions using multiple Rx beams. For example, UE-A may use Rx beam 1 in slot t1 and may change the beam to use Rx beam 2 in slot t2, e.g., due to limited hardware capability for simultaneous reception.

In an embodiment, UE-A may determine periodic cycles for sensing using each of the Rx beam within a time window and/or a frequency range, e.g., a periodic beam change/switch based on a pre-defined/configured pattern (e.g., referred to as periodic beam-formed sensing or the like) and/or a pattern activated by a MAC-CE/SCI/DCI. For example, during a first time interval (e.g., one or more slots and/or one or more symbols) UE-A may determine to use Rx beam 1 for sensing. The first time interval may be followed by a second time interval. For example, during the second time interval (e.g., one or more slots and/or one or more symbols) UE-A may determine to use Rx beam 2 for sensing, and so on. For example, the time intervals may be repeating periodically throughout the resource pool. In an example, UE-A may determine to use Rx beam 1 for sensing a first portion of RBs of the resource pool. In an example, UE-A may determine to use Rx beam 2 for sensing a second portion of RBs of the resource pool. For example, the first RBs and the second RBs may be disjoint. In an example, in response to the UE capability/assistance information indicating that UE-A is incapable of simultaneous reception using multiple beams, the BS/UE-B/UE-A may configure periodic beam-formed sensing for UE-A.

In an example, UE-A may be capable of simultaneous receptions using multiple Rx beams. For example, UE-A may transmit a message comprising sidelink capability or assistance information to the BS or UE-B. The sidelink capability or assistance information may comprise a parameter indicating that UE-A is capable of simultaneous sidelink receptions using multiple Rx beams. For example, UE-A may use Rx beam 1 and Rx beam 2 in slot t1 and slot t2.

As shown in FIG. 40, UE-A may detect/receive a second SCI (e.g., from UE-C, which may or may not be the third UE). UE-A may receive the second SCI using the second Rx beam/filter (Rx beam 2), e.g., in slot t2. In an example, slot t2 may be the same as slot t1 (e.g., if UE-A is capable of simultaneous reception using multiple beams). In an example, slot t2 may be before or after slot t1. UE-A may receive the second SCI based on the second SL RS.

The second SCI may comprise one or more fields (e.g., frequency resource assignment, time resource assignment, and/or resource reservation period) indicating a second reserved resource for transmission of a second TB via a second PSSCH (reserved resource in FIG. 40). The second SCI may comprise a priority field indicating a L1 priority value (p2) of the second TB. The second SCI may indicate (e.g., by indicating a second stage SCI comprising a field) a source ID and a destination ID of the second TB transmission via the reserved resource. For example, the destination ID may or may not match UE-A's destination ID.

The second SCI may indicate a slot and one or more RBs for the second reserved resource in time and frequency domain. The second SCI may indicate a TCI state and/or SL RS and/or Rx beam index for reception of the first TB via the first reserved resource in spatial domain. In an example, if the destination ID in the second SCI matches UE-A's destination ID, it can decode and determine the unicast information in the second SCI including the TCI state and/or SL RS and/or Rx beam index. In an example, if the destination ID in the second SCI does not match UE-A's destination ID, it cannot decode and determine the unicast information in the second SCI including the TCI state and/or SL RS and/or Rx beam index. For example, UE-A may not be able to determine the direction of UE-C's transmission of the second PSSCH.

In an example, UE-A may assume/determine that UE-C transmits the second PSSCH using the same Tx beam as the second SCI, e.g., if RRC configurations of the sidelink resource pool indicate semi-static beam-forming/beam management. For example, UE-A may determine that UE-C transmits the second PSSCH using the same beam as the second SCI, e.g., if the second SCI comprises a field (e.g., a flag) indicating a value that represents same Tx beam/direction for the reserved transmission is maintained as the second SCI (e.g., in case of dynamic beam-forming). For example, UE-C may transmit the second SCI using a third Tx beam and/or based on a third SL RS. If the field in the SCI indicates a first value (e.g., 0) UE-A may determine that UE-C will transmit the second PSSCH using the third Tx beam and/or based on the third SL RS. If the field in the SCI indicates a second value (e.g., 1) UE-A may determine that UE-C will not transmit the second PSSCH using the third Tx beam and/or based on the third SL RS, e.g., UE-C may transmit the second PSSCH using a fourth Tx beam and/or based on a fourth SL RS. In an example, RRC configuration of the sidelink resource pool may indicate whether the second SCI comprises the field or not. For example, if the RRC configuration of the sidelink resource pool indicates that the second SCI does not comprise the field, UE-A may determine same transmission direction for the second SCI and the second PSSCH reserved by the second SCI.

Thus, UE-A may determine the direction of the second PSSCH transmission by UE-C based on the second SCI. In an example, if UE-A received the second SCI using the second Rx beam/filter and/or based on the second TCI state or SL RS, it may determine/expect that the second PSSCH transmission will be also received using the second Rx beam/filter and/or based on the second TCI state or SL RS.

Referring to FIG. 40, UE-A may determine that the reserved resource indicated by the second SCI is within or overlaps in time domain with the resource selection window indicated by the first SCI. In an embodiment, UE-A may determine a first resource, overlapping with the reserved resource, within the selection window as a (non-) preferred resource based on potential overlap of the first TB transmission by UE-B using the first resource with the second PSSCH transmission by UE-C using the reserved resource, the overlap being in time and frequency and spatial domain. For example, UE-A may determine whether the first PSSCH transmission via the first resource overlaps with the reserved resource in the spatial domain based on the Rx beams(s)/filter(s) used for receiving the first SCI and the second SCI. For example, UE-A may determine spatial domain overlap if the first Rx beam is the same as the second Rx beam. In an embodiment, UE-A may determine spatial domain overlap if the first Rx beam and the second Rx beam are associated with a same SL RS (e.g., a wide beam, S-SSB or SL CSI-RS). In an embodiment, UE-A may determine spatial domain overlap if the first Rx beam and the second Rx beam are associated with a same TCI state.

For example, the first SL RS and the second SL RS may be QCLed with respect to a first type (e.g., typeA or typeB or typeC or typeD). In an embodiment, UE-A may determine a the first resource as a (non-) preferred resource, e.g., if the first SL RS and the second SL RS are QCLed. For example, the first SL RS may be a first CSI-RS and the second SL RS may be a second CSI-RS. The first CSI-RS and the second CSI-RS may be associated/QCLed with a first S-SSB. For example, UE-A may determine the first resource as a non-preferred resource or may not determine the first resource as a preferred resource, e.g., if the first TCI state of the first SL RS and the second TCI state of the second SL RS are QCLed (e.g., associated with the same SL RS). For example, the sidelink configuration of the unicast link may indicate that the first SL RS and the second SL RS are QCLed with respect to the first type. For example, the sidelink configuration of the unicast link may indicate that the first TCI state and the second TCI state are QCLed with respect to the first type and/or are associated with the same SL RS.

In an example, the power received using the first Rx beam/filter based on the first RS may impact/interfere with the power received using the second Rx beam/filter based on the second RS. For example, if the first SL RS or TCI state and the second SL RS or TCI state are QCLed with respect to a first type (e.g., based on Doppler shift, Doppler spread, average delay, and/or delay spread), the signals received via the first Rx beam/filter (which is based on the first SL RS/TCI state) and the second Rx beam/filter (which is based on the second SL RS/TCI state) may be correlated. Embodiments enable capturing the spatial correlation between signals received using different Rx beams towards a reliable sensing mechanism in the presence of beam-formed transmission/receptions.

Referring to FIG. 40, in an embodiment, UE-A may determine the first resource as a preferred/non-preferred resource, based on the first SCI and the second SCI. For example, UE-A may determine the first resource as a non-preferred resource or may not determine the first resource as a preferred resource if the first SCI and the second SCI are received using a same Rx beam/filter and/or the RSRP of the second SCI is above a threshold. For example, UE-A may determine the first resource as a non-preferred resource or may not determine the first resource as a preferred resource if the first SCI and the second SCI are received using QCLed Rx beams/filters. For example, UE-A may determine the first resource as a non-preferred resource or may not determine the first resource as a preferred resource if the first SCI and the second SCI are received using Rx beams/filters that are associated with the same SL RS. For example, UE-A may determine the first resource as a non-preferred resource or may not determine the first resource as a preferred resource if the first SCI and the second SCI are received using Rx beams/filters that are associated with the same TCI state. For example, UE-A may determine the first resource as a non-preferred resource or may not determine the first resource as a preferred resource if the first SL RS and the second SL RS are QCLed with respect to the first type. For example, UE-A may determine the first resource as a non-preferred resource or may not determine the first resource as a preferred resource if the first SL RS and the second SL RS are correlated (e.g., RRC sidelink configurations may indicate a correlation factor (e.g., between 0 and 1) between the first SL RS and the second SL RS). For example, UE-A may determine the first resource as a non-preferred resource or may not determine the first resource as a preferred resource if the correlation factor between the first SL RS and the second SL RS is greater than 0 or a threshold. For example, UE-A may determine the first resource as a non-preferred resource or may not determine the first resource as a preferred resource if the first Rx beam/filter and the second Rx beam/filter are correlated (e.g., UE-A may determine the correlation factor between the two Rx beams/filters, e.g., based on implementation). For example, UE-A may determine the first resource as a non-preferred resource or may not determine the first resource as a preferred resource if the correlation factor between the first Rx beam and the second Rx beam is greater than 0 or a threshold.

In an embodiment, UE-A may determine the first resource as a non-preferred resource or may not determine the first resource as a preferred resource if the first Rx beam/RS associated with the first reserved resource is the same and/or QCLed and/or correlated with the second Rx beam/RS associated with the reserved resource. For example, the first SCI and/or a MAC-CE/RRC message from BS or UE-B may indicate the first Rx beam/RS for reception of the first TB. UE-A may determine the second Rx beam/RS associated with the reserved resource based on the second SCI, e.g., based on the second Rx beam/RS used for receiving the second SCI and/or based on the second SCI comprising a field indicating using same Tx beam for the second PSSCH transmission and/or based on the second reserved resource being within a time interval associated with periodic beam-formed sensing using the second Rx beam/RS.

In an embodiment, UE-A may not determine the first resource as a non-preferred resource or may not determine the first resource as a preferred resource if the first Rx beam/RS associated with the first reserved resource is not the same and/or QCLed and/or correlated with the second Rx beam/RS associated with the reserved resource. For example, the first resource and the reserved resource may overlap in time and frequency, but not in spatial domain (e.g., uncorrelated directions), and thus, may not interfere with each other.

As shown in FIG. 40, UE-A may determine to transmit a IUC information to UE-B, e.g., based on the first SCI indicating a destination ID matching UE-A's destination ID and/or based on the RSRP of the second SCI being above a threshold. UE-A may transmit the IUC information to UE-B via a PSSCH transmission occasion, e.g., before the start of the first resource selection window.

In an embodiment, UE-A may use a first Tx beam/spatial filter for transmission of the IUC information to UE-B. For example, the first Tx beam/filter may be associated with the first SL RS or the first TCI state (e.g., unified TCI state). For example, the first Tx beam/filter may correspond to the first Rx beam/filter (e.g., based on the beam correspondence). In an embodiment, UE-A may determine the Tx beam/Rs for transmission of the IUC information based on a Rx beam used for receiving the first SCI indicating the IUC request. In an embodiment, UE-A may determine the Tx beam/Rs for transmission of the IUC information based on a Rx beam indicated (e.g., by the first SCI) for reception of the first TB.

Throughout this disclosure, the following terms may be used interchangeably: Rx beam, sensing beam, Rx spatial filter, Rx spatial filter setting, sensing spatial filter, sensing spatial filter setting, SL RS, TCI state.

For a resource pool, sl-TypeUE-A may not be provided, and/or the first UE may have been indicated a first reserved resource and a second reserved resource as resources for PSSCH reception. For a resource pool sl-TypeUE-A may be provided, and/or the first UE may have been indicated at least the first reserved resource or the second reserved resource for PSSCH reception. The first UE may detect a first SCI format 1-A, using a first Rx spatial setting, that includes a first priority value, p1, and the first reserved resource for PSSCH transmission from a second UE for the first Rx spatial setting of the first UE. The first UE may detect a second SCI format 1-A, using a second Rx spatial setting, that includes a second priority value, p₂<p₁, and the second reserved resource for PSSCH transmission from a third UE for the second Rx spatial setting of the first UE. The first UE may determine that the first and second resources overlap in time and frequency, and/or that the first spatial setting and the second spatial setting are the same or significantly similar or QCLed with respect to a first type (e.g., typeA or typeB or typeC or typeD). The PSFCH occasions for resource conflict information of the second UE and the third UE may be valid. The conflict information receiver flag in SCI Format 1-A from the second UE and the third UE may be set to 1, if sl-IndicationUE-B=‘enabled’. The first UE may determine the first SCI format 1-A and the second SCI format 1-A are not received later than sl-Min TimeGapPSFCH before the PSFCH occasion for conflict information. The first UE may determine to transmit to the second UE the PSFCH with the conflict information.

For a resource pool, sl-TypeUE-A may not be provided, and/or the first UE may have been indicated a first reserved resource and a second reserved resource as resources for PSSCH reception. For a resource pool sl-TypeUE-A may be provided, and/or the first UE may have been indicated at least the first reserved resource or the second reserved resource for PSSCH reception. The first UE may detect a first SCI format 1-A, using a first Rx spatial setting, that includes a first priority value, p1, and the first reserved resource for PSSCH transmission from a second UE. The first UE may detect a second SCI format 1-A, using the first Rx spatial setting, that includes a second priority value, p₂<p₁, and the second reserved resource for PSSCH transmission from a third UE. The first UE may determine that the first and second resources overlap in time and frequency and/or that the first spatial setting and the second spatial setting are the same or significantly similar or QCLed with respect to a first type (e.g., typeA or typeB or typeC or typeD). The PSFCH occasions for resource conflict information of the second UE and the third UE may be valid. The conflict information receiver flag in SCI Format 1-A from the second UE and the third UE may be set to 1, if sl-IndicationUE-B=‘enabled’. The first UE may determine the first SCI format 1-A and the second SCI format 1-A are not received later than sl-Min TimeGapPSFCH before the PSFCH occasion for conflict information. The first UE may determine to transmit to the second UE the PSFCH with the conflict information.

A wireless device may determine to transmit, via a sidelink (SL) transmission occasion, a SL transmission associated with a first SL reference signal (RS). The wireless device may determine to transmit the SL transmission based on a first reference signal received power (RSRP) associated with the first SL RS, and a second RSRP associated with a second SL RS, wherein the second SL RS is quasi co-located with the first SL RS.

The first RSRP may be used for a first sensing procedure for the SL transmission. The first sensing procedure may comprise using a first spatial domain reception filter determined based on the first SL RS. The second RSRP may be used for a second sensing procedure for the SL transmission. The second sensing procedure may comprise using a second spatial domain reception filter determined based on the second SL RS. The first spatial domain filter and the second spatial domain filter may be associated with a same TCI state and/or S-SSB and/or SL CSI-RS. The first spatial domain filter and the second spatial domain filter may be QCLed.

A first wireless device may transmit to a second wireless device, a conflict information for a sidelink (SL) reception from the second wireless device. The SL reception may be associated with a first SL reference signal (RS) and overlap in time and frequency with a reserved resource indicated in a sidelink control information (SCI) by a third wireless device. The SCI may be received based on a second SL RS quasi co-located with the first SL RS.

A first wireless device may receive from a second wireless device, a first sidelink control information (SCI) indicating a first reserved resource for a sidelink reception based on a first sidelink (SL) reference signal (RS). The first wireless device may receive, from a third wireless device and based on a second SL RS, a second SCI indicating a second reserved resource overlapping in time and frequency with the first reserved resource. The first wireless device may transmit, in response to the first SL RS and the second SL RS being quasi co-located (QCLed), a conflict information to the second wireless device.

The first wireless device may receive the first SCI using a first spatial domain reception filter determined based on the first SL RS. The second wireless device may transmit the first SCI using a first spatial domain transmission filter determined based on the first SL RS. The first SCI may comprise a field indicating reservation of the first reserved resource. The first SCI may comprise a field indicating the first SL RS for determining a spatial domain reception filter for the sidelink reception via the first reserved resource. The field may indicate a first transmission configuration indication (TCI) state, for the sidelink reception, associated with the first SL RS.

The first wireless device may receive a radio resource control (RRC) message comprising sidelink configurations indicating one or more TCI states, comprising the first TCI state, associated with the first SL RS.

The first wireless device may receive the second SCI using a second spatial domain reception filter determined based on the second SL RS. The second SCI may comprise a field indicating reservation of the second reserved resource. The second SCI may comprise a field indicating direction of a second sidelink transmission via the second reserved resource.

The first wireless device may determine the conflict information in response to the field in the second SCI indicating that a direction of the second sidelink transmission via the second reserved resource is the same as the second SCI. The first wireless device may determine no resource conflict in response to the field in the second SCI indicating that a direction of the second sidelink transmission via the second reserved resource is not the same as the second SCI. The first wireless device may determine that the second SCI and a second sidelink transmission via the second reserved resource are transmitted in same direction and/or using a same/significantly similar spatial domain transmission filter. The first wireless device may receive a sidelink configuration parameter indicating that a same or similar direction may be used for transmission of the second SCI and a second sidelink transmission via the second reserved resource.

The first wireless device may determine to transmit the conflict information based on the second reserved resource and the first reserved resource overlap in time and frequency. The first wireless device may determine to transmit the conflict information based on a first priority value indicated by the first SCI being greater than or equal to a second priority value indicated by the second SCI. The first wireless device may determine to transmit the conflict information based on a reference signal received power (RSRP) of the second SCI from the third wireless device being above a threshold. The first wireless device may determine the threshold based on a second threshold associated with the sidelink reception (or the first SL RS).

The first reserved resource may be for a physical sidelink shared channel (PSSCH) transmission from the second wireless device. The second reserved resource may be for a physical sidelink shared channel (PSSCH) transmission from the third wireless device. The first wireless device may transmit the conflict information via a physical sidelink feedback channel (PSFCH), e.g., based on the first SL RS. The first wireless device may transmit the conflict information to the second wireless device based on the first SL RS. The first wireless device may transmit the conflict information to the second wireless device using a first spatial domain transmission filter determined based on the first SL RS. The first spatial domain transmission filter and the first spatial domain reception filter may be associated with the first SL RS, e.g., QCLed. The first spatial domain transmission filter and the first spatial domain reception filter may be associated with a same TCI state.

A first wireless device may receive from a second wireless device, a request for inter-UE coordination information indicating one or more preferred or non-preferred resources within a resource selection window of a sidelink (SL) transmission associated with a first SL reference signal (RS). The first wireless device may receive, from a third wireless device and based on a second SL RS, a sidelink control information (SCI) indicating a reserved resource within the resource selection window. The first wireless device may determine, based on the first SL RS and the second SL RS being quasi co-located (QCLed), the reserved resource as a preferred or non-preferred resource for the SL transmission. The first wireless device may transmit, to the second wireless device, the inter-UE coordination information indicating one or more the preferred or non-preferred resources.

The first wireless device may receive a first SCI from the second wireless device indicating the request. The first SCI may be received based on the first SL RS. The first wireless device may receive the first SCI using a first spatial domain reception filter determined based on the first SL RS. The sidelink transmission may be transmitted by the second wireless device using a first spatial domain transmission filter determined based on the first SL RS. The first wireless device may receive the SCI from the third wireless device using a second spatial domain reception filter determined based on the second SL RS. The first wireless device may compare a reference signal received power (RSRP) of the SCI with a threshold. The first wireless device may determine the threshold based on a second threshold associated with the sidelink transmission (or the first SL RS). The first wireless device may transmit the inter-UE coordination using a first spatial domain transmission filter determined based on the first SL RS. The first spatial domain transmission filter and the first spatial domain reception filter may be associated with the first SL RS, e.g., QCLed. The first spatial domain transmission filter and the first spatial domain reception filter may be associated with a same TCI state.

The first wireless device may receive based on a first sidelink (SL) reference signal (RS), a sidelink control information (SCI) indicating a first resource. The first wireless device may determine a candidate resource set, comprising the first resource, for a SL transmission associated with a second SL RS quasi co-located with the first SL RS. The first wireless device may determine, based on a reference signal received power (RSRP) of the SCI exceeding a threshold, to exclude the first resource from the candidate resource set. The first wireless device may transmit, based on the second SL RS, the SL transmission via a second candidate resource of the candidate resource set.

The first SCI may be received using a first spatial domain reception filter determined based on the first SL RS. The first wireless device may receive the first SCI from a second wireless device in a first slot. The second wireless device may transmit the first SCI using a first spatial domain transmission filter determined based on the first SL RS. The second wireless device may further transmit a sidelink transmission via the reserved resource using the first spatial domain transmission filter.

The first wireless device may measure the RSRP of first SCI in the first slot. A RSRP measurement of the first SCI received based on the first SL RS may be higher than the threshold. The first SCI may indicate reservation of the reserved resource in time and frequency.

The first wireless device may determine, for the SL transmission, a second spatial domain transmission filter based on the second SL RS. A first antenna port used for transmitting or receiving the first SL RS may be quasi co-located with a second antenna port used for transmitting or receiving the second SL RS. The first SL RS and the second SL RS may be in a same RS group. The first SL RS and the second SL RS may be associated with a same S-SSB or TCI state or TCI state group.

The first wireless device may receive an RRC message comprising sidelink configuration parameters indicating one or more SL RS groups comprising the RS group of the first SL RS and the second SL RS. The first wireless device may receive an RRC message comprising sidelink configuration parameters indicating one or more TCI states or TCI state groups comprising the TCI state or the TCI state group, respectively.

The first wireless device may trigger resource (re-)selection procedure for the SL transmission. The first wireless device may initialize the candidate resource set. The first candidate resource may overlap in time and frequency with the reserved resource. The first SCI may be received inside a sensing window of the SL transmission. The reserved resource may be inside a selection window of the SL transmission.

A first wireless device may determine to exclude a first candidate resource from a candidate resource set, for a sidelink (SL) transmission associated with a first SL reference signal (RS), based on: a first RSRP associated with the first SL RS; and a second RSRP associated with a second SL RS QCLed with the first SL RS. The first wireless device may transmit the sidelink transmission via a second candidate resource of the candidate resource set. The first SL RS and the second SL RS may be quasi-collocated with respect to typeA and/or typeB and/or typeC and/or typeD.

The first RSRP may be below a first threshold and/or the second RSRP may be below a second threshold.

The first wireless device may receive, via a first receive beam/receive spatial filter setting, a first SCI indicating a first resource reservation overlapping with the first candidate resource, wherein the first receive beam/receive spatial filter setting is associated with the first SL RS. The first wireless device may receive, via a second receive beam/receive spatial filter setting, a second SCI indicating a second resource reservation overlapping with the first candidate resource, wherein the second receive beam/receive spatial filter setting is associated with the second SL RS.

The first wireless device may determine for a SL transmission associated with a first SL reference signal (RS), to exclude from a candidate resource set, a first candidate resource indicated by a first SCI associated with a second SL RS quasi co-located with the first SL RS, and based on a reference signal received power (RSRP) of the first SCI exceeding a threshold. The first wireless device may transmit, based on the first SL RS, the sidelink transmission via a second candidate resource of the candidate resource set.

Clause 1. A method comprising: receiving, by a first wireless device from a second wireless device, first sidelink control information (SCI) indicating a first reserved resource for a sidelink reception based on a first sidelink (SL) reference signal (RS); receiving, from a third wireless device and based on a second SL RS, second SCI indicating a second reserved resource overlapping in time and frequency with the first reserved resource; and transmitting, in response to the first SL RS and the second SL RS being quasi co-located (QCLed), conflict information to the second wireless device.

Clause 2. A method comprising: transmitting, by a first wireless device, conflict information based on: a first resource overlapping in time and frequency with a second resource; and a first sidelink (SL) reference signal (RS) of the first resource being quasi co-located with a second SL RS of the second resource.

Clause 3. The method of clause 2, further comprising receiving, from a second wireless device, first sidelink control information (SCI) indicating the first resource for a sidelink reception based on the first SL RS.

Clause 4. The method of any one of clauses 2-3, further comprising receiving first sidelink control information (SCI) using a first spatial domain reception filter.

Clause 5. The method of any one of clauses 3-4, wherein the first SCI is transmitted using a first spatial domain transmission filter determined based on the first SL RS.

Clause 6. The method of any one of clauses 3-5, wherein the first SCI comprises a field indicating reservation of the first resource.

Clause 7. The method of any one of clauses 3-6, wherein the first SCI comprises a field indicating the first SL RS for determining a spatial domain reception filter for the sidelink reception via the first resource.

Clause 8. The method of clause 7, wherein the field indicates a first transmission configuration indication (TCI) state, for the sidelink reception, associated with the first SL RS.

Clause 9. The method of any one of clauses 2-8, further comprising receiving one or more radio resource control (RRC) messages comprising one or more sidelink configurations indicating one or more TCI states, comprising a first TCI state, associated with the first SL RS.

Clause 10. The method of any one of clauses 2-9, further comprising receiving, from a third wireless device and based on the second SL RS, second SCI indicating the second resource.

Clause 11. The method of clause 10, further comprising receiving the second SCI using a second spatial domain reception filter determined based on the second SL RS.

Clause 12. The method of any one of clauses 10-11, wherein the second SCI comprises a field indicating reservation of the second resource.

Clause 13. The method of any one of clauses 10-12, wherein the second SCI comprises a field indicating direction of a second sidelink transmission via the second resource.

Clause 14. The method of any one of clauses 10-13, further comprising determining the conflict information in response to a field in the second SCI indicating that the direction of the second sidelink transmission via the second resource is the same as the second SCI.

Clause 15. The method of any one of clauses 10-14, further comprising determining no resource conflict in response to a field in the second SCI indicating that a direction of the second sidelink transmission via the second resource is not the same as the second SCI.

Clause 16. The method of any one of clauses 10-15, further comprising determining that the second SCI and a second sidelink transmission via the second resource are transmitted in same direction using a significantly similar spatial domain transmission filter.

Clause 17. The method of any one of clauses 10-16, further comprising receiving a sidelink configuration parameter indicating that a same or similar direction may be used for transmission of the second SCI and a second sidelink transmission via the second resource.

Clause 18. The method of any one of clauses 2-17, further comprising determining the conflict information based on the first SL RS and the second SL RS being quasi co-located (QCLed).

Clause 19. The method of any one of clauses 2-18, further comprising determining to transmit the conflict information based on the first resource and the second resource overlapping in time and frequency.

Clause 20. The method of any one of clauses 2-19, further comprising transmitting the conflict information is further based on a first priority value associated with the first SL RS being greater than or equal to a second priority value associated with the second SL RS.

Clause 21. The method of clause 20, wherein the first priority is indicated by first sidelink control information (SCI) or the second priority is indicated by second SCI.

Clause 22. The method of any one of clauses 2-21, further comprising transmitting the conflict information further based on a reference signal received power (RSRP) of a second SCI from a third wireless device being above a threshold.

Clause 23. The method of clause 22, wherein the threshold is based on a second threshold associated with a sidelink reception.

Clause 24. The method of any one of clauses 2-23, wherein the first resource is for a physical sidelink shared channel (PSSCH) transmission from a second wireless device.

Clause 25. The method of any one of clauses 2-24, wherein the second resource is for a physical sidelink shared channel (PSSCH) transmission from a third wireless device.

Clause 26. The method of any one of clauses 2-25, further comprising transmitting the conflict information via a physical sidelink feedback channel (PSFCH).

Clause 27. The method of clause 26, further comprising transmitting the PSFCH to the second wireless device based on the first SL RS.

Clause 28. The method of any one of clauses 2-27, further comprising transmitting the conflict information to a second wireless device.

Clause 29. The method of any one of clauses 2-28, further comprising transmitting, to a second wireless device, the conflict information using a first spatial domain transmission filter determined based on the first SL RS.

Clause 30. The method of any one of clauses 2-29, wherein the first SL RS is associated with one or both of: a first spatial domain transmission filter for transmitting the conflict information; or a first spatial domain reception filter for receiving sidelink control information.

Clause 31. The method of any one of clauses 2-30, wherein a transmission configuration indication (TCI) state is associated with one or both of: a first spatial domain transmission filter for transmitting the conflict information; or a first spatial domain reception filter for receiving sidelink control information.

Clause 32. The method of any one of clauses 2-31, wherein the first resource is a first reserved resource and the second resource is a second reserved resource.

Clause 33. A method comprising: receiving, by a first wireless device from a second wireless device, a request for inter-user equipment (UE) coordination information indicating at least one preferred or non-preferred resource within a resource selection window of a sidelink (SL) transmission associated with a first SL reference signal (RS); receiving, from a third wireless device and based on a second SL RS, a SL control information (SCI) indicating a reserved resource within the resource selection window; determining, based on the first SL RS and the second SL RS being quasi co-located (QCLed), the reserved resource is a preferred or non-preferred resource for the SL transmission; and transmitting, to the second wireless device, the inter-UE coordination information indicating the preferred or non-preferred resource.

Clause 34. A method comprising: transmitting, by a first wireless device, inter-user equipment (UE) coordination information indicating a first resource for a sidelink (SL) transmission, wherein the inter-UE coordination information is based on a first SL reference signal (RS) and a second SL RS being quasi co-located (QCLed).

Clause 35. The method of clause 34, wherein the SL transmission is based on the first SL reference signal (RS).

Clause 36. The method of any one of clauses 34-35, wherein the first resource is a preferred or non-preferred resource for the SL transmission.

Clause 37. The method of any one of clauses 34-36, wherein the first resource is associated with the second SL RS.

Clause 38. The method of any one of clauses 34-37, further comprising receiving, from a second wireless device, a request for the inter-UE coordination information.

Clause 39. The method of clause 38, receiving first sidelink control information (SCI) comprising the request for the inter-UE coordination information.

Clause 40. The method of any one of clauses 38-39, further comprising receiving the request based on the first SL RS.

Clause 41. The method of any one of clauses 34-40, further comprising receiving first sidelink control information (SCI) using a first spatial domain reception filter determined based on the first SL RS.

Clause 42. The method of any one of clauses 39-41, wherein the request for the inter-UE coordination information indicates at least one preferred or non-preferred resource within a resource selection window of the SL transmission.

Clause 43. The method of any one of clauses 34-42, wherein the first resource is within a resource selection window.

Clause 44. The method of any one of clauses 34-43, wherein the SL transmission is transmitted by the second wireless device using a first spatial domain transmission filter determined based on the first SL RS.

Clause 45. The method of any one of clauses 34-44, further comprising receiving, from a third wireless device and based on the second SL RS, a second SCI indicating the first resource.

Clause 46. The method of any one of clauses 34-45, further comprising determining based on the first SL RS and the second SL RS being QCLed, the first resource as the preferred or non-preferred resource for the SL transmission.

Clause 47. The method of any one of clauses 34-46, further comprising receiving second SCI from a third wireless device using a second spatial domain reception filter determined based on the second SL RS.

Clause 48. The method of any one of clauses 34-47, further comprising comparing a reference signal received power (RSRP) of second SCI with a threshold.

Clause 49. The method of clause 48, further comprising determining the threshold based on a second threshold associated with the SL transmission.

Clause 50. The method of any one of clauses 34-49, further comprising transmitting the inter-UE coordination using a first spatial domain transmission filter determined based on the first SL RS.

Clause 51. The method of any one of clauses 34-50, wherein the first SL RS is associated with one or both of: a first spatial domain transmission filter for transmitting the inter-UE coordination information; or a first spatial domain reception filter for receiving SCI.

Clause 52. The method of any one of clauses 34-51, wherein a transmission configuration indication (TCI) state is associated with one or both of: a first spatial domain transmission filter for transmitting the inter-UE coordination information; or a first spatial domain reception filter for receiving sidelink control information.

Clause 53. The method of any one of clauses 34-52, further comprising transmitting the inter-UE coordination information to the second wireless device.

Clause 54. The method of any one of clauses 34-53, wherein the first resource is a reserved resource.

Clause 55. A wireless device comprising: one or more processors; and memory storing instructions that, when executed by the one or more processors, cause the wireless device to perform the method of any one of clauses 1-54.

Clause 56. A non-transitory computer-readable medium comprising instructions that, when executed by one or more processors of a wireless device, cause the wireless device to perform the method of any one of clauses 1-54.

What is claimed is:

1. A first wireless device comprising:
one or more processors; and
memory storing instructions that, when executed by the one or more processors, cause the first wireless device to:
receive, from a second wireless device, first sidelink control information (SCI) indicating a first reserved resource for a sidelink reception based on a first sidelink (SL) reference signal (RS);
receive, from a third wireless device and based on a second SL RS, second SCI indicating a second reserved resource overlapping in time and frequency with the first reserved resource; and
transmit, in response to the first SL RS and the second SL RS being quasi co-located (QCLed), conflict information to the second wireless device.

2. The first wireless device of claim 1, wherein the first SCI comprises a field indicating reservation of the first reserved resource.

3. The first wireless device of claim 1, wherein the first SCI comprises a field indicating the first SL RS for determining a spatial domain reception filter for the sidelink reception via the first reserved resource.

4. The first wireless device of claim 3, wherein the field indicates a first transmission configuration indication (TCI) state, for the sidelink reception, associated with the first SL RS.

5. The first wireless device of claim 1, wherein the instructions further cause the first wireless device to receive the second SCI using a second spatial domain reception filter determined based on the second SL RS.

6. The first wireless device of claim 1, wherein the second SCI comprises a field indicating reservation of the second reserved resource.

7. The first wireless device of claim 1, wherein the second SCI comprises a field indicating a spatial domain transmission filter of a second sidelink transmission via the second reserved resource.

8. The first wireless device of claim 7, wherein the instructions further cause the first wireless device to determine the conflict information in response to the spatial domain transmission filter of the second sidelink transmission via the second reserved resource being significantly similar to a second spatial domain reception filter for the sidelink reception via the first reserved resource.

9. The first wireless device of claim 1, wherein the instructions further cause the first wireless device to transmit the conflict information is further based on a first priority value associated with the first SL RS being greater than or equal to a second priority value associated with the second SL RS.

10. The first wireless device of claim 1, wherein the instructions further cause the first wireless device to transmit the conflict information further based on a reference signal received power (RSRP) of the second SCI device being above a threshold.

11. A method comprising:
receiving, by a first wireless device from a second wireless device, first sidelink control information (SCI) indicating a first reserved resource for a sidelink reception based on a first sidelink (SL) reference signal (RS);
receiving, from a third wireless device and based on a second SL RS, second SCI indicating a second reserved resource overlapping in time and frequency with the first reserved resource; and
transmitting, in response to the first SL RS and the second SL RS being quasi co-located (QCLed), conflict information to the second wireless device.

12. The method of claim 11, wherein the first SCI comprises a field indicating reservation of the first reserved resource.

13. The method of claim 11, wherein the first SCI comprises a field indicating the first SL RS for determining a spatial domain reception filter for the sidelink reception via the first reserved resource.

14. The method of claim 13, wherein the field indicates a first transmission configuration indication (TCI) state, for the sidelink reception, associated with the first SL RS.

15. The method of claim 11, further comprising receiving the second SCI using a second spatial domain reception filter determined based on the second SL RS.

16. The method of claim 11, wherein the second SCI comprises a field indicating reservation of the second reserved resource.

17. The method of claim 11, wherein the second SCI comprises a field indicating a spatial domain transmission filter of a second sidelink transmission via the second reserved resource.

18. The method of claim 17, further comprising determining the conflict information in response to the spatial domain transmission filter of the second sidelink transmission via the second reserved resource being significantly similar to a second spatial domain reception filter for the sidelink reception via the first reserved resource.

19. The method of claim 11, further comprising transmitting the conflict information is further based on a first priority value associated with the first SL RS being greater than or equal to a second priority value associated with the second SL RS.

20. A non-transitory computer-readable medium comprising instructions that, when executed by one or more processors of a first wireless device, cause the first wireless device to:
receive, from a second wireless device, first sidelink control information (SCI) indicating a first reserved resource for a sidelink reception based on a first sidelink (SL) reference signal (RS);
receive, from a third wireless device and based on a second SL RS, second SCI indicating a second reserved resource overlapping in time and frequency with the first reserved resource; and
transmit, in response to the first SL RS and the second SL RS being quasi co-located (QCLed), conflict information to the second wireless device.
